(19) United States
(12) Patent Application Publication
(10) Pub. No.: US 2007/0004497 A1
(43) Pub. Date: Jan. 4, 2007

(54) Gaming machine

(75) Inventors: Kazuo Okada, Tokyo (JP); Takaaki Hishinuma, Tokyo (JP); Kensuke Kondo, Tokyo (JP); Takayuki Hirauchi, Tokyo (JP); Yousuke Kamada, Tokyo (JP); Makoto Hirosawa, Tokyo (JP); Tomohiro Nakata, Tokyo (JP); Kiyotaka Morishima, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Aruze Corp., Tokyo (JP)

(21) Appl. No.: 11/365,803

(22) Filed: Mar. 2, 2006

(30) Foreign Application Priority Data
Jun. 28, 2005 (JP) 2005-189073
Jul. 27, 2005 (JP) 2005-217953
Aug. 30, 2005 (JP) 2005-250347

(51) Int. Cl. A63F 13/00

(52) U.S. Cl. 463/20

(57) ABSTRACT

Disclosed is a gaming machine. The gaming machine comprises a main control circuit for determining a combination corresponding to a numerical range including a random number value sampled by a random number lottery, based on a probability sortition table, as an internal winning combination. The probability sortition table includes the information of a first numerical range corresponding to RB, the information of a second numerical range included in the first numerical range and corresponding to Small Win of White 7, and the information of a third numerical range including a part of the numerical range constituting the first numerical range and corresponding to Small Win of Cherry.

### CROSS REFERENCE TO RELATED APPLICATION

This application is based upon and claims the benefit of priority from the prior Japanese patent Application No. 2005-250347, filed on Aug. 30, 2005 that is based upon and claims the benefit of priority from the prior Japanese patent Application No. 2005-189073, filed on Jun. 28, 2005 and the prior Japanese patent Application No. 2005-217953, filed on Jul. 27, 2005.

### BACKGROUND OF THE INVENTION

1. Field of the Invention

The present invention relates to a gaming machine.

2. Description of Related Art

A slot machine, so-called pachi-slot machine having a stop button comprises a variable display device having mechanical rotation reels for displaying symbols in a front display window, or an electrical variable display device for displaying symbols arranged on reels on a screen. Control means drives the variable display device in accordance with a start operation of a player to rotate each of the reels, thereby variably displaying the symbols. After a predetermined time period, the control means stops the rotation of the reels one by one automatically or in accordance with a stop operation of the player. At this time, when the symbols of the respective reels displayed in the display window form a specific combination (winning symbol), a game medium such as coin, medal, etc. is paid out to the player.

At present, the machine forming a mainstream has plural types of winning modes. In particular, when a winning of a predetermined combination is made (determined), a gaming state is provided in which a condition is better than a base state during a predetermined time period, in addition to the payout of the coin-one time. As the combination, there are a combination allowing a game, in which a relatively large payout is awarded to a player, to be carried out for the predetermined number of times (which is referred to as ┌big bonus┘ and abbreviated to ∃BB┘), and a combination allowing a game, in which a relatively small payout is awarded to a player, to be carried out for the predetermined number of times (which is referred to as ┌regular bonus┘ and abbreviated to ┌RB┘).

The gaming machine may be considered to have a harmful effect on the social morals. In manufacturing the gaming machine, it should be paid attention to the social effect so as not to arouse the passion for gambling. As the standard of judgment, there is a ┌Rule concerning Authorization and Models of Gaming Machine┘ in ┌Act concerning Rules and Adequacy of Duties of Business Offering Food and Entertainment┘. The criteria such as numerical values indicated therein are the only criteria, which are socially approved, for determining whether a gaming machine has a harmful effect on the social morals and are very important to manufacture the gaming machine.

For example, it is defined (in the annexed list 5 (1)-vii (vi) of the above Rule) that the number of combinations of symbols (symbol combinations) allowing a continuous operation increase device of single bonus (hereinafter, referred to as ┌BB┘) to be operated should not exceed 1/1500 of the number of all combinations of symbols in a gaming machine which is over when a continuous operation device of single bonus (hereinafter, referred to as ┌RB┘) is operated three times during the BB. In the gaming machine, 5 activated lines are typically defined. Accordingly, an expected value that a symbol combination of BB will be displayed on the activated lines is 1/300 (at this time, the attraction-in control is not considered).

In the gaming machine having the 5 activated lines, an amount of stop data relating to the stop control becomes more, but a stop display pattern (stop mode of symbol) is not monotonous. In other words, it is possible to display the various stop display patterns. In addition, when a bet number bet per one game is 1 piece, the activated line becomes one, when the bet number is 2 pieces, the activated line becomes three, and when the bet number is 3 pieces, the activated line becomes five. In other words, an internal winning probability of BB is set depending on the bet number. In the mean time, when the bet number is 1 piece, an internal winning probability is set to be lower than when the bet number is 3 pieces. Accordingly, the smaller the bet number, the lower the internal winning probability. A display probability that the symbol combination will be displayed on the activated line is defined to be within a range of (20% of the internal winning probability. In addition, it is impossible to set the display probability, which is a probability with regard to the display, and the internal winning probability, which is a probability with regard to the lottery, with values far apart.

Instead of the gaming machine having 5 activated lines (5 line-machine), it may be considered a gaming machine having one activated line (one line-machine). Since the one line-machine has the smaller activated line than the 5 line-machine, the proportion that a symbol combination corresponding to an internal winning combination will be displayed on the activated line is reduced, the stop display pattern on the activated line is also apt to be monotonous and the interest in a game may be lowered.

In addition, in the machine forming a mainstream, it is required that a winning of a combination (hereinafter, referred to as ┌internal winning┘) should be determined by an internal lottery process (hereinafter, ┌internal lottery┘) and a player should carry out a stop operation at a timing at which a combination of symbols representing a winning establishment of the combination internally won (hereinafter, referred to as ┌internal winning combination┘) can be stopped on an activated pay line (hereinafter, referred to as ┌activated line┘) so that a combination of predetermined symbols is arranged along the activated line and a winning enabling a coin, medal and the like to be paid out is determined. In other words, even though the internal winning is determined, a winning cannot be established unless the player carries out the stop operation at the proper timing. As a consequence, a gaming machine forms a mainstream, which requires a skill in the timing of the stop operation (skill intervention ability called as ┌observation push┘ forms a large part).

With regard to the gaming machine, it has been suggested a gaming machine wherein a control device comprises combination lottery means for carrying out a lottery of whether a winning of a combination or losing is determined, stop control means for carrying out stop control of reels being rotated, based on the lottery result of the combination lottery means, and winning determining means for determining whether a winning is made through a stop position of the symbol at the time when the rotation of all the reels is stopped, and the combination lottery means is structured so that several combinations are determined in a single game (see Japanese Unexamined Patent Publication No. 2004-113292). According to the gaming machine, it is possible to determine the several combinations in a single game. Therefore, the types of combinations become more, so that the game is not monotonous and the player's interest in the game is increased.

However, according to the above gaming machine, the several combinations are determined just in one game, so that the interest is lowered.

### SUMMARY OF THE INVENTION

Accordingly, the invention has been made to solve the above-mentioned problems occurring in the prior art. An object of the invention is to provide a gaming machine capable of increasing the interest in a game by the expectations for a winning of a predetermined combination.

In a gaming machine of the invention, internal winning combination determination information includes information of a first numerical range corresponding to a first combination, information of a second numerical range included in the first numerical range and corresponding to a second combination and information of a third numerical range including a part of the numerical range constituting the first numerical range and corresponding to a third combination.

More specifically, the invention provides following gaming machines.

(1) There is provided a gaming machine comprising: symbol display means (for example, reels 3L, 3C, 3R, symbol display areas 21L, 21CL, 21R) for displaying plural symbols; start signal output means (for example, start switch 6S, main control circuit 71) for outputting a command signal to start a unit game (for example, one game) in accordance with an operation of a player (for example, start operation); internal winning combination determination information storing means (for example, probability sortition table, RAM 33, ROM 32, main control circuit 71) for storing internal winning combination determination information (for example, probability sortition table) having information (for example, ┌0┘˜┌99┘) of numerical ranges (for example, random number range) corresponding to each of predetermined plural combinations (for example, RB, Small Win of White 7, Small Win of Cherry, Replay, Small Win of Bell, etc.); internal winning combination determining means (for example, means for carrying out a probability sortition process, main control circuit 71) for determining a combination corresponding to a numerical range including a random number value (for example, random number value sampled in a process of a step S4 of FIG. 12) sampled by a random number lottery as an internal winning combination (for example, internal carryover combination), based on the internal winning combination determination information; symbol varying means (for example, stepping motors 49L, 49C, 49R, main control circuit 71) for varying (for example, variably displaying) symbols to be displayed by the symbol display means, on condition that a signal is outputted by the start signal output means; stop signal output means (for example, stop switches 7LS, 7CS, 7RS) for outputting a command signal (for example stop command signal) to stop the symbol variation carried out by the symbol varying means, in accordance with an operation (for example, operation of stop buttons 7L,7C, 7R) of the player; stop control means (for example, means for carrying out a sliding-symbol-number deciding process, means for carrying out processes in steps S16˜S18 of FIG. 13, main control circuit 71) for carrying out a stop control of the symbol variation carried out by the symbol varying means, based on a signal outputted by the stop signal output means and an internal winning combination determined by the internal winning combination determining means; and means (for example, means for carrying out a process of a step S22 in FIG. 14, main control circuit 71) for awarding a payout (for example, payout of medal, automatic insertion of medal, shift of gaming state, etc.) to the player when a predetermined symbol combination (for example, symbol combination corresponding to Small Win of Bell) is displayed by the symbol display means, wherein the internal winning combination determination information includes information of a first numerical range (for example, ┌0┘˜┌99┘) corresponding to a first combination (for example, RB), information of a second numerical range (for example, ┌100┘˜┌199┘) included in the first numerical range and corresponding to a second combination (for example, Small Win of White 7) and information of a third numerical range (for example ┌200┘˜┌349┘) including a part (for example, ┌200┘˜┌299┘) of the numerical range constituting the first numerical range and corresponding to a third combination (for example, Small Win of Cherry).

According to the gaming machine described in the above (1), the internal winning combination determining means determines a combination corresponding to a numerical range including a random number value sampled by the random number lottery as an internal winning combination, based on the internal winning combination determination information. The internal winning combination determination information includes the information of a first numerical range corresponding to a first combination, the information of a second numerical range included in the first numerical range and corresponding to a second combination and the information of a third numerical range including a part of the numerical range constituting the first numerical range and corresponding to a third combination. Accordingly, when the second combination is an internal winning combination, the first combination is always determined as an internal winning combination. In addition, when the third combination is an internal winning combination, there are a case where the first combination is determined as an internal winning combination and a case where the first combination is not determined as an internal winning combination. In other words, when a symbol combination corresponding to the second combination is displayed, the first combination is determined without fail, and when a symbol combination corresponding to the third combination is displayed, the first combination may not be determined. Like this, since the player's expectations that the first combination will be an internal winning combination can be made to be different depending on whether the displayed symbol combination corresponds to the second combination or the third combination, it is possible to increase the interest in the game.

(2) According to the gaming machine, it is further provided with carryover means (for example, means for carrying out a process of a step S34 in FIG. 15, main control circuit 71) for carrying over the first combination as an internal winning combination until a symbol combination corresponding to the first combination is displayed by the symbol display means, on condition that the internal winning combination determining means determines the first combination as an internal winning combination, and the awarding means comprises means (for example, means for carrying out a process of a step S25 in FIG. 14) for operating an advantage state (for example, RB gaming state) which is relatively advantageous to the player, on condition that the symbol combination (for example, ┌Red 7-Red 7-Red 7┘ or ┌Blue 7-Blue 7-Blue 7┘) corresponding to the first combination is displayed by the symbol display means; and game value awarding means (for example, means for carrying out a process of a step S22 in FIG. 14) for awarding a game value (for example, 15 medals) to the player, on condition that the symbol combination (for example, ┌White 7-Bell-Bell┘) corresponding to the second combination is displayed by the symbol display means, and awarding the game value or a game value (for example, 2 medals or 4 medals) different from it to the player, on condition that the symbol combination (for example, ┌Cherry-Any-Any┘) corresponding to the third combination is displayed by the symbol display means.

According to the gaming machine described in the above (2), when the symbol combination corresponding to the second combination is displayed by the symbol display means, the symbol combination corresponding to the first combination determined as an internal winning combination together with the second combination by the internal winning combination determining means is not displayed by the symbol display means. Accordingly, the first combination is carried over by the carryover means. In the mean time, when the symbol combination corresponding to the third combination is displayed by the symbol display means, the symbol combination corresponding to the first combination determined as an internal winning combination together with the third combination by the internal winning combination determining means is not displayed by the symbol display means. Accordingly, the first combination may be carried over by the carryover means. At this time, when only the third combination is determined by the internal winning combination determining means, the first combination is not carried over. Since the player's expectations that the first combination will be carried over can be made to be different depending on whether the displayed symbol combination corresponds to the second combination or the third combination, it is possible to increase the interest in the game. In addition, since it is different degrees of the expectations that the first combination will carried over and the symbol combination corresponding to the first combination is displayed by the symbol display means, so that an advantageous gaming state will be operated, the player can sufficiently enjoy the game.

(3) There is provided a gaming machine comprising: game value information storing means (for example, means for updating a bet number, main control circuit 71) for storing information (for example, bet number) of a game value (for example, medal); game start command means (for example, start switch 6S, means for carrying out a process of a step S3 in FIG. 12, main control circuit 71) for outputting a game start command signal to start a unit game (for example, one game) in accordance with an operation of a player (for example, start operation); symbol display means (for example, reels 3L, 3C, 3R, symbol display areas 21L, 21C, 21R) having plural display units (for example, symbol display areas 21L, 21C, 21R) capable of variably displaying plural types of symbols, on condition that the information of game value is stored in the game value information storing means when the game start command signal is detected; stop command means (for example, stop switches 7LS, 7CS, 7RS) provided to correspond to each of the plural display units and outputting a stop command signal to stop the variable display of symbols in the corresponding display units in accordance with an operation (for example, operation of stop buttons 7L, 7C, 7R) by a player; internal winning combination determining means (for example, means for carrying out a probability sortition process, main control circuit 71) for determining an internal winning combination (for example, internal carryover combination), on condition that the game start command signal is detected; stop control means (for example, means for carrying out a sliding-symbol-number deciding process, means for carrying out processes in steps S16˜S18 of FIG. 13, main control circuit 71) for stopping the variable display of symbol of the display unit corresponding to the detected stop command signal, on condition that the stop command signal is detected (for example, a result of determination in a step S13 of FIG. 13 is YES); combination determining means (for example, means for carrying out a step S20 in FIG. 14, main control circuit 71) for determining whether a symbol combination, which is arranged along a line (for example, center line 8c) connecting symbol stop positions (for example, center symbol stop positions of the respective symbol display areas 21L, 21C, 21R) predetermined for each of the display units, corresponds to an internal winning combination determined by the internal winning combination determining means, on condition that the plural display units stop the symbols; means (for example, means for carrying out processes of a step S22 and a step S25 in FIG. 14, main control circuit 71) for awarding a payout (for example, payout of medal, automatic insertion of medal, shift of gaming state, etc.) to the player, on condition that the combination determining means determines that the symbol combination arranged along the line corresponds to the internal winning combination determined by the internal winning combination determining means, the payout corresponding to the determined internal winning combination; display means (for example, identification information area 77) capable of displaying identification information discernible by the player along the line (for example, center line 8c); and display control means (for example, sub-control circuit 72) for controlling the display means.

According to the gaming machine described in the above (3), the display means is capable of displaying identification information discernible by the player along the line. Accordingly, by changing a display mode of the identification information to notify or suggest the game related information, the player can enjoy the game while positively perceiving the change. In addition, through the notification, the player may pay attention to the symbol combination arranged on the line along which the identification information is displayed.

(4) There is provided a gaming machine comprising: symbol display means (for example, reels 3L, 3C, 3R, symbol display areas 21L, 21C, 21R) for displaying plural symbols; start signal output means (for example, start switch 6S, main control circuit 71) for outputting a command signal to start a unit game (for example, one game) in accordance with an operation (for example, start operation, etc.) by a player; internal winning combination determination information storing means (for example, probability sortition table, RAM 33, ROM 32, main control circuit 71) for storing internal winning combination determination information (for example, probability sortition table (see FIG. 20A,20B)) having information about the lowest limit (for example, ┌0┘) and the upper limit (for example, ┌299┘) of numerical ranges corresponding to each of predetermined plural combinations (for example, RB, Small Win of White 7, Small Win of Cherry, Replay, Small Win of Bell); internal winning combination determining means (for example, means for carrying out a probability sortition process, main control circuit 71) for determining a combination corresponding to a numerical range including a random number value (for example, random number value sampled in a process of a step S4 of FIG. 12) sampled by a random number lottery, as an internal winning combination (for example, internal carryover combination), based on the internal winning combination determination information; symbol varying means (for example, stepping motors 49L, 49C, 49R, main control circuit 71) for varying (for example, variably displaying) symbols to be displayed by the symbol display means, on condition that a signal is outputted by the start signal output means; stop signal output means (for example, stop switches 7LS, 7CS, 7RS) for outputting a command signal (for example, stop command signal) to stop the symbol variation carried out by the symbol varying means, in accordance with an operation (for example, operation of stop buttons 7L, 7C, 7R) by a player; stop control means (for example, means for carrying out a sliding-symbol-number deciding process, means for carrying out processes in steps S16˜S18 of FIG. 13, main control circuit 71) for carrying out a stop control of the symbol variation carried out by the symbol varying means, based on a signal outputted by the stop signal output means and an internal winning combination determined by the internal winning combination determining means; and means (for example, means for carrying out a process of a step S22 in FIG. 14, main control circuit 71) for awarding a payout (for example, payout of medal, automatic insertion of medal, shift of gaming state, etc.) to a player, when a predetermined symbol combination (for example, symbol combination corresponding to Small Win of Bell) is displayed by the symbol display means, wherein the internal winning combination determination information includes information of the first lowest limit (for example, ┌0┘) and the first upper limit (for example, ┌299┘) corresponding to a first combination (for example, RB), information of the second lowest limit (for example, ┌100┘) and the second upper limit (for example, ┌199┘) corresponding to a second combination (for example, Small Win of White 7) and information of the third lowest limit (for example, ┌200┘) and the third upper limit (for example, ┌349┘) corresponding to a third combination (for example, Small Win of Cherry), wherein the information of the second lowest limit is the information of a value of the first lowest limit or more, the information of the second upper limit is the information of a value of the first upper limit or less, and the information of the third lowest limit is one of the information of a value of the first lowest limit or more and the information of a value smaller than the first lowest limit, and wherein when the information of the third lowest limit is the information of a value of the first lowest limit or more, the information of the third upper limit is the information of a value greater than the first upper limit, and when the information of the third lowest limit is the information of a value smaller than the first lowest limit, the information of the third upper limit is the information of a value of the first upper limit or less.

According to the gaming machine described in the above (4), the internal winning combination determination information includes the information of the first lowest limit and the first upper limit corresponding to a first combination, the information of the second lowest limit and the second upper limit corresponding to a second combination and the information of the third lowest limit and the third upper limit corresponding to a third combination. At this time, the information of the second lowest limit is the information of a value of the first lowest limit or more, and the information of the second upper limit is the information of a value of the first upper limit or less. In addition, the information of the third lowest limit is one of the information of a value of the first lowest limit or more and the information of a value smaller than the first lowest limit. When the information of the third lowest limit is the information of a value of the first lowest limit or more, the information of the third upper limit is the information of a value greater than the first upper limit, and when the information of the third lowest limit is the information of a value smaller than the first lowest limit, the information of the third upper limit is the information of a value of the first upper limit or less. Accordingly, when the second combination is an internal winning combination, the first combination is always determined as an internal winning combination, and when the third combination is an internal winning combination, there are a case where the first combination is determined as an internal winning combination and a case where the first combination is not determined as an internal winning combination. In other words, when a symbol combination corresponding to the second combination is displayed, the first combination is determined without fail, and when a symbol combination corresponding to the third combination is displayed, the first combination may not be determined. Like this, since the player's expectations that the first combination will be an internal winning combination can be made to be different depending on whether the displayed symbol combination corresponds to the second combination or the third combination, it is possible to increase the interest in the game.

### BRIEF DESCRIPTION OF THE DRAWINGS

Other and further objects, features and advantages of the invention will appear more fully from the following description taken in connection with the accompanying drawings, in which:

FIG. 1 is a perspective view showing an external appearance of a gaming machine according to an embodiment of the invention;

FIG. 2 shows a panel display unit, a liquid crystal display unit and a fixed display unit;

FIG. 3 is a perspective view showing a schematic structure of a liquid crystal display unit;

FIG. 4 is a view showing an example of symbols arranged on reels;

FIG. 5 is a block diagram of an electric circuit;

FIG. 6 shows an occurrence condition of each gaming state, a shift condition and a gaming state of a shift place;

FIG. 7 shows a relationship of a combination, a symbol combination and a payout number;

FIG. 8A shows an internal winning combination storing area;

FIG. 8B shows an internal carryover combination storing area;

FIG. 9A shows a probability sortition table for normal gaming state;

FIG. 9B shows a probability sortition table for RB gaming state;

FIG. 9C shows a probability sortition table for carryover state;

FIG. 10A shows a stop table;

FIG. 10B shows a stop table;

FIG. 11 shows a display combination priority table;

FIG. 12 is a main flow chart of a main control circuit;

FIG. 13 is a flow chart following FIG. 12;

FIG. 14 is a flow chart following FIG. 13;

FIG. 15 is a flow chart showing a gaming status supervisory process;

FIG. 16 is a flow chart showing a probability sortition process;

FIG. 17 is a flow chart showing a sliding-symbol-number deciding process;

FIG. 18 is a flow chart following FIG. 17;

FIG. 19 shows a probability sortition table determining table;

FIG. 20A shows a probability sortition table for normal gaming state;

FIG. 20B shows a probability sortition table for RB gaming state;

FIG. 21 shows a random number value storing area;

FIG. 22 shows an internal winning combination determining table;

FIG. 23 is a flow chart showing a probability sortition process;

FIG. 24 is a flow chart following FIG. 23;

FIG. 25A is a view showing a display example of a liquid crystal display unit;

FIG. 25B is a view showing a display example of a liquid crystal display unit;

FIG. 26 shows a panel display unit, a liquid crystal display unit and a fixed display unit of a liquid crystal display device;

FIG. 27 shows an example of symbols arranged on reels;

FIG. 28A shows a display example of a liquid crystal display unit;

FIG. 28B shows a display example of a liquid crystal display unit;

FIG. 29 shows a symbol arrangement table;

FIG. 30 shows a symbol combination table;

FIG. 31 shows an internal lottery table determining table;

FIG. 32 shows an internal lottery table;

FIG. 33 shows an internal winning combination determining table;

FIG. 34 shows a reel stop beginning determination table;

FIG. 35 shows a stop table;

FIG. 36 shows a stop table;

FIG. 37 shows a stop table;

FIG. 38 shows a priority attraction-in ranking table;

FIG. 39 shows a table on bonus operation;

FIG. 40A shows an internal winning combination 1 storing area;

FIG. 40B shows an internal winning combination 2 storing area;

FIG. 40C shows an internal carryover combination storing area;

FIG. 40D shows a random number value storing area;

FIG. 41 is a main flow chart of a min control circuit;

FIG. 42 is a flow chart following FIG. 41;

FIG. 43 is a flow chart showing a bonus operation supervisory process;

FIG. 44 is a flow chart showing a medal insertion(start checking process;

FIG. 45 is a flow chart showing a gaming status supervisory process;

FIG. 46 is a flow chart showing an internal lottery process;

FIG. 47 is a flow chart following FIG. 46;

FIG. 48 is a flow chart showing a reel stop initialization process;

FIG. 49 is a flow chart showing a reel stop control process;

FIG. 50 is a flow chart showing a sliding-symbol-number deciding process;

FIG. 51 is a flow chart showing a sliding-symbol-number deciding process for bonus+Small Win;

FIG. 52 is a flow chart showing a display combination retrieving process;

FIG. 53 is a flow chart showing a bonus end checking process;

FIG. 54 is a flow chart showing a bonus operation checking process; and

FIG. 55 is a flow chart showing an intervention process under control of a main CPU.

### DESCRIPTION OF THE PREFERRED EMBODIMENTS

Hereinafter, it will be described preferred embodiments of the invention with reference to the drawings.

### Embodiment 1

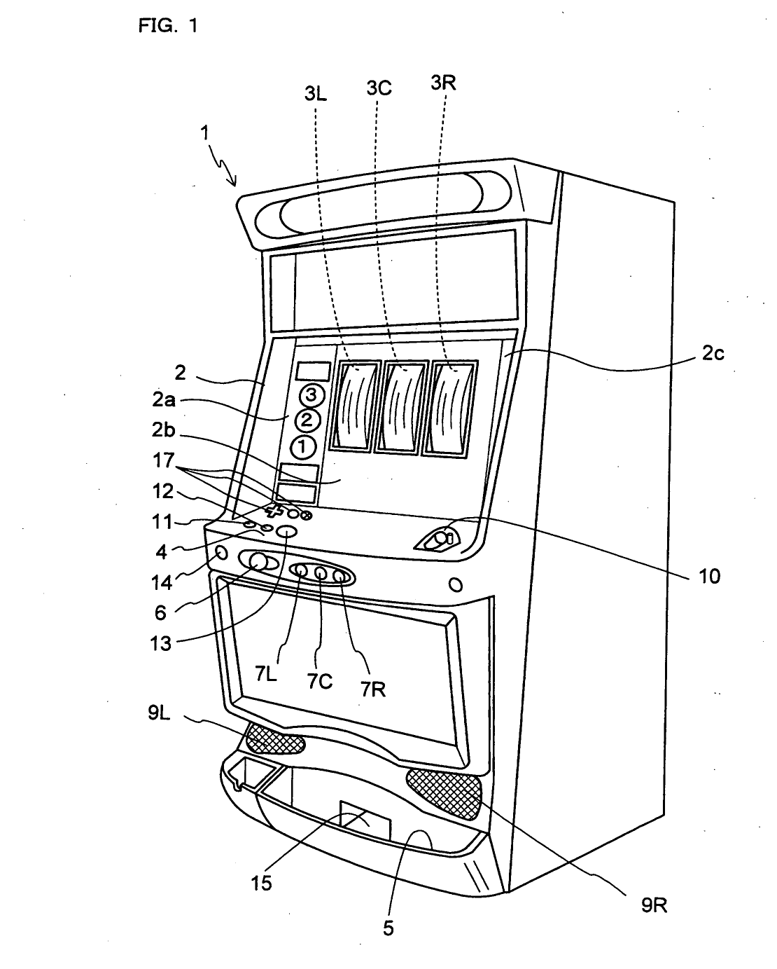

FIG. 1 is a perspective view showing an external appearance of a gaming machine 1 according to an embodiment of the invention. The gaming machine 1 is a so-called pachi-slot machine. The gaming machine 1 is a gaming machine played with a game medium such as coin, medal, gaming ball, token, and card memorizing information about a game value awarded or to be awarded to a player. In the followings, it is described that a medal is used to play the game.

A front door 2 is provided at a front surface thereof with a panel display unit 2a having an approximate vertical surface, a liquid crystal display unit 2b and a fixed display unit 2c (which will be specifically described later). In addition, three reels 3L, 3C, 3R having plural symbols drawn on peripheries thereof are rotatably mounted horizontally in a row at the rear of the front door 2. Each of the reels 3L, 3C, 3R is rotated at a constant speed (for example, 80 revolutions/min).

A base portion 4 having an approximate horizontal surface is provided below the panel display unit 2a, the liquid crystal display unit 2b and the fixed display unit 2c. A medal insertion slot 10 for inserting a medal is formed at a right side of the base portion 4. The inserted medal is credited or bet per a game. The base portion 4 is provided at a left side thereof with a 1-BET switch 11, a 2-BET switch 12 and a MAX-BET switch 13 for betting medals credited through a push operation.

When the 1-BET switch 11 is pushed one time, 1 piece of medals credited is bet per a game, when the 2-BET switch 12 is pushed one time, 2 pieces of medals credited is bet per a game, and when the MAX-BET switch 13 is pushed one time, the maximum medals which can be bet per a game are bet.

When the BET-switches 11 to 13 are pushed, a predetermined display line is activated (which will be specifically described later). Hereinafter, the operation of the BETswitches 11 to 13 and an operation of inserting a medal into the medal insertion slot 10 (operation of inserting a medal so as to play a game) are referred to as ┌BET operation┘. An operating unit 17 is mounted above the BET switches 11 to 13. The operating unit 17 is manipulated so as to display information such as game history on a liquid crystal display device 131.

The base portion 4 is provided at the frontal left side with a C/P switch 14 for switching credits/payouts of medals, which are obtained by a player through the game, through a push operation. When the C/P switch 14 is operated, the medals are paid out from a medal payout slot 15 at a front lower side and the paid out medals are stacked in a medal tray 5. Speakers 9L, 9R for producing an effect sound regarding the game effect are provided at the upper left and right sides of the medal tray 5.

A start lever 6 for rotating the reels to variably display the symbols in display windows 21L, 21C, 21R by a manipulation of the player is mounted at the right side of the C/P switch 14 to be rotatable within a predetermined range of angles.

Three stop buttons 7L, 7C, 7R for stopping rotation of the reels 3L, 3C, 3R are provided at the right side of the start lever 6 in the frontal center of the base portion 4. In addition, in one embodiment, a one game (i.e., unit game) is basically started by the operation of the start lever 6 and is over when all the reels 3L, 3C, 3R are stopped.

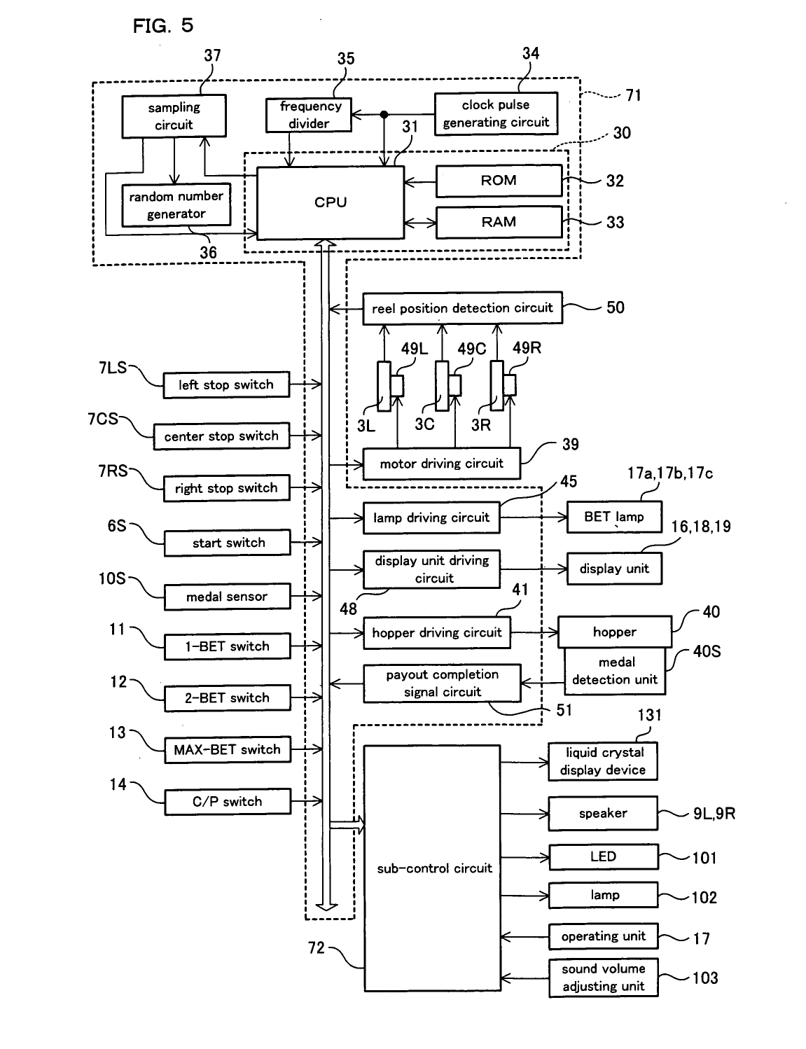

Herein, in one embodiment, a stop operation of the reel (i.e., operation of the stop button) carried out while all the reels are being rotated is referred to as a first stop operation, a stop operation which is carried out following the first stop operation is referred to as a second stop operation, and a stop operation which is carried out following the second stop operation is referred to as a third stop operation. In addition, stop switches 7LS, 7CS, 7RS are arranged at the rear of the stop buttons 7L, 7C, 7R, which will be described with reference to FIG. 5. The stop switches detect push operations (i.e., stop operations) of the corresponding stop buttons.

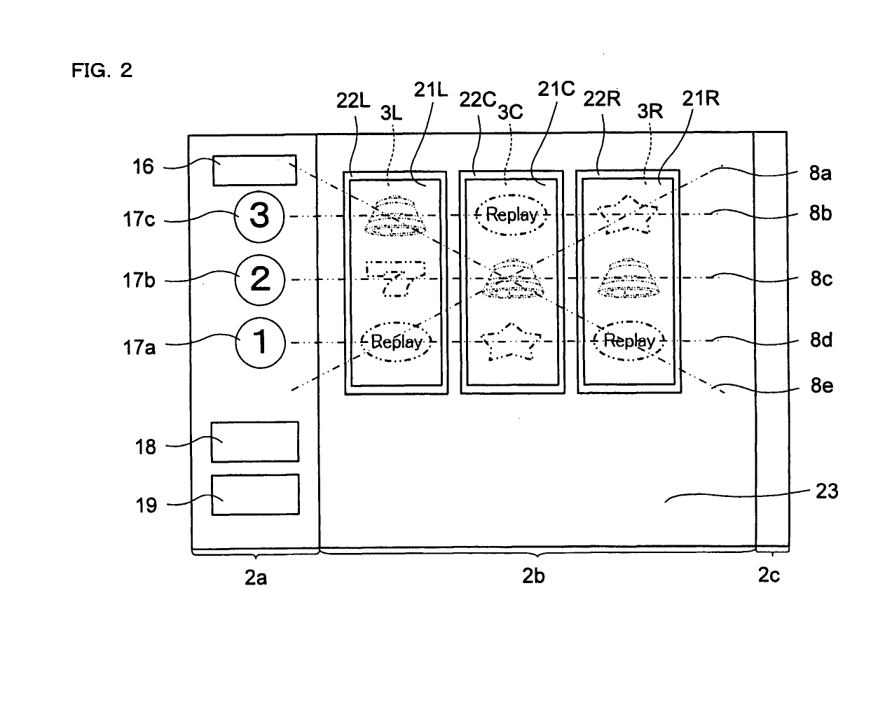

Hereinafter, the panel display unit 2a, the liquid crystal display unit 2b and the fixed display unit 2c are described with reference to FIG. 2.

The panel display unit 2a consists of a bonus game information display unit 16, BET lamps 17a to 17c, a payout display unit 18 and a credit display unit 19. The bonus game information display unit 16 consists of 7 segment LEDs and displays game information during a bonus game. The 1-BET lamp 17a, the 2-BET lamp 17b and the MAX-BET lamp 17c are turned on in accordance with the number of medals bet so as to play a one game (hereinafter, referred to as ┌bet number┘).

The 1-BET lamp 17a is turned on when the bet number is 1. The 2-BET lamp 17b is turned on when the bet number is 2. The MAX-BET lamp 17c is turned on when the bet number is 3. The payout display unit 18 and the credit display unit 19 consist of 7 segment LEDs, respectively, and display a payout number of medals at the time when a winning is made (a combination is made) and a number of medals credited.

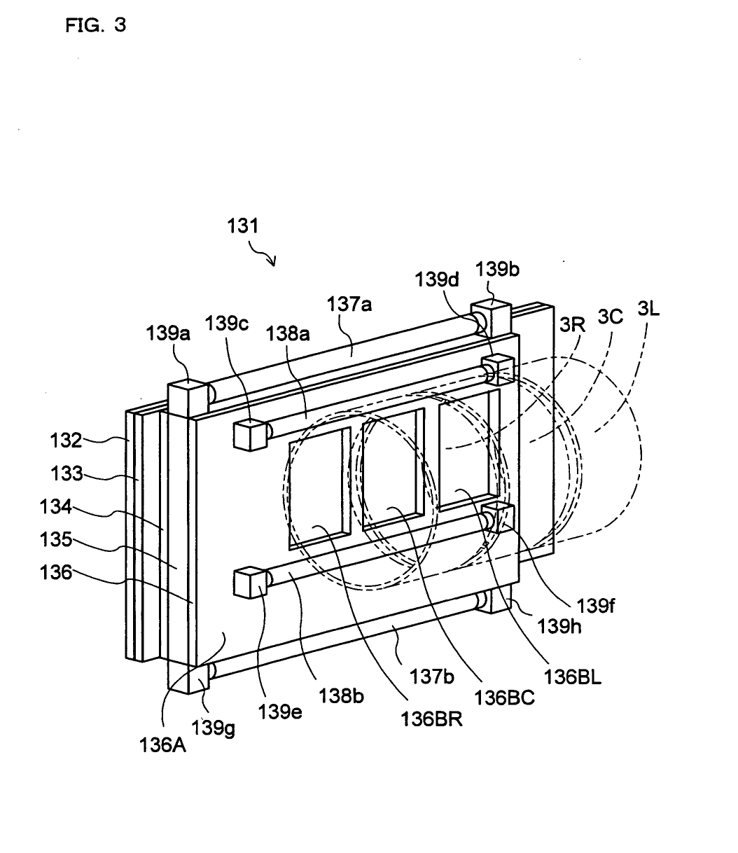

The liquid crystal display unit 2b consists of symbol display areas 21L, 21C, 21R, frame display areas 22L, 22C, 22R and an effect display area 23. The display contents of the liquid crystal display unit 2b are adopted to vary in accordance with the rotation and the stop modes of the reels 3L, 3C, 3R and an operation of the liquid crystal display device 131 (see FIG. 3).

Each of the display windows 21L, 21C, 21R is mounted to correspond to each of the reels 3L, 3C, 3R and carries out the display of symbols arranged on the reels 3L, 3C, 3R or various displays for effects.

The symbol display areas 21L, 21C, 21R are provided with display lines, i.e., top line 8b, center line 8c and bottom line 8d which are horizontally directed and cross-up line 8a and cross-down line 8e which are diagonally directed. When the player pushes the BET-switches 11 to 13 or inserts medals into the medal insertion slot 10, one, three and five of these display lines are activated, respectively (hereinafter, activated display line is referred to as ┌activated line┘). The BET lamps 17a, 17b, 17c are turned on to express which of the display lines are activated. Herein, the display lines 8a to 8e are related to whether a combination is made or not.

The symbol display areas 21L, 21C, 21R are under transmissive state so that the player can see the symbols on the reels 3L, 3C, 3R, at least when the corresponding reels 3L, 3C, 3R are being rotated and when the corresponding stop buttons 7L, 7C, 7R can be pushed.

The frame display areas 22L, 22C, 22R are mounted to surround each of the symbol display areas 21L, 21C, 21R, and display the frames of the symbol display areas 21L, 21C, 21R arranged on the front of the reels 3L, 3C, 3R.

The effect display area 23 is an area except the symbol display areas 21L, 21C, 21R and the frame display areas 22L, 22C, 22R of the liquid crystal display unit 2b. The effect display area 23 displays an image (for example, notification lamp) definitely notifying that a bonus can be made, an effect for increasing an interest in a game and information required so that a player can advantageously play a game.

The fixed display unit 2c is an area in which a predetermined figure, picture and the like are drawn. It may be such structured that the figure, picture and the like drawn on the fixed display unit 2c and the image displayed on the effect display area 23 are correlated to display one still image or moving image.

FIG. 3 is a perspective view of schematically showing a structure of the liquid crystal display device 131. First, an inside structure of the reels 3L, 3C, 3R is described. In the reels 3L, 3C, 3R, LED receiving circuit boards are mounted at the rear of the three rows of symbols (i.e., 9 symbols) which are displayed on each of the symbol display areas 21L, 21C, 21R when the rotation of reels 3L, 3C, 3R are stopped. The LED receiving circuit boards include three LED receiving units (i.e., total nine), respectively, and plural LED lamps are mounted therein.

The LED lamps illuminate rear surfaces of reel sheets mounted along the peripheries of the reels 3L, 3C, 3R. More specifically, they illuminate areas corresponding to the symbol display areas 21L, 21C, 21R. The reel sheet is structured to have a transparent property and the lights emitted from the LED lamps pass through the front surface of the reel sheet.

In addition, the left reel 3L consists of a cylindrical frame structure formed by spacing two ring-shaped frames having a same shape at an interval and connecting them with plural connection members, and a transfer member for transferring a driving force of a stepping motor 49L mounted at a center of the frame structure to the ring-shaped frames. In addition, the reel sheet is mounted along the periphery of the left reel 3L.

The LED receiving circuit board arranged in the reel 3L includes three LED receiving units for receiving plural LED lamps. The LED receiving circuit board is mounted in such a way that the LED receiving units are respectively located at the rears of symbols (i.e., total 3 symbols) that a player can see through the symbol display 21L. In addition, the center reel 3C and the right reel 3R have also the same structure as the left reel 3L and comprise the LED receiving circuit boards therein, respectively.

Next, the transmissive liquid crystal display device 131 is described. The liquid crystal display device 131 consists of a protecting glass 132, a display plate 133, a liquid crystal panel 134, a light guide plate 135, a reflecting film 136, fluorescent lamps 137a, 137b, 138a, 138b which are so-called white light sources (for example, means for generating lights, including all wavelengths of lights, with a proportion that a specific color is unnoticeable), and a flexible board (not shown) consisting of a table carrier package having an IC for driving the liquid crystal panel mounted thereon and connected to a terminal unit of the liquid crystal panel 134.

The liquid crystal display device 131 is mounted just at the front (i.e., in front of a display surface), viewing from the reels 3L, 3C, 3R. In addition, the reels 3L, 3C, 3R and the liquid crystal display device 131 are separately (for example, at an interval) mounted.

The protecting glass 132 and the display plate 133 are made of transmissive members. The protecting glass 132 is provided to protect the liquid crystal panel 134. In the display plate 133, a figure, a picture and the like are drawn on areas corresponding to the panel display unit 2a and the fixed display unit 2c (see FIG. 2).

Herein, in FIG. 3, it is not shown an electric circuit provided to operate the various display units (the bonus game information display unit 16, the payout number display unit 18, the credit display unit 19) and the BET lamps 17a to 17c arranged at the rear of the display plate 133 corresponding to the panel display unit 2a.

In the liquid crystal panel 134, liquid crystals are sealingly injected in a gap between a transparent board such as glass plate having a thin film transistor layer formed thereon and a transparent board opposite to the board. A display mode of the liquid crystal panel 134 is set as a normally white. The normally white is such a structure that it becomes a white display under state that the liquid crystal is not driven (i.e., a voltage is not applied to the liquid crystal panel 134). In other words, the light travels to the display surface, so that the transmitted light is visible from.

Accordingly, by adopting the liquid crystal panel 134 structured with the normally white, even when there occurs a state at which the liquid crystal cannot be driven, it is possible to see the symbols arranged on the reels 3L, 3C, 3R through the symbol display areas 21L ,21C, 21R and to continuously play the game. In other words, even when there occurs such state that the liquid crystal cannot be driven, it is possible to play the game in relation to the rotation and stop of the reels 3L, 3C, 3R.

The light guide plate 135 is provided at the rear of the liquid crystal panel 134 so as to guide the light from the fluorescent lamps 137a, 137b into the liquid crystal panel 134 (i.e., to illuminate the liquid crystal panel 134) and consists of a transmissive member (i.e., a member having a light guide function) such as acryl-based resin having about 2 cm thickness, for example.

For the reflecting film 136, it is possible to use a material having silver deposition film formed on a white polyester film or aluminum thin film, for example. The reflecting film reflects the light, which is introduced into the light guide plate 135, toward the front. Thereby, the liquid crystal panel 134 is illuminated. The reflecting film 136 consists of a reflecting area 136A and non-reflecting areas (i.e., transmissive areas) 136BL, 136BC, 136BR. The non-reflecting areas 136BL, 136BC, 136BR are made of transparent materials, so that they transmit the incident light without reflecting it.

In addition, the non-reflecting areas 136BL, 136BC, 136BR are provided at front positions of the symbols which are displayed when the rotation of reels 3L, 3C, 3R is stopped. In the mean time, sizes and positions of the non-reflecting areas 136BL, 136BC, 136BR are structured to be matched to the symbol display areas 21L, 21C, 21R (see FIG. 2). Further, in the reflecting film 136, an area except the non-reflecting areas 136BL, 136BC, 136BR is the reflecting area 136A which reflects the light introduced to the light guide plate 135 toward the front.

The fluorescent lamps 137a, 137b are arranged along upper and lower ends of the light guide plate 135 and supported at their both ends by the lamp holders 139a, 139b, 139g, 139h. The fluorescent lamps 137a, 137b generate the light to be introduced into the light guide plate 135.

The fluorescent lamps 138a, 138b are arranged at upper and lower parts of the rear of the reflecting film 136. The lights generated from the fluorescent lamps 138a, 138b are reflected at the surfaces of the reels 3L, 3C, 3R and incident on the non-reflecting area 136BL, 136BC, 136BR. The incident lights pass through the non-reflecting area 136BL, 136BC, 136BR and illuminate the liquid crystal panel 134.

Hereinafter, functions of the LED lamps and the fluorescent lamps 137a, 137b, 138a, 138b are described.

First, it is described a function of each lamp when the liquid crystals of the symbol display areas 21L, 21C, 21R are not driven (i.e., voltage is not applied to parts corresponding to the symbol display areas 21L, 21C, 21R of the liquid crystal panel 134).

Some of the lights emitted from the fluorescent lamps 138a, 138b are reflected by the reel sheet. In addition, some of the lights emitted from the LED lamps mounted at the LED receiving circuit board penetrate the reel sheet. Since these lights penetrate the non-reflecting areas 136BL, 136BC, 136BR, and the light guide plate 135 and the liquid crystal panel 134 which constitute the liquid crystal display device 131, the player can see the symbols arranged on the reels.

In addition, the lights emitted from the fluorescent lamps 137a, 137b and introduced toward the light guide plate 135 pass through the liquid crystal panel 134 and are incident to the player's eyes. In other words, the areas of the liquid crystal panel 134 corresponding to the frame display areas 22L, 22C, 22R and the effect display area 23 are illuminated by the fluorescent lamps 137a, 137b.

Next, it is described a function of each lamp when the liquid crystals of the symbol display areas 21L, 21C, 21R are driven (i.e., voltage is applied to parts corresponding to the symbol display areas 21L, 21C, 21R of the liquid crystal panel 134).

Some of the lights emitted from the fluorescent lamps 138a, 138b are reflected by the reel sheet. In addition, some of the lights emitted from the LED lamps penetrate the reel sheet. Since some of these lights are reflected or absorbed in the liquid crystal driven area of the areas of the liquid crystal panel 134, the player can see an effect image and the like displayed on the symbol display areas 21L, 21C, 21R.

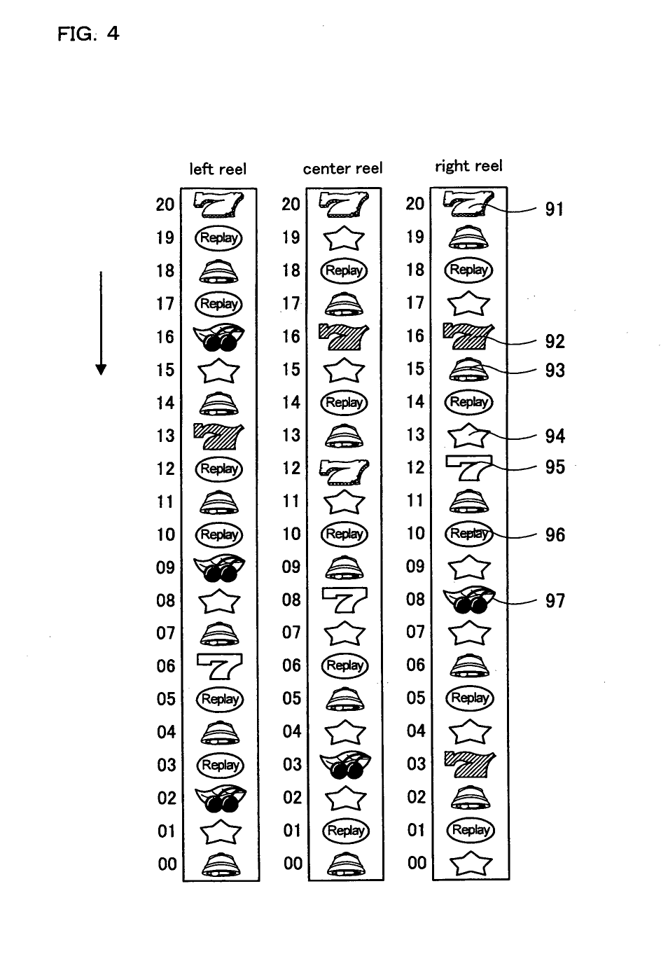

FIG. 4 shows symbol rows displayed on the reels 3L, 3C, 3R, in each of which 21 symbols are arranged. Each of the symbols is given with code numbers of ┌00┘˜┌20┘, and stored (memorized) as a symbol arrangement table in a ROM 32 (see FIG. 5) which will be described later. Each of the reels 3L, 3C, 3R is arranged with the symbol row consisting of ┌Red 7 (symbol 91)┘, ┌Blue 7 (symbol 92)┘, ┌Bell (symbol 93)┘, ┌Blank (symbol 94)┘, ┌White 7 (symbol (95)┘, ┌Replay (symbol 96)┘ and ┌Cherry (symbol 97)┘. Each of the reels 3L, 3C, 3R is rotated so that the symbol rows are moved in an arrow direction of FIG. 4.

┌Blank┘ is a symbol which is not directly related to establishment of a combination. In other words, even though ┌Blank┘ is displayed along one activated line, the payout, such as automatic insertion of medal, shift of gaming state, etc. is not awarded to the player.

┌Cherry┘ is a symbol which is stopped in a predetermined variable display unit (for example, left symbol display area 21L) to establish a predetermined combination (Small Win of Upper and Lower Cherry, Small Win of Center Cherry). Hereinafter, Small Win of Upper and Lower Cherry and Small Win of Center Cherry are collectively referred to as ┌Small Win of Cherry┘.

In one embodiment, RB, Small Win of White 7, Replay, Small Win of Bell, Small Win of Upper and Lower Cherry and Small Win of Center Cherry are provided as a combination. In addition, RB is a first type special single bonus. The combination (combination data) is the control information in which a payout to be paid out a player is matched to a symbol combination, and used to switch (shift) a gaming state and to award a game value, etc.

FIG. 5 shows a circuit structure comprising a main control circuit 71 controlling a game process operation of the gaming machine 1, a peripheral device (i.e., actuator) electrically connected to the main control circuit 71, and a sub-control circuit 72 controlling the liquid crystal display device 131, the speakers 9L, 9R, the LED 101 and the lamp 102 on the basis of control signals transmitted from the main control circuit 71.

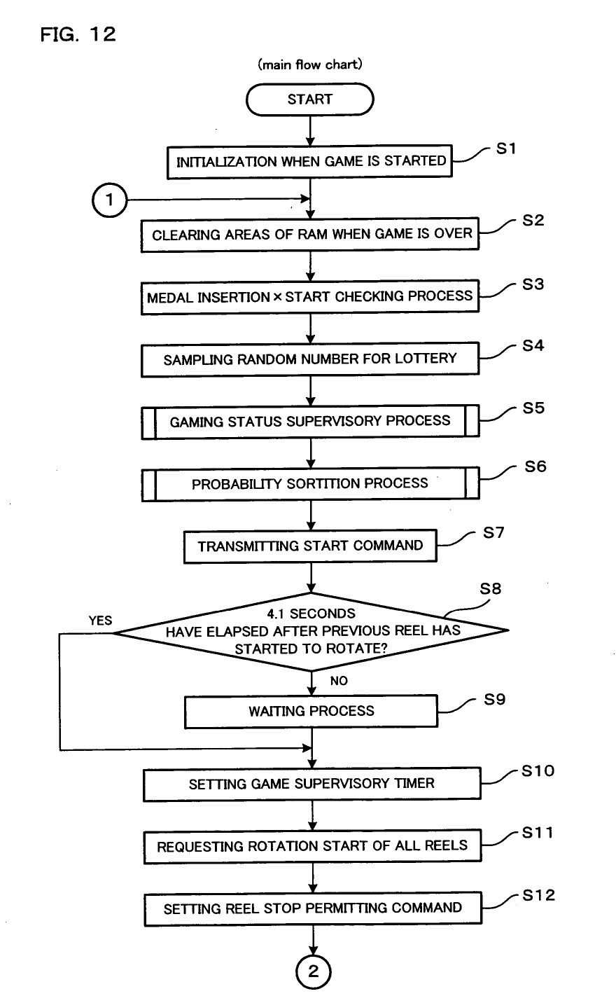

The main control circuit 71 comprises a micro computer 30 arranged on a circuit board as a main constituting element and is further provided with a circuit for sampling random numbers. The micro computer 30 includes a CPU 31 for carrying out control operations in accordance with preset programs (see FIGS. 12 to 18), and a ROM 32 and a RAM 33 which are memory means.

To the CPU 31 is connected a clock pulse generating circuit 34, a frequency divider 35, a random number generator 36 for generating a random number to be sampled and a sampling circuit 37. In the mean time, it may be structured such that the random number sampling is carried out in the micro computer 30, i.e., on an operating program of the CPU 31. In this case, the random number generator 36 and the sampling circuit 37 may be omitted. However, they may be also held for a backup of the random number sampling operation.

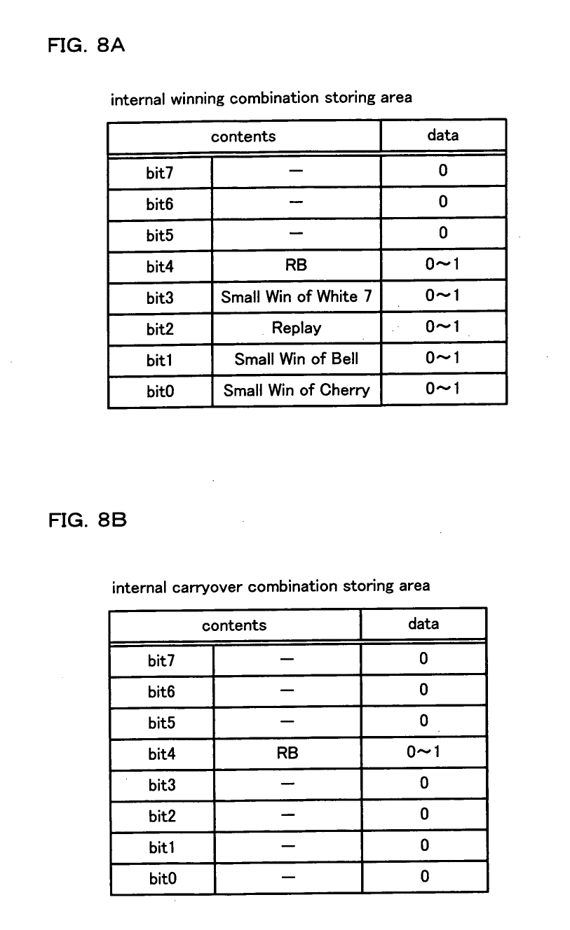

The ROM 32 of the micro computer 30 stores a probability sortition table used to determine the random number sampling which is carried out whenever the start lever 6 is operated (start operation), a stop table group for determining a stop mode of the reel in accordance with the operation of the stop button, and the like. In addition, various control commands for being transmitted to the sub-control circuit 72 and the like stored therein. In the mean time, a command, information and the like are not transmitted from the sub-control circuit 72 to the main control circuit 71. In other words, it is carried out a one-way communication from the main control circuit 71 to the sub-control circuit 72. Various information is stored in the RAM 33 which is provided with storing areas shown in FIG. 8A,8B. The RAM 33 stores an internal winning combination, an internal carryover combination, the information about a current gaming state, and the like.

In the circuit shown in FIG. 5, main actuators controlled by control signals from the micro computer 30 include display units such as BET lamps (1-BET lamp 17a, 2-BET lamp 17b, MAX-BET lamp 17c), bonus game information display unit 16, payout display unit 18, credit display unit 19 and the like, a hopper 40 (including a driving unit for payout) receiving a medal and paying out a predetermined number of medals by a command of a hopper driving circuit 41, and stepping motors 49L, 49C, 49R for rotating the reels 3L, 3C, 3R.

In addition, to the CPU 31 are connected a motor driving circuit 39 for controlling the stepping motors 49L, 49C, 49R, the hopper driving circuit 41 for controlling the hopper 40, a lamp driving circuit 45 for turning on/off the BET lamps 17a, 17b, 17c and a display unit driving circuit 48 for controlling the display units, such as bonus game information display unit 16, payout display unit 18, credit display unit 19 and the like. These driving circuits receive the control signals outputted from the CPU 31 to control the operations of the actuators, respectively.

In addition, as means for generating an input signal required so that the micro computer 30 generates a control signal, there are provided the start switch 6S, the stop switches 7LS, 7CS, 7RS, the 1-BET switch 11, the 2-BET switch 12, the MAX-BET switch 13, the C/P switch 14, a medal sensor 10S, a reel position detection circuit 50 and a payout completion signal circuit 51.

The start switch 6S detects a manipulation of the start lever 6. The medal sensor 10S detects a medal inserted into the medal insertion slot 10S. The stop switches 7LS, 7CS, 7RS generate a. stop signal in accordance with the operations of the corresponding stop buttons 7L, 7C, 7R. The reel position detection circuit 50 receives a pulse signal from reel rotating sensors and supplies a signal for detecting a position of the respective reels 3L, 3C, 3R to the CPU 31. The payout completion signal circuit 51 generates a signal for detecting a payout completion of the medal when a value counted by a medal detection unit 40S (i.e., the number of medals paid out from the hopper 40) reaches a predetermined value.

In the circuit of FIG. 5, the random number generator 36 generates random numbers within a predetermined range, and the sampling circuit 37 samples one random number value at an appropriate timing after the start lever 6 is manipulated. The random number value sampled is used to determine an internal winning combination and the like on the basis of the probability sortition table stored in the ROM 32, for example.

After the reels 3L, 3C, 3R start to rotate, it is counted the number of driving pulses supplied to the respective stepping motors 49L,49C, 49R and the counted value is written in a predetermined area of the RAM 33. In the mean time, a reset pulse is obtained from the reels 3L, 3C, 3R every one revolution and inputted to the CPU 31 through the reel position detection circuit 50. The counted value of the driving pulses stored in the RAM 33 is cleared to ┌0┘ by the reset pulse. Thereby, the counted value of the driving pulses corresponding to a rotating position within a range of one revolution is stored in the RAM 33, with regard to each of the reels 3L, 3C, 3R.

In order to match the rotating positions of the reels 3L, 3C, 3R to the symbols arranged on the peripheries of the reels, a symbol table (not shown) is stored in the ROM 32. In this symbol table, on the basis of the rotating positions generated by the reset pulse, code numbers sequentially given every rotation pitch of the respective reels 3L, 3C, 3R are matched to symbol codes representing symbols provided to correspond to each of the code numbers.

In addition, a symbol combination table (not shown) is stored in the ROM 32. In the symbol combination table, it is matched a combination of symbols in which a combination is made (winning), the payout number of medals of the winning and a winning determining code (establishment determining code) representing that the winning is made. The symbol combination table is referred to when it is carried out a control for stopping the rotations of the left reels 3L, the center reel 3C and the right reel 3R and when it is carried out a winning confirmation (confirmation of a display combination) after all the reels 3L, 3C, 3R are stopped. The display combination (display combination data) is a combination (establishment combination) corresponding to a symbol combination arranged along the activated line. A payout corresponding to the display combination is awarded to the player.

In case that an internal winning combination is determined by a lottery process (for example, probability sortition process) based on the random number sampling, the CPU 31 transmits a signal for performing the control for stopping the rotations of the reels 3L, 3C, 3R to the motor driving circuit 39, on the basis of the signals transmitted from the stop switches 7LS, 7CS, 7RS at the timing at which the player operates the stop buttons 7C, 7L, 7R and the determined stop table. The internal winning combination (internal winning combination data) is information for identifying a mode of the stop control or identifying a combination which can be a display combination (combination which can be allowed as a display combination). It can be said that an internal winning combination is indirectly matched to a corresponding symbol combination and a payout to be awarded to the player, through a mode of stop control corresponding to the internal winning combination.

When it is made a stop mode (winning mode) representing a winning of a determined combination, the CPU 31 supplies a payout command signal to the hopper driving circuit 41 and pays out the predetermined number of medals from the hopper 40. At this time, the medal detection unit 40S counts the number of medals paid out from the hopper 40, and the medal payout completion signal is inputted to the CPU 31 when the counted value reaches a predetermined value. Thereby, the CPU 31 stops the driving of the hopper 40 through the hopper driving circuit 41 and ends the medal payout process.

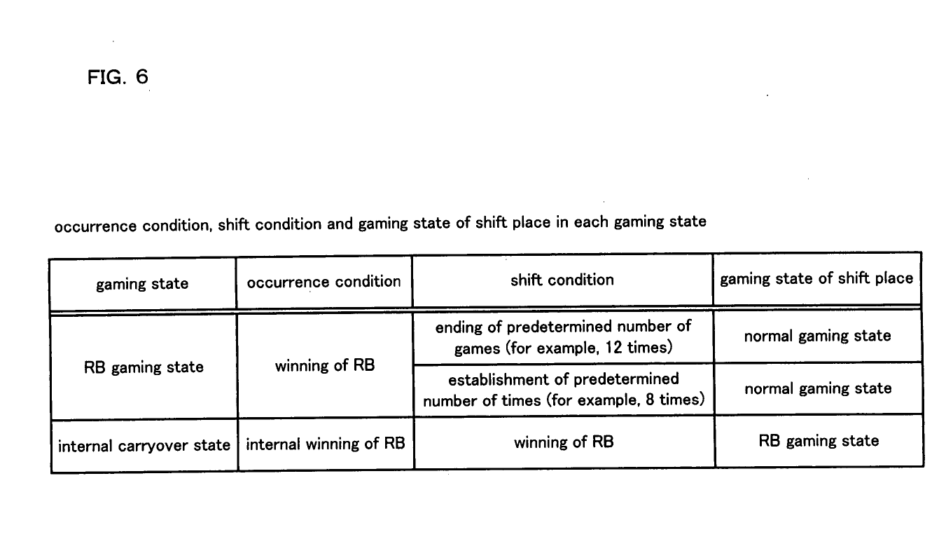

FIG. 6 views an occurrence condition of each gaming state, a shift condition and a gaming state of a shift place when the shift condition is fulfilled. In the respective gaming states, types and winning probabilities of an internal winning combination are different.

In one embodiment, the gaming state includes a normal gaming state, a RB gaming state and a carryover state. In addition, a combination (RB) which is carried over under carryover state is referred to as ┌internal carryover combination┘.

The normal gaming state is a gaming state in which an expected value of the so-called ┌rate of paying out┘ (a game value to be paid out to a player to a unit game value bet per a game) is less than ┌1┘. In addition, there is no internal carryover combination in the normal gaming state, and it is the most disadvantageous to the player as compared to the other gaming states.

The RB gaming state is a gaming state consisting of a game in which ┌the first type special single bonus┘ operates.

The carryover state is a gaming state in which a symbol combination corresponding to RB is allowed to be arranged along the activated line, i.e., RB is established over one or more games.

As shown in FIG. 6, an occurrence condition of the RB gaming state is a winning of RB. When the predetermined number of games (for example, 12 times) is over or when the predetermined number of winnings (for example, 8 times) is made, the shift condition is satisfied and the gaming state is shifted to the normal gaming state.

An occurrence condition of the carryover state is an internal winning of RB. When RB is made, the shift condition is satisfied and the gaming state is shifted to the RB gaming state.

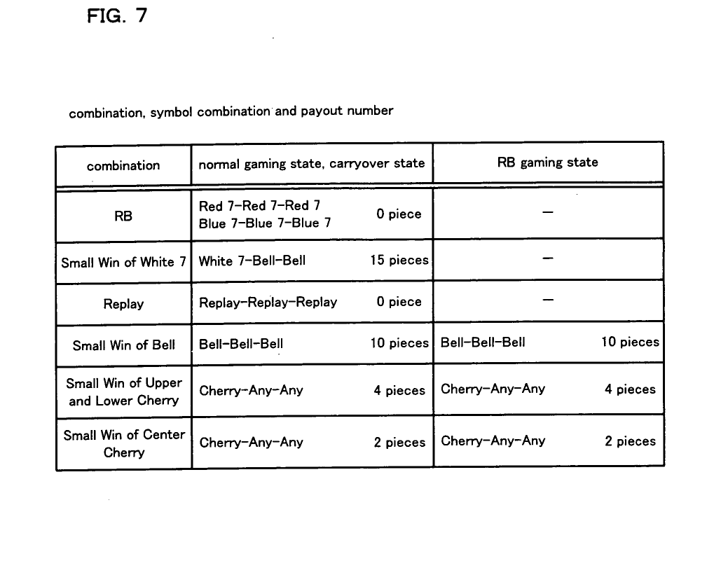

In the followings, it is described a combination, a symbol combination and a payout number with reference to FIG. 7.

When ┌Red 7-Red 7-Red 7┘ or ┌Blue 7-Blue 7-Blue 7┘ is arranged along the activated line, RB is made (a display combination becomes RB).

When ┌White 7-Bell-Bell┘ is arranged along the activated line, Small Win of White 7 is made (a display combination becomes Small Win of White 7) and 15 medals are paid out. When ┌Cherry-Any-Any┘ is arranged along the activated line, Small Win of Cherry is made. When Small Win of Upper and Lower Cherry is made, 4 medals are paid out, and when Small Win of Center Cherry is made, 2 medals are paid out. A combination of symbols representing that Small Win of Bell is made and a payout number thereof are as shown.

When ┌Replay-Replay-Replay┘ is arranged along the activated line, Replay is made. When Replay is made, since the same number of medals as the inserted medals is automatically inserted, the player can play a next game without consuming the medals. In other words, Replay is a combination allowing a player to play a game, irrespective of the insertion of the game medium.

In the followings, it is described areas (memory areas) for storing an internal winning combination and an internal carryover combination, with reference to FIG. 8A, 8B.

FIG. 8A shows an internal winning combination storing area. The information (data) of an internal winning combination is stored in an internal winning combination storing area consisting of 1 byte. In the internal winning combination storing area, a bit 0 (first bit) is a storing area corresponding to Small Win of Cherry. A bit 1 (second bit) is a storing area corresponding to Small Win of Bell.

A bit 2 (third bit) is a storing area corresponding to Replay. A bit 3 (fourth bit) is a storing area corresponding to Small Win of White 7. A bit 4 (fifth bit) is a storing area corresponding to RB. A bit 5 (sixth bit), a bit 6 (seventh bit) and a bit 7 (eighth bit) are unused storing areas. In the internal winning combination storing area, a combination corresponding to a bit which is 1 is an internal winning combination. For example, when ┌00000010┘ is stored in the internal winning combination storing area (i.e., when the bit 1 (second bit) is 1), an internal winning combination is Small Win of Bell.

FIG. 8B shows an internal carryover combination storing area. In the internal carryover combination storing area, the information of the internal carryover combination is stored in an internal carryover combination storing area consisting of 1 byte. In the internal carryover combination storing area, a bit 4 (fifth bit) is a storing area (memory area) corresponding to RB. A bit 0 (first bit)˜a bit 3 (fourth bit) and a bit 5 (sixth bit)˜a bit 7 (eighth bit) are unused storing areas. When there is an internal carryover combination (carryover state), 1 is stored in the bit 4 (fifth bit) corresponding to RB of the internal carryover combination storing area (i.e., ┌00010000┘ is stored in the internal carryover combination storing area).

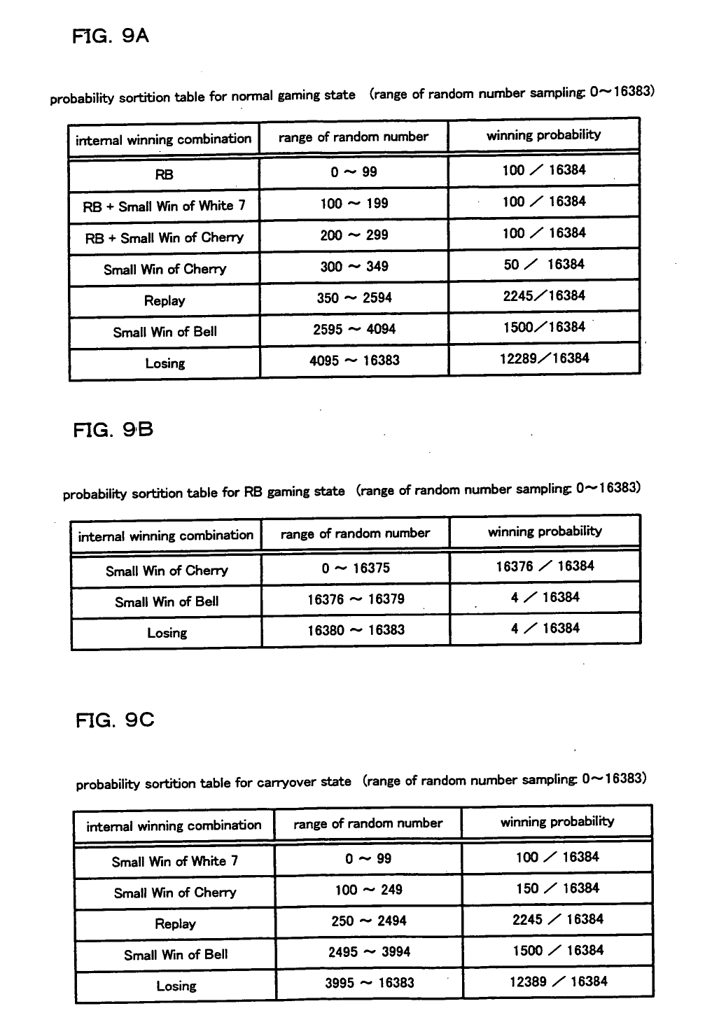

In the followings, it is described a probability sortition table (bet number: 3) with reference to FIG. 9A,9B,9C.

FIG. 9A shows a probability sortition table for normal gaming state. There is a case where a winning of RB, RB+Small Win of White 7, RB+Small Win of Cherry, Small Win of Cherry, Replay or Small Win of Bell is determined in the normal gaming state. RB+Small Win of White 7 corresponds to a random number range (numerical range) of ┌100┘˜┌199┘. Both RB and Small Win of White 7 become an internal winning combination by one lottery. RB+Small Win of Cherry corresponds to a random number range of ┌200┘˜┌299┘. Both RB and Small Win of White 7 become an internal winning combination by one lottery.

RB corresponds to a random number range of ┌0┘˜┌299┘ (information of a first numerical range). The lowest limit (first lowest limit) and the upper limit (first upper limit) of a random number range in which a winning of RB is determined are ┌0┘ and ┌299┘, respectively. In other words, the random number range is ┌0┘˜┌299┘

Small Win of White 7 corresponds to a random number range of ┌100┘˜┌199┘ (information of a second numerical range). The lowest limit (second lowest limit) and the upper limit (second upper limit) of a random number range in which a winning of Small Win of White 7 is determined are ┌100┘ and ┌199┘, respectively.

Small Win of Cherry corresponds to a random number range of ┌200┘˜┌349┘ (information of a third numerical range). The lowest limit (third lowest limit) and the upper limit (third upper limit) of a random number range in which a winning of Small Win of Cherry is determined are ┌200┘ and ┌349┘, respectively.

Accordingly, the random number range corresponding to Small Win of White 7 is included in the random number range corresponding to RB. In other words, when a winning of Small Win of White 7 is determined, a winning of RB is always determined. In addition, the random number range corresponding to Small Win of Cherry includes a part ┌200┘˜┌299┘ of the random number range corresponding to RB. In other words, when a winning of Small Win of Cherry is determined, there are a case where a winning of RB is determined and a case where a winning of RB is not determined.

The lowest limit and the upper limit of the random number range in which Small Win of White 7 is determined are included in the random number range in which a winning of RB is determined. In other words, when a winning of Small Win of White 7 is determined, a winning of RB is determined without fail. In the mean time, the lowest limit of the random number range in which Small Win of Cherry is determined is included in the random number range in which a winning of RB is determined, but the upper limit thereof is not included. In other words, when a winning of Small Win of Cherry is determined, there are a case where a winning of RB is determined and a case where a winning of RB is not determined.

In addition, when a winning of RB+Small Win of White 7 is determined, it is allowed symbol combinations corresponding to RB and Small Win of White 7 to be arranged along the activated line. At this time, RB is preferentially attracted-in. When a winning of RB+Small Win of Cherry is determined, it is allowed symbol combinations corresponding to RB and Small Win of Cherry to be arranged along the activated line. At this time, RB is preferentially attracted-in. In case that an internal winning of RB+Small Win of White 7 is determined, so that a winning of Small Win of White 7 is determined but a winning of RB is not determined, RB is carried over. In case that an internal winning of RB+Small Win of Cherry is determined, so that a winning of Small Win of Cherry is determined but a winning of RB is not determined, RB is carried over.

In the normal gaming state, a winning of Small Win of Cherry is determined when an internal winning combination is Small Win of Cherry as well as when a winning of RB+Small Win of Cherry is determined. Accordingly, when a winning of Small Win of Cherry is determined, there are a case where RB is carried over and a case where RB is not carried over. In the mean time, in the normal gaming state, there is a case where a winning of Small Win of White 7 is determined when a winning of RB+Small Win of White 7 is determined. In addition, also in the carryover state, a winning of Small Win of White 7 is determined. In this case, RB carried over is carried over into a next game. Accordingly, when a winning of Small Win of White 7 is determined, RB is carried over without fail.

The player's expectations for RB are relatively higher in a case where a winning of Small Win of White 7 is determined, as compared to a case where a winning of Small Win of Cherry is determined. Accordingly, it is possible to change the player's expectations for RB depending on the type of a combination made and thus to increase the interest in the game.

In addition, when a winning of RB+Small Win of White 7 is determined, 1 is respectively stored in the bit 4 (fifth bit) corresponding to RB and the bit 3 (fourth bit) corresponding to Small Win of White 7 of the internal winning combination storing area (i.e., ┌00011000┘ is stored in the internal winning combination storing area). When a winning of RB+Small Win of Cherry is determined, 1 is respectively stored in the bit 4 (fifth bit) corresponding to RB and the bit 0 (first bit) corresponding to Small Win of Cherry of the internal winning combination storing area (i.e., ┌00010001┘ is stored in the internal winning combination storing area).

FIG. 9B shows a probability sortition table for RB gaming state. In the RB gaming state, there is a case where an internal winning of Small Win of Bell or Small Win of Cherry is determined.

FIG. 9C shows a probability sortition table for carryover state. In the carryover state, there is a case where an internal winning of Small Win of White 7, Replay, Small Win of Bell or Small Win of Cherry is determined.

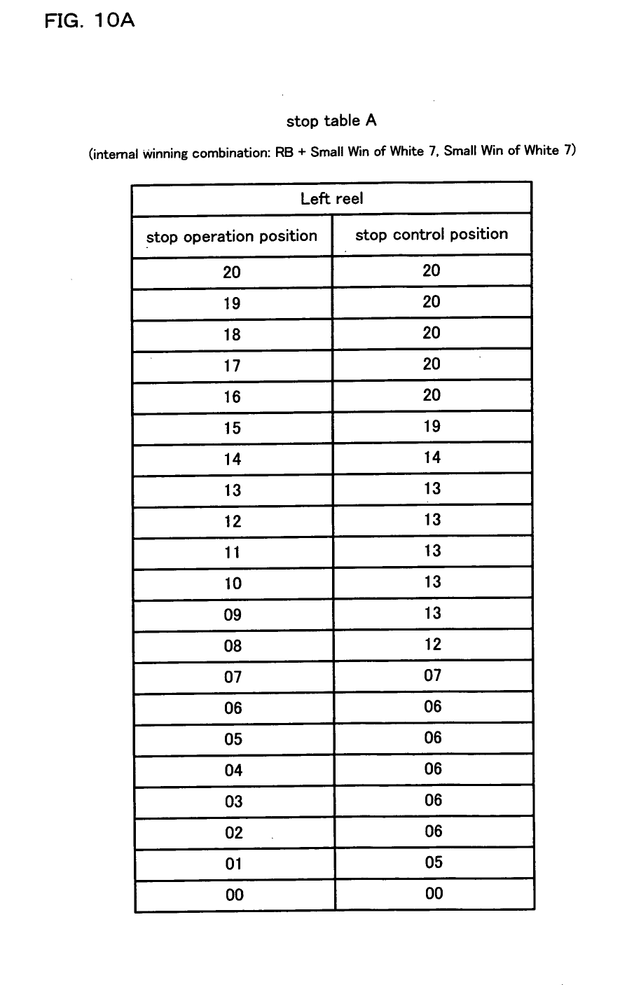

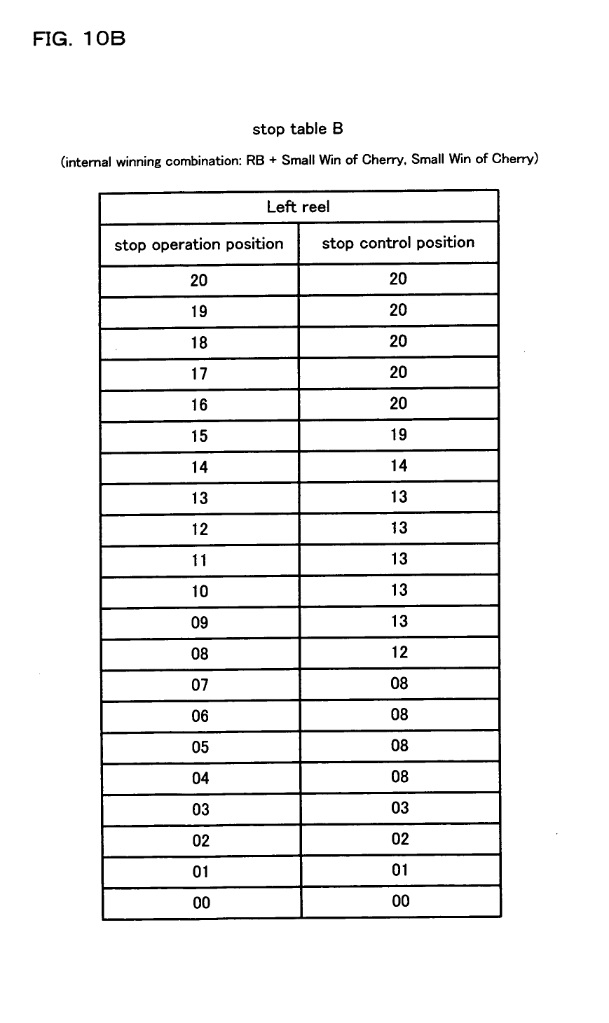

In the followings, a stop table is described with reference to FIG. 10A,10B.

Basically, a stop table is structured so that a predetermined symbol combination (symbol combination of a corresponding combination) is arranged along a predetermined display line (activated line). However, a stop table corresponding to Losing is structured so that a symbol combination corresponding to a combination is not arranged along the predetermined display line.

In the stop table, it is defined a stop operation position and a stop control position of the respective reels 3L, 3C, 3R. The stop operation position represents a code number of a symbol located on the center line 8c (specifically, symbol whose center is above the center line 8c and nearest at the position of the center line 8c) when the stop buttons 7L, 7C, 7R mounted to correspond to the respective reels 3L, 3C, 3R are operated. The stop control position represents a code number of a symbol stopped at the position of the center line 8c when the reel for which the stop operation is carried out is stopped.

In one embodiment, the number of sliding symbols is set to be maximum ┌4 symbols┘ (the number of sliding symbols is 4 symbols). For example, if the stop button 7R is operated at the time when ┌Blue 7┘ of the code number ┌16┘ reaches the position of the center line 8c while the right reel 3R is being rotated, it is possible to stop-control the right reel 3R so that ┌Red 7┘ of the code number ┌20┘ is stopped at the position of the center line 8c.

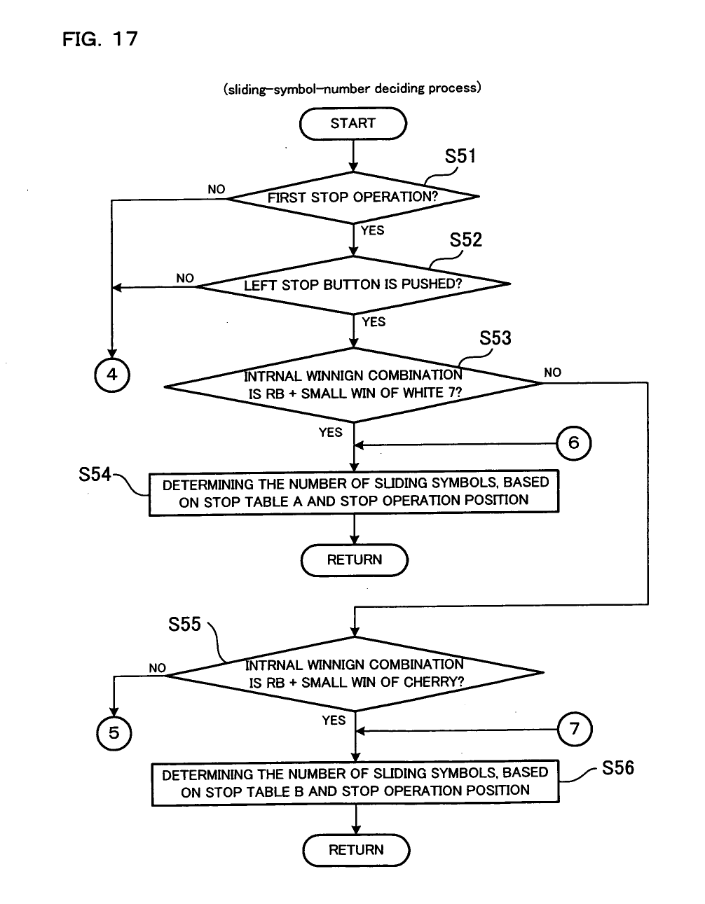

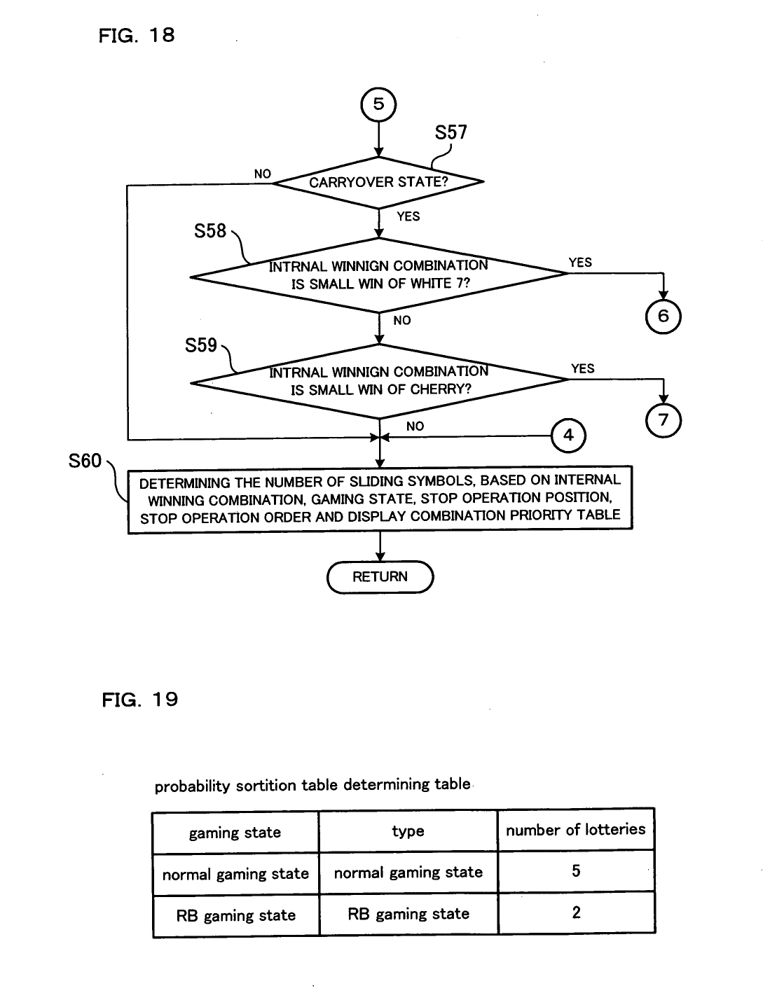

Herein, the ┌attraction-in┘ is meant by stopping the reel (reel corresponding to stop operation), which is a stop control target, so that a symbol constituting a symbol combination corresponding to an attraction-in target combination is displayed at the symbol stop position connected by the activated line, under condition that the maximum number of sliding symbols is 4. The attraction-in target combination is a combination corresponding to a symbol combination arranged along the activated line. In addition, the ┌attraction-in┘ is carried out by setting a stop table corresponding to an internal winning combination (see a sliding-symbol-number deciding process in FIGS. 17 and 18) and stop-controlling the corresponding reel.

In the followings, it is described a stop table Awhich is referred to when the first stop operation is an operation for the left stop button 7L, in case that an internal winning combination is RB+ Small Win of White 7 in the normal gaming state and an internal winning combination is Small Win of White 7 in the carryover state, with reference to FIG. 10A. In addition, stop tables for center reel and right reel are omitted.

In FIG. 10A, the stop control position of the left reel 3L is any one of the code numbers ┌00┘, ┌05┘, ┌06┘, ┌07┘, ┌12┘, ┌13┘, ┌14┘, ┌19┘ and ┌20┘. In the symbol arrangement shown in FIG. 4, the symbols corresponding to the code numbers, a symbol over one, regarding the symbol corresponding to the code numbers or a symbol under one, regarding the symbol corresponding to the code numbers is ┌Red 7┘, ┌Blue 7┘ or ┌White 7┘. Accordingly, ┌Red 7┘, ┌Blue 7┘ or ┌White 7┘ is stopped at one of the upper, central and lower symbol stop positions of the left symbol display area 21L.

Like this, by using the stop table shown in FIG. 10A, ┌Red 7-Red 7-Red 7┘ and ┌Blue 7-Blue 7-Blue 7┘ which are symbols combinations corresponding to RB or ┌White 7-Bell-Bell┘ which is a symbol combination corresponding to Small Win of White 7 is stopped on the activated line. However, the symbol combination corresponding to RB or Small Win of White 7 may not be stopped, depending on the timing of the stop operation (stop operation position) by the player, a stop operation order and the like.

In the followings, it is described a stop table B which is referred to when the first stop operation is an operation for the left stop button 7L, in case that an internal winning combination is RB+Small Win of Cherry in the normal gaming state and an internal winning combination is Small Win of Cherry in the carryover state, with reference to FIG. 10B. In addition, stop tables for center reel and right reel are omitted.

In FIG. 10B, the stop control position of the left reel 3L is any one of the code numbers ┌00┘, ┌01┘, ┌02┘, ┌03┘, ┌08┘, ┌12┘, ┌13┘, ┌14┘, ┌19┘ and ┌20┘. In the symbol arrangement shown in FIG. 4, the symbols corresponding to the code numbers, a symbol over one, regarding the symbol corresponding to the code numbers or a symbol under one, regarding the symbol corresponding to the code numbers is ┌Red 7┘, ┌Blue 7┘ or ┌Cherry┘. Accordingly, ┌Red 7┘, ┌Blue 7┘ or ┌Cherry┘ is stopped at one of the upper, central and lower symbol stop positions of the left symbol display area 21L.

Like this, by using the stop table shown in FIG. 10B, ┌Red 7-Red 7-Red 7┘ and ┌Blue 7-Blue 7-Blue 7┘ which are symbols combinations corresponding to RB or ┌Cherry-Any-Any┘ which is a symbol combination corresponding to Small Win of Cherry is stopped on the activated line. However, the symbol combination corresponding to RB or Small Win of Cherry may not be stopped, depending on the timing of the stop operation by the player, a stop operation order and the like.

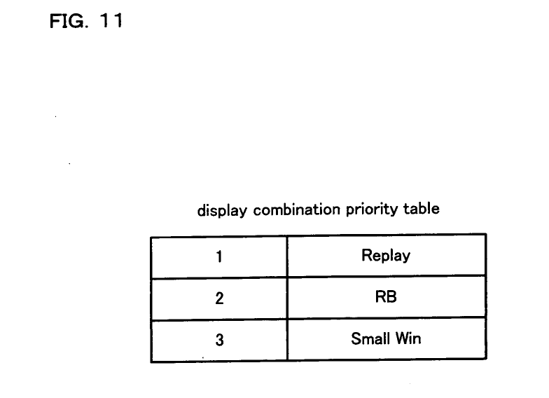

In the followings, it is described a display combination priority table with reference to FIG. 11.

A display combination priority table includes the information of a priority ranking defined to stop the reels so that which one of a symbol combination corresponding to Small Win and a symbol combination corresponding to RB is preferentially displayed on the activated line, when there are two internal winning combinations or when there are an internal winning combination and an internal carryover combination. In Replay, RB and Small Win, the priority ranking of Replay is the highest and the priority ranking of Small Win is the lowest.

For example, in case that an internal carryover combination is RB and an internal winning combination is Replay, the ┌attraction-in┘ of RB is not carried out and it is carried out the stop control of reel corresponding to the first to third stop operations, based on the stop table provided to correspond to Replay. In the mean time, in case that an internal carryover combination is RB and an internal winning combination is Small Win of Bell, when the ┌attraction-in┘ of RB is carried out but is not realized, the stop control of reel is carried out, based on the stop table provided to correspond to Small Win of Bell.

In the followings, it is described a control operation of the main control circuit 71 with reference to FIGS. 12 to 14.

First, the CPU 31 carries out an initialization process when-a game starts (step S1). Specifically, the CPU 31 initializes the memory contents and communication data of RAM 33. Then, the CPU 31 erases the predetermined memory contents (for example, information of a predetermined memory area (for example, area memorizing an internal winning combination)) of the RAM 33 when a game is over (step S2), and then proceeds to a step S3. Specifically, the CPU 31 erases the data of the writable area of the RAM 33 used in a previous game, writes a parameter necessary for a next game into the writable area of the RAM 33 and indicates a start address of a sequence program for the next game, etc.

In the step S3, the CPU 31 carries out a medal insertion(start checking process, and then proceeds to a step S4. In this process, the CPU 31 updates the insertion number, based on the inputs from the start switch 6S, the medal sensor 22S or the BET switches 11 to 13. In the step S4, the CPU 31 samples a random number for lottery, and proceeds to a step S5. The random number sampled in this process is used for a probability sortition process which will be described later.

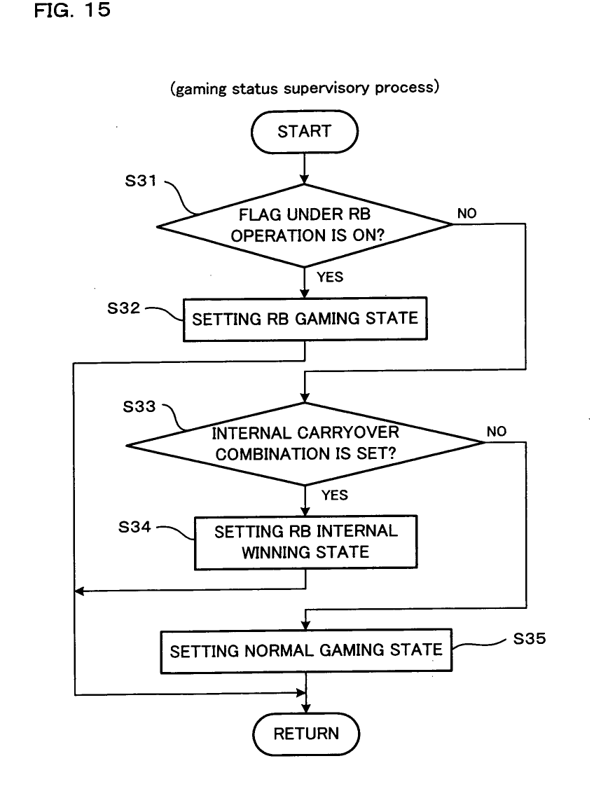

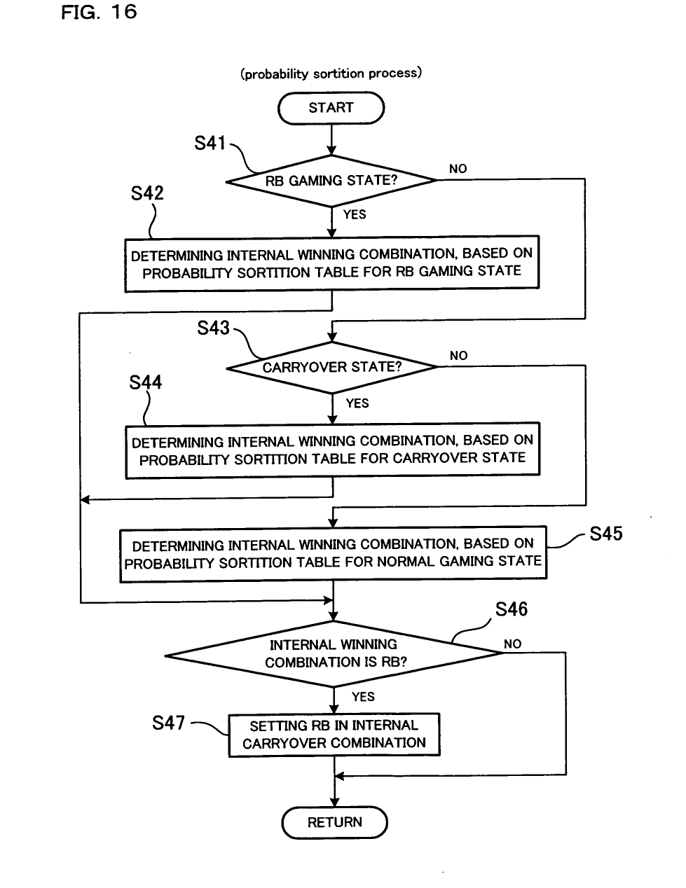

In the step S5, the CPU 31 carries out a gaming status supervisory process which will be described with reference to FIG. 15, and proceeds to a step S6. In the step S6, the CPU 31 carries out a probability sortition process which will be described with reference to FIG. 16, and proceeds to a step S7.

In the step S7, the CPU 31 sets a start command and proceeds to a step S8. The start command contains the information of a gaming state, an internal winning combination, etc., and is transmitted to the sub-control circuit 72. in the step S8, the CPU 31 determines whether ┌4.1 seconds┘ have elapsed after a previous reel has started to rotate. When a result of the determination is YES, the CPU 31 proceeds to a step S10, otherwise proceeds to a step S9.

In the step S9, the CPU 31 consumes a game start waiting time (waiting process) and then proceeds to a step S10. Specifically, the CPU 31 annuls an input related to a game start operation by a player during the period from after the previous game has started until a predetermined time (for example, 4.1 seconds) has elapsed.

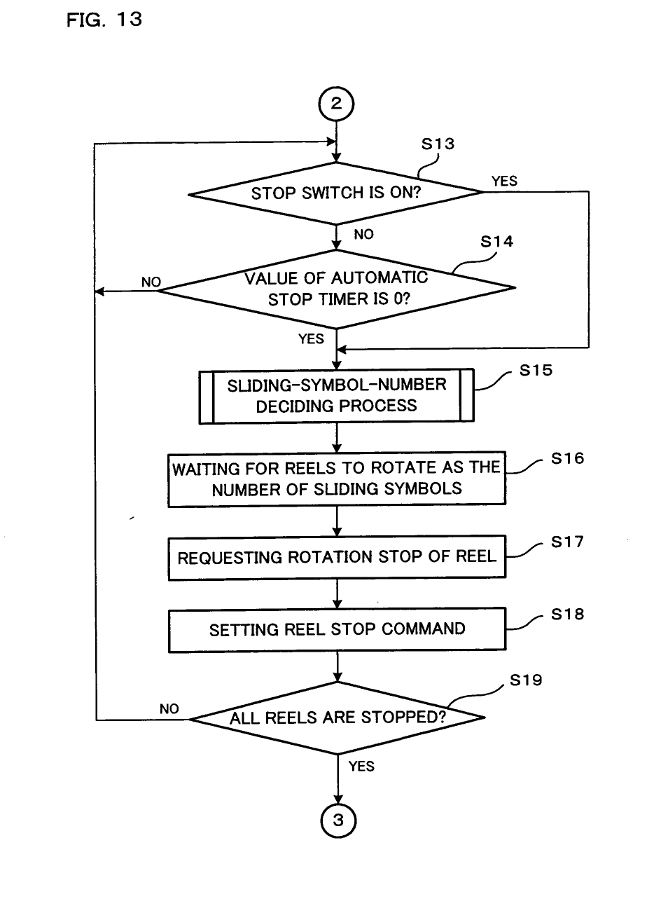

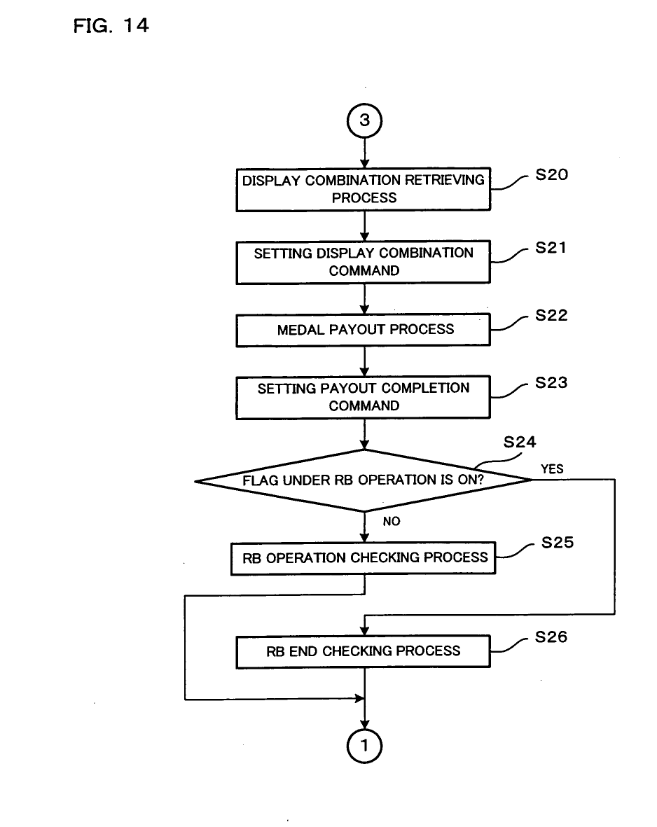

In the step S10, the CPU 31 sets a game supervisory timer, and then proceeds to a step S11. The game supervisory timer includes an automatic stop timer for automatically stopping the reels 3L, 3C, 3R, irrespective of the stop operation for the stop buttons 7L, 7C, 7R by the player. In the step S11, the CPU 31 requests the rotation start of all reels, and proceeds to a step S12. In the step S12, the CPU 31 sets a reel stop permitting command, and then proceeds to a step S13 in FIG. 13.

In the step S13 of FIG. 13, the CPU 31 determines whether the stop switch is ┌ON┘ or not, i.e., whether any one of the stop buttons 7L, 7C, 7R is pushed or not. When a result of the determination is YES, the CPU 31 proceeds to a step S15, otherwise proceeds to a step S14. In the step S14, the CPU 31 determines whether a value of the automatic stop timer is ┌0┘ or not. When a result of the determination is YES, the CPU 31 proceeds to a step S15, otherwise proceeds to the step S13.

In the step S15, the CPU 31 carries out a sliding-symbol-number deciding process which will be described with reference to FIGS. 17 and 18, and then proceeds to a step S16. In the step S16, the CPU 31 waits for the reels 3L, 3C, 3R, which corresponds to the stop buttons 7L, 7C, 7R for which the stop operation is carried out, to rotate as the number of sliding symbols determined, and then proceeds to a step S17.

In the step S17, the CPU 31 requests the rotation stop of the reels and proceeds to a step S18. In the step S18, the CPU 31 sets a reel stop command and then proceeds to a step S19. In the step S19, the CPU 31 determines whether or not all the reels are stopped. When a result of the determination is YES, the CPU 31 proceeds to a step S20 of FIG. 14, otherwise proceeds to the step S13.

In the step S20 of FIG. 14, the CPU 31 carries out a display combination retrieving process and then proceeds to a step S21. The display combination retrieving process is a process of setting a flag for identifying a display combination (established combination), based on the stop mode of the symbols in the symbol display areas 21L, 21C,21R. In the step S21, the CPU 31 sets a display combination command including the display combination information, and then proceeds to a step S22.

In the step S22, the CPU 31 carries out a medal payout process, and then proceeds to a step S23. In the step S23, the CPU 31 sets a payout ending command, and proceeds to a step S24. In the step S24, the CPU 31 determines whether the flag under RB operation is ON or not. When a result of the determination is YES, the CPU 31 proceeds to a step S26, otherwise proceeds to a step S25. The flag under RB operation is the information for identifying whether it is under RB gaming state. When it is under RB gaming state, the flag under RB operation is ON, otherwise the flag under RB operation is ┌OFF┘.

In the step S25, the CPU 31 carries out a RB operation checking process and then proceeds to the step S2 of FIG. 12. In the RB operation checking process, when a display combination is RB, the CPU 31 carries a process on RB operation. In the step S26, the CPU 31 carries out a RB end checking process and proceeds to the step S2 in FIG. 12. In the RB end checking process, the CPU 31 determines whether the number of games under RB gaming state exceeds the possible game-number (for example, 8 times) and whether the number of cases where a combination is established under RB gaming state exceeds to the possible winning-number (for example, 8 times). When it is determined that at least one exceeds, the CPU 31 ends the RB gaming state.

In the followings, it is described a gaming status supervisory process with reference to FIG. 15.

First, the CPU 31 determines whether a flag under RB operation is ON or not (step S31). When a result of the determination is YES, the CPU 31 proceeds to a step S32, otherwise proceeds to a step S33. In the step S32, the CPU 31 sets the RB gaming state as a gaming state, and proceeds to the step S6 in FIG. 12.

In the step S33, the CPU 31 determines whether an internal carryover combination is set or not. When a result of the determination is YES, the CPU 31 proceeds to a step S34, otherwise proceeds to a step S35. An internal carryover combination is set in a step S47 of FIG. 16. In the step S34, the CPU 31 sets a RB internal winning state and proceeds to the step S6 in FIG. 12. In the step S35, the CPU 31 sets the normal gaming state and proceeds to the step S6 in FIG. 12. Based on the gaming state set in the gaming status supervisory process, it is carried out a determination of an internal winning combination.

In the followings, it is described a probability sortition process with reference to FIG. 16.

First, the CPU 31 determines whether it is under RB gaming state (step S41). When a result of the determination is YES, the CPU 31 proceeds to a step S42, otherwise proceeds to a step S43. In the step S42, the CPU 31 determines an internal winning combination, based on the probability sortition table for RB gaming state (see FIG. 9B), and then proceeds to a step S46. In the step S43, the CPU 31 determines whether it is under carryover state. When a result of the determination is YES, the CPU 31 proceeds to a step S44, otherwise proceeds to a step S45.

In the step S44, the CPU 31 determines an internal winning combination, based on the probability sortition table for carryover state (see FIG. 9C), and then proceeds to a step S46. In the step S45, the CPU 31 determines an internal winning combination, based on the probability sortitiQn table for normal gaming state (see FIG. 9A), and then proceeds to a step S46. In the step S46, the CPU 31 determines whether the internal winning combination is RB or not.

When a result of the determination is YES, the CPU 31 proceeds to a step S47, otherwise proceeds to the step S7 in FIG. 12. In the step S47, the CPU 31 sets an internal carryover combination, based on the internal winning combination, and then proceeds to the step S7 in FIG. 12. In the step S47, the CPU 31 stores 1 in a predetermined storing place (bit 4 (fifth bit)) of the internal carryover combination storing area (see FIG. 8B).

In the followings, it is described a sliding-symbol-number deciding process with reference to FIGS. 17 and 18.

First, the CPU 31 determines whether it is the first stop operation (step S51). When a result of the determination is YES, the CPU 31 proceeds to a step S52, otherwise proceeds to a step S60 in FIG. 18. In the step S52, the CPU 31 determines whether it is the left stop button operation. When a result of the determination is YES, the CPU 31 proceeds to a step S53, otherwise proceeds to a step S60 in FIG. 18.

In the step S53, the CPU 31 determines whether the internal winning combination is RB+Small Win of White 7. When a result of the determination is YES, the CPU 31 proceeds to a step S54, otherwise proceeds to a step S55. In the step S53, the CPU 31 determines the number of sliding symbols, based on the stop table A and the stop operation position, and then proceeds to the step S16 in FIG. 13.

In the step S55, the CPU 31 determines whether or not the internal winning combination is RB+Small Win of Cherry. When a result of the determination is YES, the CPU 31 proceeds to a step S56, otherwise proceeds to a step S57 in FIG. 18. In the step S56, the CPU 31 determines the number of sliding symbols, based on the stop table B and the stop operation position, and then proceeds to the step S16 in FIG. 13.

In the step S57 of FIG. 18, the CPU 31 determines whether the gaming state is the carryover state or not. When a result of the determination is YES, the CPU 31 proceeds to a step S58, otherwise proceeds to a step S60. In the step S58, the CPU 31 determines whether or not the internal winning combination is Small Win of White 7. When a result of the determination is YES, the CPU 31 proceeds to the step S54 in FIG. 17, otherwise proceeds to a step S59.

In the step S59, the CPU 31 determines whether or not the internal winning combination is Small Win of Cherry. When a result of the determination is YES, the CPU 31 proceeds to the step S56 in FIG. 17, otherwise proceeds to a step S60. In the step S60, the CPU 31 determines the number of sliding symbols, based on the gaming state, the stop operation position, the stop operation order and the display combination priority table, and then proceeds to the step S16 in FIG. 13.

### Embodiment 2

Hereinafter, an embodiment 2 of the invention will be described.

In the embodiment 2, the structure of the gaming machine, the structure of the electric circuit and the like are same as those of the embodiment 1. However, in the embodiment 2, it is carried out a probability sortition process different from the probability sortition process which has been described in the embodiment 1. Hereinafter, it will be described the structures different from in the embodiment 1.

In the followings, it is described a probability sortition table determining table with reference to FIG. 19.

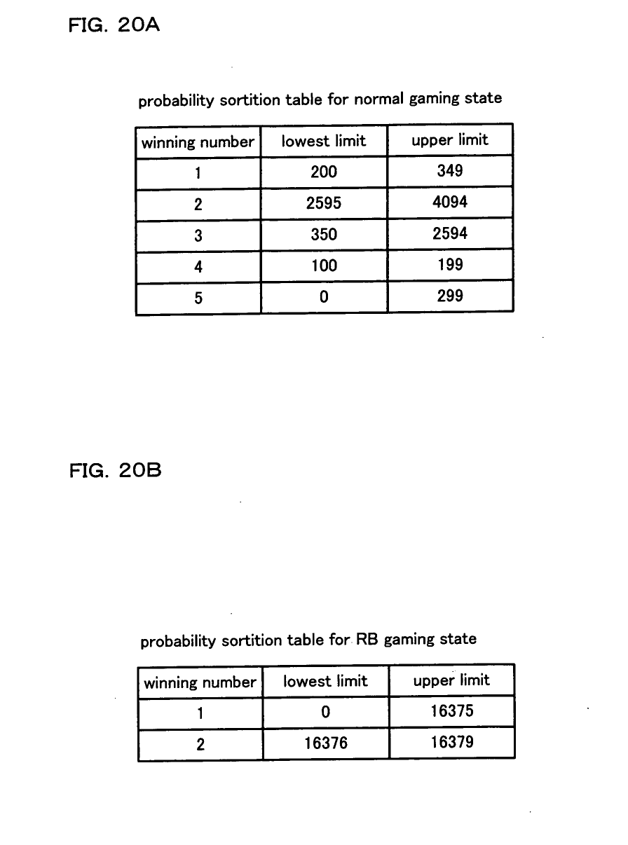

A probability sortition table determining table includes the information of a type of a probability sortition table (see FIG. 20A,20B) and the number of lotteries corresponding to the gaming state. A probability sortition table for normal gaming state (see FIG. 20A) is stored as a type of a probability sortition table of the normal gaming state. A probability sortition table for RB gaming state (see FIG. 20B) is stored as a type of a probability sortition table of the RB gaming state. In addition, in case of the carryover state, a type of the probability sortition table is the probability sortition table for normal gaming state.

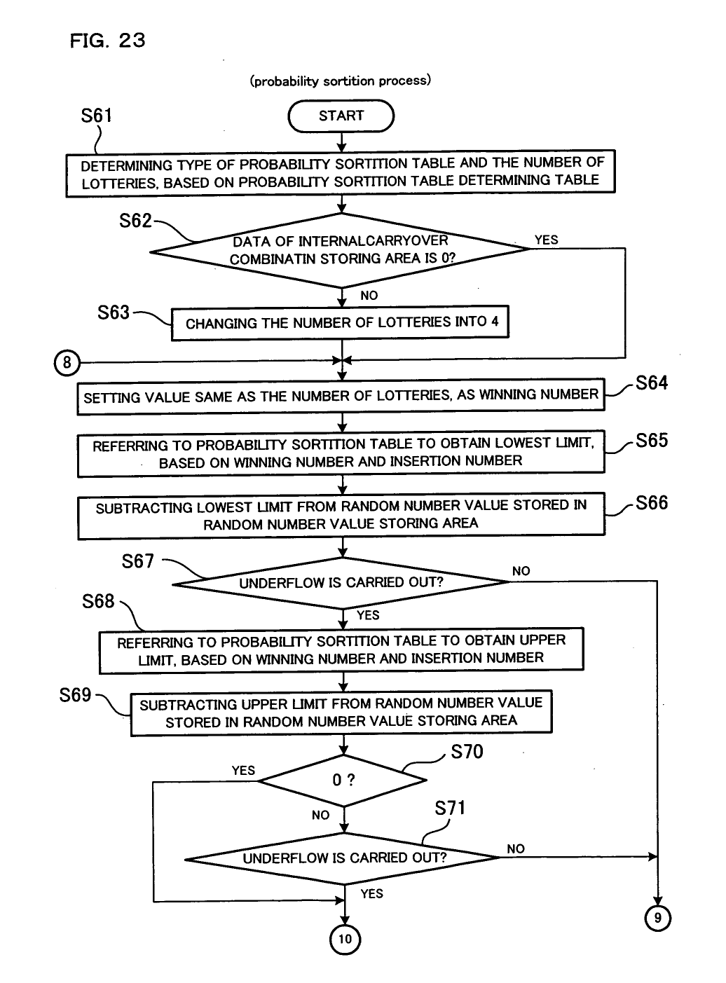

In addition, 5 is stored as the number of lotteries of the normal gaming state. 2 is stored as the number of lotteries of the RB gaming state. Further, in case of the carryover state, the number of lotteries is 4 (see a step S63 in FIG. 23).

The number of lotteries is the number of cases where it is carried out a process required to determine an internal winning combination. Specifically, the number of lotteries is the number of cases where it is carried a process of determining whether or not the random number is within a predetermined range (numerical range corresponding to the winning number which will be described with reference to FIG. 20A,20B).

In the followings, it is described a probability sortition table (bet number: 3) with reference to FIG. 20A,20B.

A probability sortition table is basically provided for each of the gaming states and includes the information about the lowest limit and the upper limit of a numerical range corresponding to a winning number. Specifically, a probability sortition table for normal gaming state (see FIG. 20A) is used in the normal gaming state, and a probability sortition table for RB gaming state (see FIG. 20B) is used in the RB gaming state. In addition, the probability sortition table for normal gaming state is used in the carryover state. As described below in FIG. 22, since a winning number corresponds to a combination, the probability sortition table includes the information about the upper limit and the lowest limit of numerical ranges corresponding to each of plural combinations, respectively.

FIG. 20A shows a probability sortition table for normal gaming state. The probability sortition table for normal gaming state of the embodiment 2 is structured such that a type of an internal wining combination and a probability that an internal winning of each combination will be determined are same as those of the probability sortition table for normal gaming state of the embodiment 1. In the carryover state of the embodiment 2, the probability sortition table for normal gaming state is used to determine an internal winning combination and the number of lotteries is updated to 4 (see a step S63 in FIG. 23). Accordingly, in the carryover state, a type of an internal wining combination and a probability that an internal winning of each combination will be determined are same as the case using the probability sortition table for carryover state (see FIG. 9C) of the embodiment 1.

FIG. 20B shows a probability sortition table for RB gaming state. The probability sortition table for RB gaming state of the embodiment 2 is structured such that a type of an internal wining combination and a probability that an internal winning of each combination will be determined are same as those of the probability sortition table for RB gaming state (see FIG. 9B) of the embodiment 1. In addition, it is omitted the probability sortition table having the bet number (insertion number) except 3.

In the determination (lottery) of a winning number based on the probability sortition table, it is determined whether the random number value is within a range expressed by the lowest limit and the upper limit corresponding to a winning number, from a winning number same as the number of lotteries determined for each of the gaming states to the winning number 0, in descending order. When the random number value is within a range expressed by the lowest limit and the upper limit, a corresponding winning number is determined. In addition, the number of cases where it is determined whether or not the random number value is within a range expressed by the lowest limit and the upper limit corresponding to a winning number is same as the number of lotteries set in the probability sortition table determining table in FIG. 19.

In addition, when the random number value is never within a range expressed by the lowest limit and the upper limit until the winning number becomes 0, the wining number is 0 (i.e., losing). The losing of an internal winning combination means that it is not determined a combination matched to a payout to be awarded to the player in the internal lottery. In addition, in the embodiment, the losing is not a combination matched to a game value. In addition, a symbol combination corresponding to the losing as an internal winning combination may be considered as any symbol combination different from symbol combinations corresponding to predetermined plural combinations. However, in the embodiment, a symbol combination corresponding to the losing is not provided.

In addition, it is determined whether or not a winning is made, until a winning number becomes ┌0┘, in descending order, and the numerical ranges defined by the lowest and upper limits corresponding to each of the plural combinations are duplicately set. Accordingly, plural combinations may be determined as an internal winning combination. At this time, an internal winning combination is determined on the basis of the winning number determined, the gaming state, the insertion number and the internal winning combination determining table (see FIG. 22).

For example, in case of the normal gaming state, when the random number value sampled from the random numbers consisting of a range of 0˜16383 is 250, “the random number value (R) (280)—the lowest limit (L) (0)” is calculated for the winning number 5 first of all. The calculation result becomes 0 or more. Subsequently, “the random number value (R) (250)—the upper limit (U) (299)” is calculated. This calculation result becomes 0 or less. Accordingly, since the random number value is within the numerical range corresponding to the winning number (L≦R≦U), when the random number value sampled in the normal gaming state is 250, the winning number 5 is determined. In case that the winning number 5 is determined, RB corresponding to the winning number 5 becomes an internal winning combination, based on an internal winning combination determining table (see FIG. 22).

Next, “the random number value (R) (250)—the lowest limit (L) (100)” is calculated for the winning number 4. The calculation result becomes 0 or more. Subsequently, “the random number value (R) (250)—the upper limit (U)” (199) is calculated. This calculation result is greater than 0. Accordingly, since the random number value is not within the numerical range corresponding to the winning number (L≦R≦U), when the random number value sampled in the normal gaming state is 250, the winning number 4 is not determined.

Like this, the calculations of “random number value (R) (250)—lowest limit (L)” and “random number value (R) (250)—upper limit (U)” are repeated in descending order until the winning number becomes 0 so as to determine whether each of the winning numbers 3, 2 and 1 is determined or not. In case that the random number value sampled in the normal gaming state is 250, the winning numbers 3 and 2 are not determined. However, the winning number 1 is determined since the lowest limit (L) is 200 and the upper limit (U) is 349. Therefore, when the random number value sampled in the normal gaming state is 250, the winning numbers 1 and 5 are determined, so that both Small Win of Cherry and RB are determined as an internal winning combination on the basis of the internal winning combination determining table (see FIG. 22).

In case of the carryover state, the number of lotteries is changed into 4 (see a step S63 in FIG. 23). Accordingly, in the carryover state, since there is no case where the winning number 5 is determined, RB corresponding to the winning number 5 is not determined as an internal winning combination, based on the internal winning combination determining table (see FIG. 22).

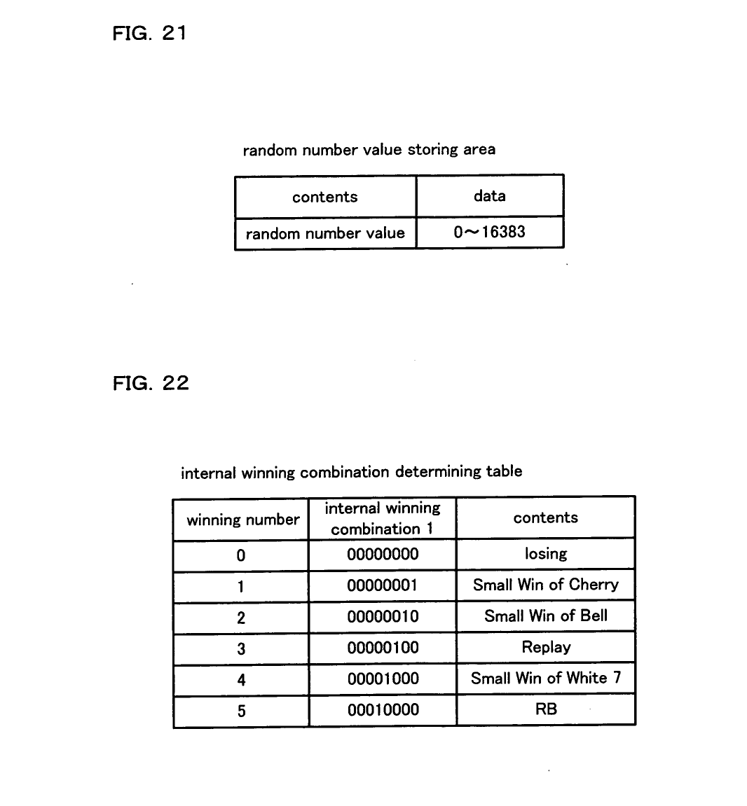

In the followings, it is described a random number value storing area (memory area) with reference to FIG. 21.

Arandom number value storing area is provided in the RAM 33. The numerical value information about the random number for lottery sampled in the step S4 of FIG. 12 is stored in the random number value storing area. In the step S4 of FIG. 12, one numerical value information of 0˜16383 is sampled as a random number for lottery and the sampled numerical value information is stored in the random number value storing area.

In the followings, it is described an internal winning combination determining table with reference to FIG. 22.

An internal winning combination determining table includes the information about an internal winning combination (flag) corresponding to a winning number. The flag is expressed by binary number. The internal winning combination expressed to correspond to the winning number is the information for identifying an internal winning combination and consists of 1 byte.

In case that the winning number is 0 and the information representing the internal winning combination is ┌00000000┘, the losing is determined as an internal winning combination. In case that the winning number is 1 and the information representing the internal winning combination ┌00000001┘, an internal winning combination is Small Win of Cherry. In case that the winning number is 2 and the information representing the internal winning combination ┌00000010┘, an internal winning combination is Small Win of Bell.

In case that the winning number is 3 and the information representing the internal winning combination ┌00000100┘, an internal winning combination is Replay. In case that the winning number is 4 and the information representing the internal winning combination ┌00001000┘, an internal winning combination is Small Win of White 7. In case that the winning number is 5 and the information representing the internal winning combination ┌00010000┘, an internal winning combination is RB.

The internal winning combination is basically the information for identifying the mode of stop control or identifying a combination which can be a display combination (i.e., combination which is allowed as a display combination). It can be said that an internal winning combination is indirectly matched to a corresponding symbol combination and a payout to be awarded to the player, through the mode of stop control (stop table) corresponding to the internal winning combination.

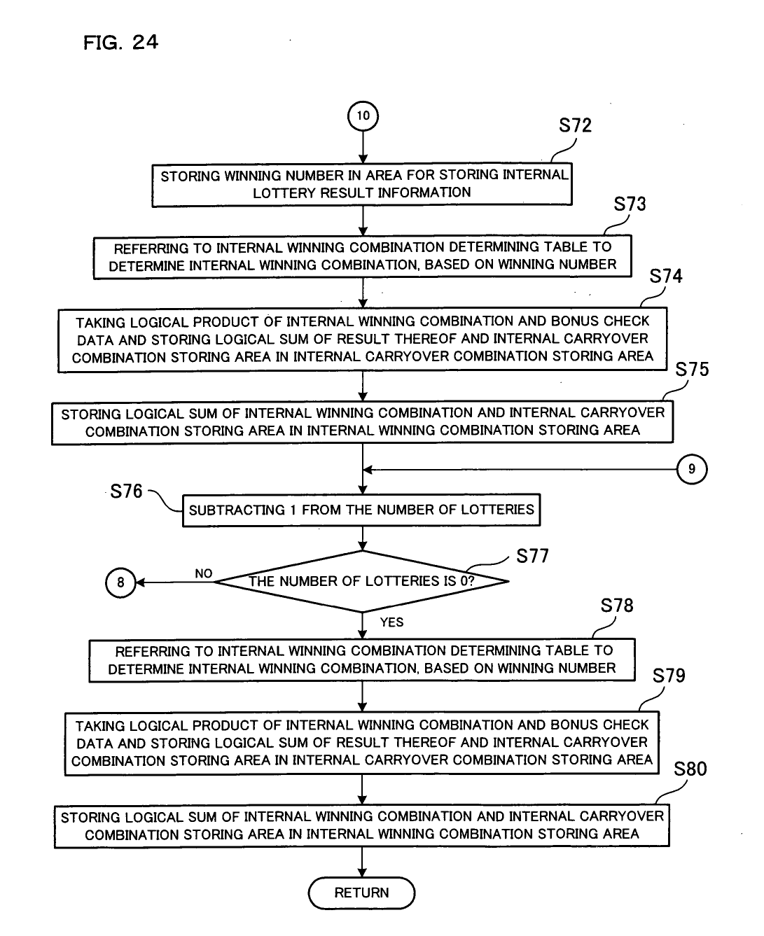

In the followings, a probability sortition process is described with reference to FIGS. 23 and 24.

First, the CPU 31 determines a type of the probability sortition table (see FIG. 20A, 20B) and the number of lotteries depending on the gaming states, based on the probability sortition table determining table (see FIG. 19) (step S61), and then proceeds to a step S62. In the step S62, the CPU 31 determines whether or not the data (information) stored in the internal carryover combination storing area is 0 (i.e., whether or not there is an internal carryover combination). When a result of the determination is YES, the CPU 31 proceeds to a step S64, otherwise proceeds to a step S63. A result of the determination in the step S62 becomes NO in the carryover state. In the step S63, the CPU 31 changes the number of lotteries into 4 and then proceeds to a step S64.

In the step S64, the CPU 31 sets a value same as the number of lotteries in the register of the CPU 31, as a winning number, and then proceeds to a step S65. Thereby, the winning number ┌5┘ is set in the normal gaming state, the winning number ┌2┘ is set in the RB gaming state and the winning number ┌4┘ is set in the internal winning state (carryover state). In the step S65, the CPU 31 refers to the probability sortition table determined in the step S61 to obtain the lowest limit (L) based on the winning number and the insertion number, and then proceeds to a step S66. In the step S66, the CPU 31 subtracts the lowest limit (L) from the random number value (R) stored in the random number value storing area of the RAM 33 (R-L), and then proceeds to a step S67.

In the step S67, the CPU 31 determines whether or not it is carried out an underflow. Specifically, the CPU 31 determines whether the calculation result of R-L is negative or not. When a result of the determination is YES, the CPU 31 proceeds to a step S76 in FIG. 24, otherwise proceeds to a step S68. The result of determination becomes YES when the random number value is smaller than the lowest limit (L>R). In addition, the result of determination becomes NO when the random number value is equal to or greater than the lowest limit (L≦R).

In the step S68, the CPU 31 refers to the probability sortition table determined in the step S61 to obtain the upper limit (U) based on the winning number and the insertion number, and then proceeds to a step S69. In the step S69, the CPU 31 subtracts the upper limit (U) from the random number value (R) stored in the random number value storing area of the RAM 33 (R-U), and then proceeds to a step S70.

In the step S70, the CPU 31 determines whether a value resulting from the subtraction, i.e., the calculation result of R-U is ┌0┘ or not. When a result of the determination is YES, the CPU 31 proceeds to a step S72 in FIG. 24, otherwise proceeds to a step S71. The result of determination becomes YES when the random number value is equal to the upper limit (R=U). In addition, the result of determination becomes NO when the random number value is not equal to the upper limit (L≈R).

In the step S71, the CPU 31 determines whether or not it is carried out an underflow. Specifically, the CPU 31 determines whether the calculation result of R-U is negative or not. When a result of the determination is YES, the CPU 31 proceeds to a step S72 in FIG. 24, otherwise proceeds to a step S76 in FIG. 24. The result of determination becomes YES when the random number value is smaller than the upper limit (R<U). In addition, the result of determination becomes NO when the random number value is greater than the upper limit (R>U).

In the step S72, the CPU 31 stores the winning number in an area for storing internal lottery result information, and then proceeds to a step S73. In the step S73, the CPU 31 refers to the internal winning combination determining table to determine an internal winning combination, based on the winning number, and then proceeds to a step S74.

In the step S74, the CPU 31 takes a logical product of the internal winning combination and bonus check data, stores a logical sum of a result thereof and an internal carryover combination storing area in the internal carryover combination storing area, and then proceeds to a step S75. RB which is correspondingly determined is stored in the internal carryover combination storing area. In addition, the bonus check data is ┌00010000┘. In the step S75, the CPU 31 stores a logical sum of the internal winning combination and the internal carryover combination storing area in the internal winning combination storing area, and then proceeds to a step S76. The data relating to a type of the internal winning combination determined is stored in the internal winning combination storing area.

In the step S76, the CPU 31 subtracts 1 from the number of lotteries, and then proceeds to a step S77. In the step S77, the CPU 31 determines whether or not the number of lotteries is 0. When a result of the determination is YES, the CPU 31 proceeds to a step S78, otherwise proceeds to the step S64 in FIG. 23. The result of determination becomes YES when the number of cases where it is determined whether or not the random number (R) is within the numerical range defined by the upper limit (U) and the lowest limit (L) is 5 times in the normal gaming state, 2 times in the RB gaming state and 4 times in the internal wining state (carryover state). In the mean time, the result of determination becomes NO when the number of cases is less than 5 times in the normal gaming state, less than 2 times in the RB gaming state and less than 4 times in the internal wining state (carryover state).

In the step S78, the CPU 31 refers to the internal winning combination determining table to determine an internal winning combination based on the winning number, and then proceeds to a step S79. In the step S79, the CPU 31 takes a logical product of the internal winning combination and bonus check data, stores a logical sum of a result thereof and an internal carryover combination storing area in the internal carryover combination storing area, and then proceeds to a step S80. Thereby, the internal carryover combination is stored in the internal carryover combination storing area. In the step S80, the CPU 31 stores a logical sum of the internal winning combination and the internal carryover combination storing area in the internal winning combination storing area, and then proceeds to the step S7 in FIG. 12. As a result, when the processes in the steps S72˜S76 are not carried out because the random number value (R) is not within any numerical ranges of the probability sortition table in FIG. 20A,20B, the losing or internal carryover combination is stored in the internal carryover combination storing area.

### Embodiment 3

Hereinafter, a gaming machine according to an embodiment 3 will be described.

In the embodiment 3, the structure of the gaming machine, the structure of the electric circuit and the like are same as those of the embodiment 1. However, in the embodiment 3, only the center line 8c is set as the activated line. In addition, the player can select one of the bet numbers 1 to 3. Further, the activated line is only the center line 8c, irrespective of the bet numbers.

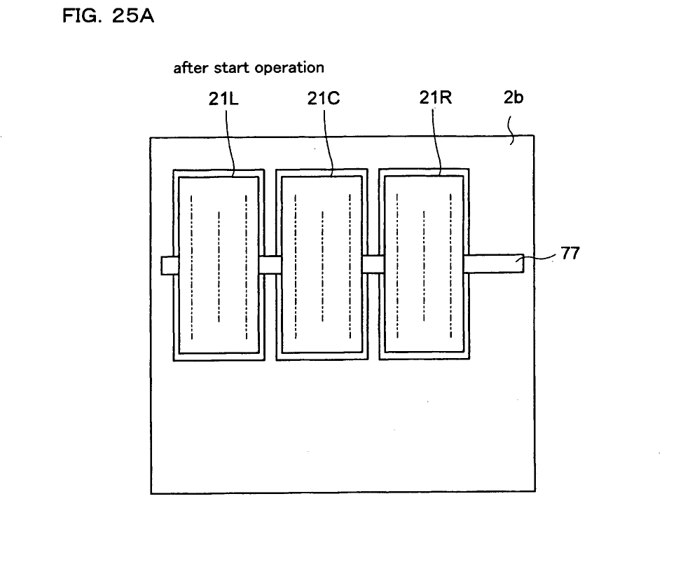

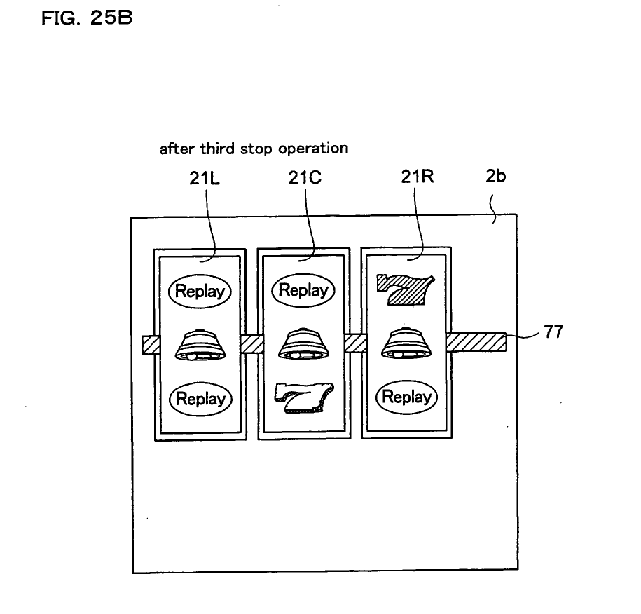

FIG. 25A, 25B shows a display example of the liquid crystal display unit 2b of the embodiment 3.

The liquid crystal display unit 2b is provided with an identification information display area 77 in accordance with the position of the center line 8c, i.e., the position corresponding to the line connecting the central symbol stop positions of the respective symbol display areas 21L, 21C, 21R. The display mode of the display area is changed, based on the game operation by the player such as start operation and stop operation, and the game related information such as internal winning combination, gaming state, bet number, etc.

FIG. 25A shows a display example after the start operation.

In the display example, the identification information display area 77 is a white color. In the embodiment 3, the symbol display areas 21L, 21C, 21R are respectively provided with the upper, central and lower symbol stop positions. Among them, only the central symbol stop position is related to the establishment of a combination. Accordingly, by providing the identification information display area 77 along the center line 8c, the player can definitely perceive that a line related to the establishment of a combination is only the center line 8c. In the mean time, by providing the symbol stop position, which is not directly related to the establishment of a combination, to the respective symbol display areas 21L, 21C, 21R, it is possible to notify that there is a variation in the stop modes of the symbols in the symbol display areas 21L, 21C, 21R, with regard to the identification information such as internal winning combination, etc.

FIG. 25B shows a display example after all the reels are stopped.

In the display example, the identification information display area 77 is a rainbow color. In the embodiment 3, the display modes (color, shapes, etc.) of the identification information display area 77 after all the reels are stopped are changed to notify or suggest the internal winning combination and the gaming state. Even though the player plays the game while paying attention to the symbol combination arranged along the center line 8c related to the establishment of a combination, since the game related information is notified or suggested by the change of the display modes of the identification information display area 77 provided along the center line 8c, the player can positively perceive the change and enjoy the game. In addition, it is possible to make the player pay attention to the symbol combination arranged along the center line 8c by the notification.

In the embodiment 3, the identification information display area 77 is provided to an area except the symbol display areas 21L, 21C, 21R. However, the invention is not limited thereto. For example, the identification information display area 77 may be structured to extend over the symbol display areas 21L, 21C, 21R. In addition, it may be structured such that a part of one or more symbol display areas 21L, 21C, 21R is a part of the identification information display area 77. In addition, it may be structured such that a part of a symbol display area except the symbol display area which is variably displaying the symbols or the symbol display area which can stop the variable display is a part of the identification information display area 77. In this case, among the plural rows which are variably displayed, a part of s symbol display area corresponding to a row whose variable display is stopped becomes the identification information display area 77.

In addition, it may be provided game value information storing means for storing information of a game value; game start command means for outputting a game start command signal to start a unit game in accordance with an operation of a player; symbol display means having plural display units capable of variably displaying plural types of symbols, on condition that the information of game value is stored in the game value information storing means when the game start command signal is detected; stop command means provided to correspond to each of the plural display units and outputting a stop command signal to stop the variable display of symbols in the corresponding display units in accordance with an operation by a player; internal winning combination determining means for determining an internal winning combination, on condition that the game start command signal is detected; stop control means for stopping the variable display of symbol of the display unit corresponding to the corresponding stop command signal, on condition that the stop command signal is detected; combination determining means for determining whether a symbol combination, which is arranged along a line connecting symbol stop positions predetermined for each of the display units, corresponds to an internal winning combination determined by the internal winning combination determining means, on condition that the plural display units stop the symbols; means for awarding a payout to the player, on condition that the combination determining means determines that the symbol combination arranged along the line corresponds to the internal winning combination determined by the internal winning combination determining means, the payout corresponding to the determined internal winning combination; display means capable of displaying identification information discernible by the player along the line; and display control means for controlling the display means.

In addition, the display control means may control the display means to display the identification information along the line in a display area except the display areas corresponding to the plural display units, among the display areas of the display means.

In addition, it may be provided internal winning combination determination information storing means (for example, probability sortition table, etc.) for storing, several times, the determination result of the internal winning combination determining means, the type of the symbol combination arranged along the line and the internal winning combination determination information for an internal winning combination, and the display control means may control the display means, based on one identification information or a combination of two or more identification information of the type (for example, type of the gaming state, a probability magnitude of Replay) of the internal winning combination determination information used to determine an internal winning combination by the internal winning combination determining means and the bet number (information stored in the game value information storing means). In addition, the display control means may control the display means to display the information allowing the player to identify the type of the determination result and the bet number.

In addition, the display control means may control the display means to display one or a combination of two or more of the identification information, on condition that the information of game value is stored in the game value information storing means, when the game start command signal is detected. In addition, the display control means may control the display means to display one or a combination of two or more of the identification information, on condition that the stop command signal is detected. Further, the display control means may control the display means to display one or a combination of two or more of the identification information, on condition that the plural display units stop the symbols. For example, the display means may display the information (for example, color, shape, etc.) which can identify the bet number when the start operation is carried out, and may display the information which can identify a combination or internal winning combination established when all the reels are stopped.

### Embodiment 4

Hereinafter, a gaming machine according to an embodiment 4 will be described.

In the embodiment 4, the structure of the gaming machine, the structure of the electric circuit and the like are basically same as those of the embodiment 1. In the followings, it will be described the structures different from in the embodiment 1.

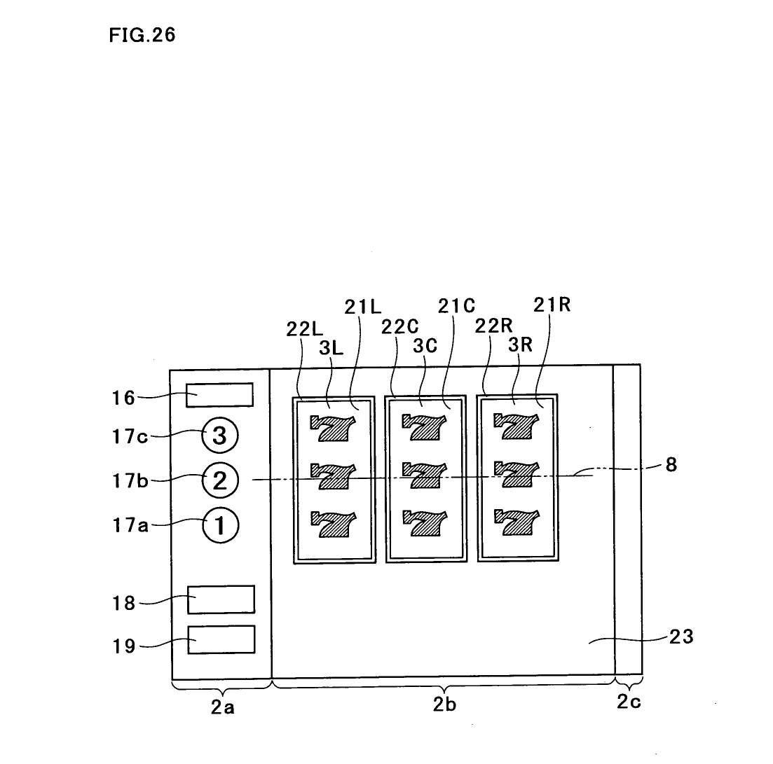

Hereinafter, the panel display unit 2a, the liquid crystal display unit 2b and the fixed display unit 2c are described with reference to FIG. 26.

The panel display unit 2a consists of the bonus game information display unit 16, the BET lamps 17a to 17c, the payout display unit 18 and the credit display unit 19. The bonus game information display unit 16 consists of 7 segment LEDs and displays game information during a bonus game. The 1-BET lamp 17a, the 2-BET lamp 17b and the MAX-BET lamp 17c are turned on in accordance with the number of medals bet so as to play a one game (hereinafter, referred to as ┌bet number┘).

The 1-BET lamp 17a is turned on when the bet number is 1. The 2-BET lamp 17b is turned on when the bet number is 2. The MAX-BET lamp 17c is turned on when the bet number is 3. The payout display unit 18 and the credit display unit 19 consist of 7 segment LEDs, respectively, and display a payout number of medals at the time when a winning is made and a number of medals credited.

The liquid crystal display unit 2b consists of symbol display areas 21L, 21C, 21R, frame display areas 22L, 22C, 22R and an effect display area 23. The display contents of the liquid crystal display unit 2b are adopted to vary in accordance with the rotation and the stop modes of the reels 3L, 3C, 3R and an operation of the liquid crystal display device 131 (see FIG. 3).

Each of the display windows 21L, 21C, 21R is mounted to correspond to each of the reels 3L, 3C, 3R and carries out the display of symbols arranged on the reels 3L, 3C, 3R or various displays for effects.

The symbol display areas 21L, 21C, 21R is provided with the center line 8c as a display line. When the player pushes the BET-switches 11 to 13 or inserts medals into the medal insertion slot 10, the display line is activated (hereinafter, activated display line is referred to as ┌activated line┘). In case that the bet number is 1 or more, the display line is activated, irrespective of the bet number.

Herein, each of the symbol display areas 21L, 21C, 21R is provided with three symbol stop positions (upper symbol stop position, central symbol stop position, lower symbol stop position) in a longitudinal direction (vertical direction). When the variable display of the symbols is stopped in the respective symbol display areas 21L, 21C, 21R, the symbols are stopped in the respective symbol stop positions provided to the symbol display areas 21L, 21C, 21R. The display line connects the central stop positions in the respective symbol display areas 21L, 21C,21R. Areas ofthe symbol display areas 21L, 21C, 21R corresponding to the symbol stop positions connecting the activated line are referred to as active areas, and areas of the symbol display areas 21L, 21C, 21R corresponding to the symbol stop positions not connecting the activated line are referred to as non-active areas.

The symbol display areas 21L, 21C, 21R are under transmissive state so that the player can see the symbols on the reels 3L, 3C, 3R, at least when the corresponding reels 3L, 3C, 3R are being rotated and when the corresponding stop buttons 7L, 7C, 7R can be pushed.

The frame display areas 22L, 22C, 22R are mounted to surround each of the symbol display areas 21L, 21C, 21R, and display the frames of the symbol display areas 21L, 21C, 21R arranged on the front of the reels 3L, 3C, 3R.

The effect display area 23 is an area except the symbol display areas 21L, 21C, 21R and the frame display areas 22L, 22C, 22R of the liquid crystal display unit 2b. The fixed display unit 2c is an area in which a predetermined figure, picture and the like are drawn. It may be such structured that the figure, picture and the like drawn on the fixed display unit 2c and the image displayed on the effect display area 23 are correlated to display one still image or moving image.

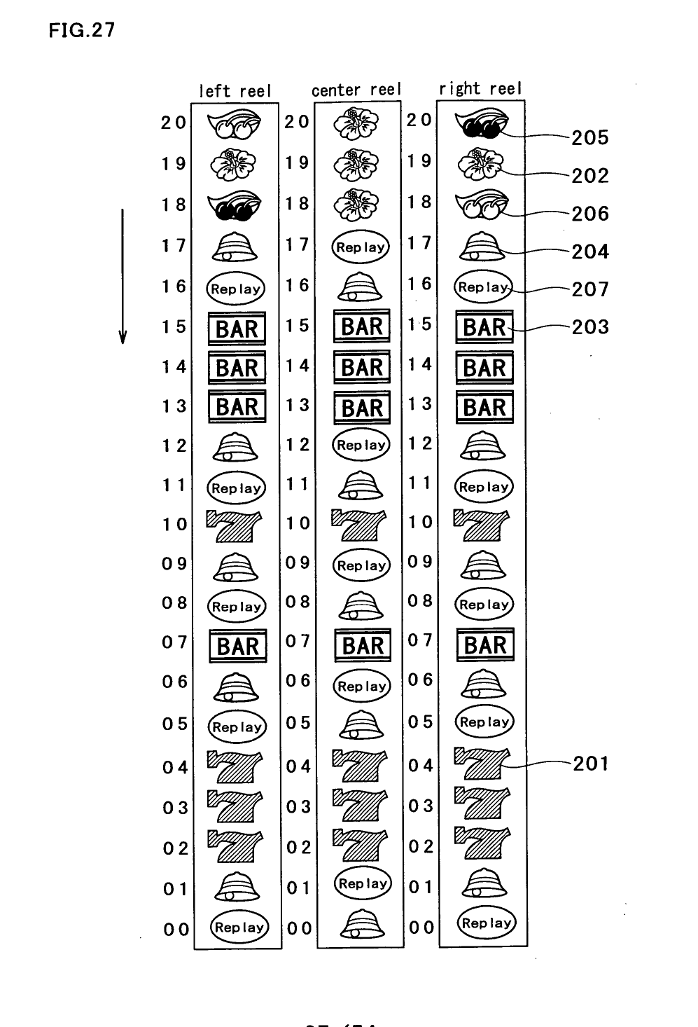

FIG. 27 shows symbol rows displayed on the reels 3L, 3C, 3R, in each of which 21 symbols are arranged. Each of the symbols is given with code numbers of ┌00┘˜┌20┘, and stored (memorized) as a data table in the ROM 32 (see FIG. 6). Each of the reels 3L, 3C, 3R is arranged with the symbol row consisting of ┌Red 7 (symbol 201)┘, ┌Hibiscus (symbol 202)┘, ┌BAR (symbol 203)┘, ┌Bell (symbol 204)┘, ┌Red Cherry (symbol (205)┘, ┌Blue Cherry (symbol 206)┘ and ┌Replay (symbol 207)┘. Each of the reels 3L, 3C, 3R is rotated so that the symbol rows are moved in an arrow direction of FIG. 27.

In the respective reels 3L, 3C, 3R, there is a place where ┌Red 7┘ and ┌BAR┘ constituting a symbol combination of MB (continuous cooperation device relating to a second type special single bonus) are arranged at a symbol interval exceeding the maximum number of sliding symbols (4 in the embodiment). For example, in the left reel 3L, ┌Red 7┘ of the code number 04 and ┌Red 7┘ of the code number 10 are arranged at an interval of 5 symbols.

In the embodiment, MB1, MB2, Red Cherry, Blue Cherry, Bell, Red 7 Bell, BAR Bell, Hibiscus, complex combination and Replay are provided as a combination. MB1 and MB2 are collectively referred to as ┌middle bonus ┌(MB)┘. In addition, Red Cherry, Blue Cherry, Bell, Red 7 Bell, BAR Bell and Hibiscus are collectively referred to as ┌Small Win┘. Furthermore, Red Cherry and Blue Cherry are collectively referred to as ┌Cherry┘. In addition, a symbol constituting a symbol combination corresponding to MB is referred to as ┌bonus symbol┘. Specifically, the bonus symbol is ┌Red 7 (symbol 201)┘ and ┌BAR (symbol 203)┘.

The combination (combination data) is the control information in which the payout to be awarded to the player is matched to a symbol combination in advance, and is used to stop-control the reels 3L, 3C, 3R, to switch (shift) the gaming state, to pay out the game value, etc. In the complex combination, combinations of the payout to be awarded to the player and a symbol combination are matched in plural (i.e., complex combination is a set of plural combinations). A symbol combination to be displayed (payout to be awarded to the player) is determined in accordance with the operating timing of the stop buttons 7L, 7C, 7R by the player.

In addition, in one embodiment, the gaming state basically includes a normal gaming state and a challenge bonus gaming state (hereinafter, abbreviated as ┌CB gaming state┘). Basically, the gaming state is identified by a type of an internal lottery table used to determine an internal winning combination and a mode of stop control of a reel (so-called ┌maximum number of sliding symbols┘). Specifically, the gaming state can be identified by a type of a combination which an internal winning thereof may be determined, an internal winning probability, the maximum number of sliding symbols, etc. In addition, in the CB gaming state, the left reel 3L is stopped within first time (for example, 75 ms) after the left stop button 7L is pushed. Besides, it is stopped within second time (for example, 190 ms). In other words, it is provided plural types of gaming states having different maximum time from after the stop buttons 7L, 7C, 7R are pushed until the reels 3L, 3C, 3R are stopped.

The normal gaming state consists of a base section having no internal carryover combination, and a carryover section having an internal carryover combination. It is possible to determine whether or not it is under carryover section, depending on the internal carryover combination. In the carryover section, an internal winning of MB is not determined. In the base section, an internal winning of MB may be determined. Accordingly, the base section and the carryover section are gaming states different from each other. The internal carryover combination is a combination which permits a corresponding symbol combination to be arranged along the activated line over one or more games (depending on the internal winning combination). The internal carryover combination is included in the internal winning combination.

The CB gaming state is a gaming state structured by a game in which ra second type special single bonusj operates. In the CB gaming state, the left reel 3L is under no control state (maximum number of sliding symbols is 1) and the maximum number of sliding symbols of the other reels is 4. In addition, in the gaming state except the CB gaming state, the maximum number of sliding symbols is 4. The number of sliding symbols is a moving amount of a symbol after the corresponding stop button is pushed.

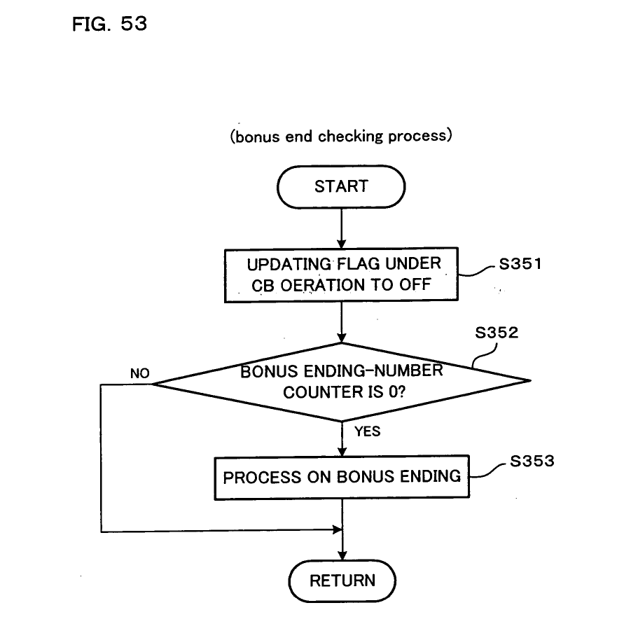

The CB gaming state can be identified depending on whether a flag under CB operation is ON or OFF. The flag under CB operation is the information for identifying whether or not a gaming state is the CB gaming state. When a flag under MB operation is ON, the flag under CB operation is updated to ON. When one game is over, the flag under CB operation is updated to OFF (see a step S351 in FIG. 53).

The flag under MB operation is the information for identifying whether a gaming state occurring with MB being established is an advantageous state or not. In the advantageous state, with regard to a unit game value used to play a game (for example, 1 medal bet per a game), an expected value of a game value to be awarded to a player is relatively higher than in the normal gaming state (i.e., the extent of advantage is relatively higher). When MB is made, the flag under MB operation is updated to ON. MB is a continuous operation device of single bonus relating to a second type special single bonus. When the number of medals paid out exceeds a possible payout number (i.e., bonus ending-number counter becomes 0), the flag under MB operation is updated to OFF. The bonus ending-number counter is the number of medals which can be paid out in a game from after the flag under MB operation is updated to ON until the flag under MB operation is updated to OFF. When MB is made, 250 is set as an initial value of the bonus ending-number counter.

It is described a relationship of the flag under MB operation and the flag under CB operation from after the flag under MB operation is updated to ON until it is updated to OFF. When MB is made, the flag under MB operation is updated to ON. In case that the flag under MB operation is ON, the flag under CB operation is updated to ON. Then, when a game is over, the flag under CB operation is updated to OFF. If the flag under MB operation is ON when a game is started, the flag under CB operation is again updated to ON.

If the condition that the flag under MB operation is updated to OFF is satisfied, the flag under MB operation is updated to OFF. At this time, with the flag under MB operation being updated to OFF, it is maintained the state that the flag under CB operation is updated to OFF. Accordingly, when the flag under MB operation is ON, the flag under CB operation is updated to ON. In other words, after MB is made, the CB gaming state is maintained until the flag under MB operation is updated to OFF.

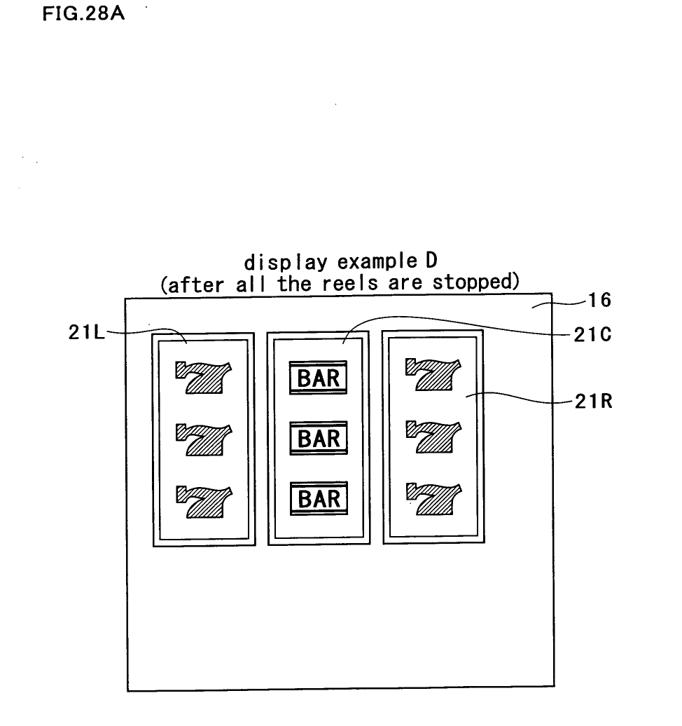

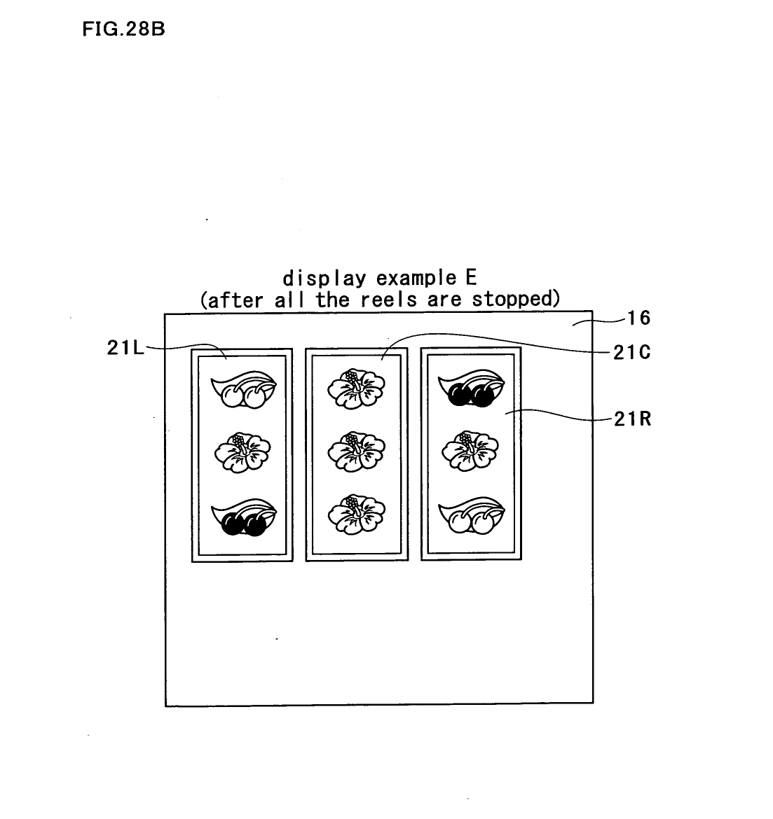

In the followings, it is described a display example of the liquid crystal display unit 2b with reference to FIG. 28A, 28B.

FIG. 28A, 28B shows a display example after all the reels 3L, 3C, 3R are stopped. In the example, it is controlled that an area of the liquid crystal panel 134 corresponding to the symbol display areas 21L, 21C, 21R becomes a white display. The player can observe the symbol stopped at the symbol stop position through the symbol display areas 21L, 21C, 21R.

FIG. 28A shows a mode (display example D) of which the bonus symbols are stopped at all the symbol stop positions (active area and non-active area) corresponding to the respective symbol display areas 21L, 21C, 21R. Specifically, the bonus symbol ┌Red 7┘ is stopped at all the symbol stop positions provided to the left symbol display area 21L. The bonus symbol ┌BAR┘ is stopped at all the symbol stop positions provided to the center symbol display area 21C. The bonus symbol ┌Red 7┘ is stopped at all the symbol stop positions provided to the right symbol display area 21R.

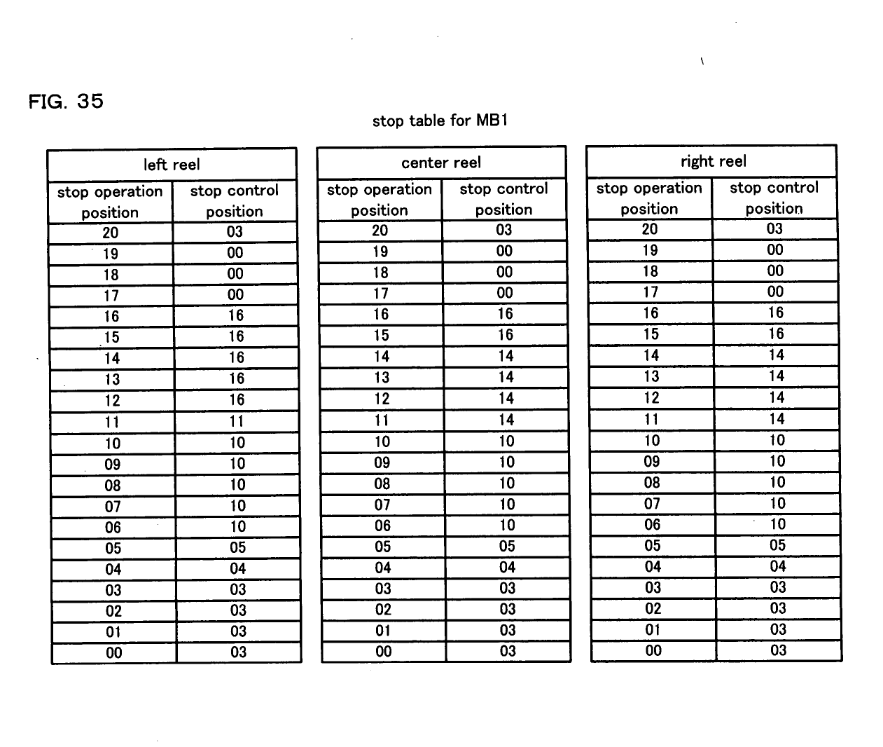

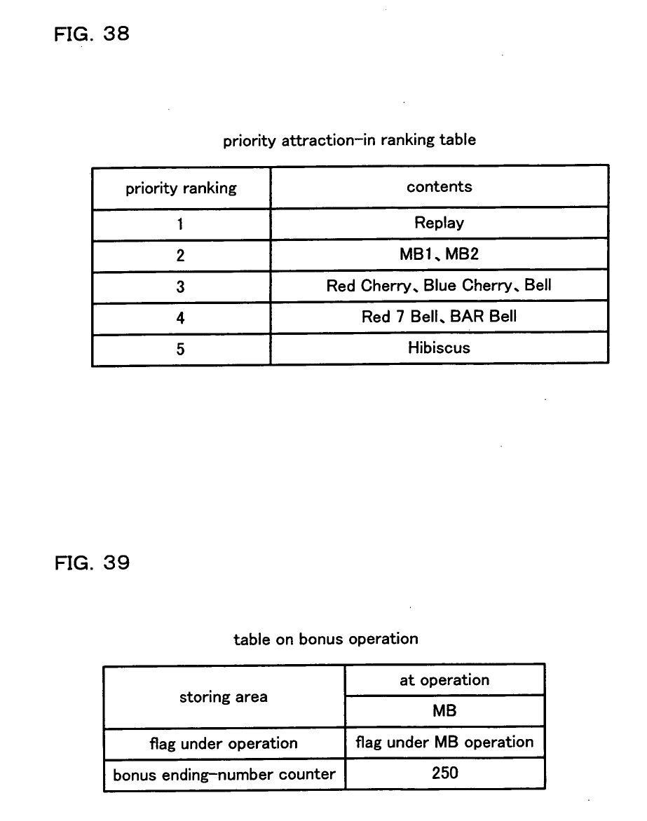

In one embodiment, the three same bonus symbols ┌Red 7┘ or ┌BAR┘ are successively arranged in the respective reels 3L, 3C, 3R. In other words, there is a case where three bonus symbols are arranged and stopped in the respective symbol display areas 21L, 21C, 21R. In addition, in one embodiment, when an internal winning combination is determined, it is retrieved a symbol which can be attracted-in under control of program, or it is determined which of the plural types of symbols is displayed on the activated line using stop tables (see FIGS. 35 to 37) and a priority attraction-in ranking table (see FIG. 38).

Specifically, when an internal winning of MB1 only is determined, ┌Red 7┘ or ┌Replay┘ is displayed at the central symbol stop position of the left symbol display area 21L, ┌Red 7┘, ┌BAR┘ or ┌Bell┘ is displayed at the central symbol stop position of the central symbol display area 21C and ┌Red 7┘, ┌BAR┘ or ┌Replay┘ is displayed at the central symbol stop position of the right symbol display area 21R, based on a stop table for MB1 which will be described later.

In other words, in one embodiment, the symbol display areas (symbol display means) 21L, 21C, 21R are structured such that the bonus symbols (symbol constituting a specific symbol combination) equal to or more than the number of symbol stop positions provided to the symbol display areas 21L, 21C, 21R are displayed in the variation direction, with regard to each of the plural rows, and in a reel stop control process which will be described later, it is carried out the stop control capable of stopping the bonus symbols at all the symbol stop positions provided to the symbol display areas 21L, 21C, 21R, regarding to each of the plural rows.

In addition, the symbol to be stopped is different depending on the stop operation timing and the stop operation position. However, when the stop control is carried out on the basis of the stop table for MB1, the two same bonus symbols may be displayed along one activated line. In addition, in this case, the three bonus symbols ┌Red 7┘ or ┌BAR┘ may be stopped in succession. In other words, when the stop table for MB1 is used, the three same bonus symbols may be successively stopped or the two same bonus symbols may be displayed along one activated line.

In the mean time, when an internal winning of MB is not determined, it is determined a symbol to be displayed at the activated line, based on a stop table (not shown) structured so that the two same bonus symbols are not displayed along one activated line. In addition, this stop table is structured such that the three same bonus symbols are not successively stopped in the respective symbol display areas 21L, 21C, 21R. In other words, in case that an internal winning of MB is not determined, the three same bonus symbols are not successively stopped in the respective symbol display areas 21L, 21C, 21R and the two same bonus symbols are not displayed along one activated line. Like this, in case that the three same bonus symbols are successively stopped in the respective symbol display areas 21L, 21C, 21R or the two same bonus symbols are displayed along one activated line, an internal winning of MB is determined.

In other words, in one embodiment, in case that the variable display is carried out in any one of the plural rows on condition that an internal winning combination is MB (special combination), it is carried out the stop control capable of displaying the bonus symbols (symbols constituting a specific symbol combination) at the symbol stop positions provided to the symbol display areas 21L, 21C, 21R, with regard to each of all the reels in which the variable display is not carried out among the lines connecting the one symbol stop position predetermined for each of the plural rows. In addition, in case that the variable display is carried out in any one of the plural rows on condition that an internal winning combination is not MB, it is carried out the stop control which does not display the bonus symbols at the symbol stop positions provided to the symbol display areas 21L, 21C, 21R, with regard to each of all the reels in which the variable display is not carried out among the lines connecting the one symbol stop position predetermined for each of the plural rows.

As described above, in the display example D, since the three same bonus symbols are successively stopped in the respective symbol display areas 21L, 21C, 21R, the display example D is a mode of a case where an internal winning of MB is determined. The player can easily perceive the stop mode and the fact that an internal winning of MB is determined, since the three same bonus symbols are successively stopped in the respective symbol display areas 21L, 21C, 21R.

FIG. 28B shows a mode (display example E) of which Hibiscus is established. Specifically, ┌Blue Cherry┘, ┌Hibiscus┘ and ┌Red Cherry┘ are stopped at the upper, central and lower symbol stop positions provided to the left symbol display area 21L. ┌Hibiscus┘, ┌Hibiscus┘ and ┌Hibiscus┘ are stopped at the upper, central and lower symbol stop positions provided to the central symbol display area 21C. ┌Red Cherry┘, ┌Hibiscus┘ and ┌Blue Cherry┘ are stopped at the upper, central and lower symbol stop positions provided to the right symbol display area 21R.

In one embodiment, since the lowest and upper limits corresponding to Hibiscus are within a range of the lowest and upper limits corresponding to MB, when Hibiscus is determined as an internal winning combination, MB is also determined as an internal winning combination. When Hibiscus is determined as an internal winning combination, since an internal winning of MB is also determined, the player who is concerned about the occurrence of MB pays attention to ┌Hibiscus┘. Herein, ┌Hibiscus┘ is arranged between ┌Red Cherry┘ and ┌Blue Cherry┘.

In addition, in one embodiment, when ┌Red Cherry┘ or ┌Blue Cherry┘ is stopped on the activated line, Cherry is established. In other words, in case of Cherry, when one symbol is stopped, Cherry (combination) is established. Accordingly, the player much pays attention to ┌Red Cherry┘ or ┌blue Cherry┘, as compared to a symbol constituting a symbol combination corresponding to Small Win except Cherry.

In other words, in one embodiment, the symbol display areas 21, 21C, 21R are structured such that ┌Cherry┘ (specific symbol), ┌Hibiscus┘ (symbol constituting a second symbol combination corresponding to a second combination) and ┌Cherry ┘ are successively displayed in this order with regard to the left reel 3L (specific row). In addition, in a reel stop control process which will be described later, with regard to the left reel 3L, it is carried out the stop control capable of stopping ┌Cherry┘ in the symbol stop positions (upper symbol stop position and lower symbol stop position) of the upper and lower parts provided to the symbol display areas 21L, 21C, 21R and ┌Hibiscus┘ in the symbol stop positions (central symbol stop position) of the central parts provided to the symbol display areas 21L, 21C, 21R.

As described above, in the display example E, ┌Red Cherry┘ and ┌Blue Cherry┘ are displayed in the symbol stop positions which are not related to whether a combination is established or not. The player pays attention to the symbols stopped. Since ┌Hibiscus┘ arranged between the symbols is stopped on the activated line, an impact stop display pattern is provided. Accordingly, the player can easily perceive Hibiscus established. In addition, since the player perceives that Hibiscus is established, the player can perceive that an internal winning of MB is determined.

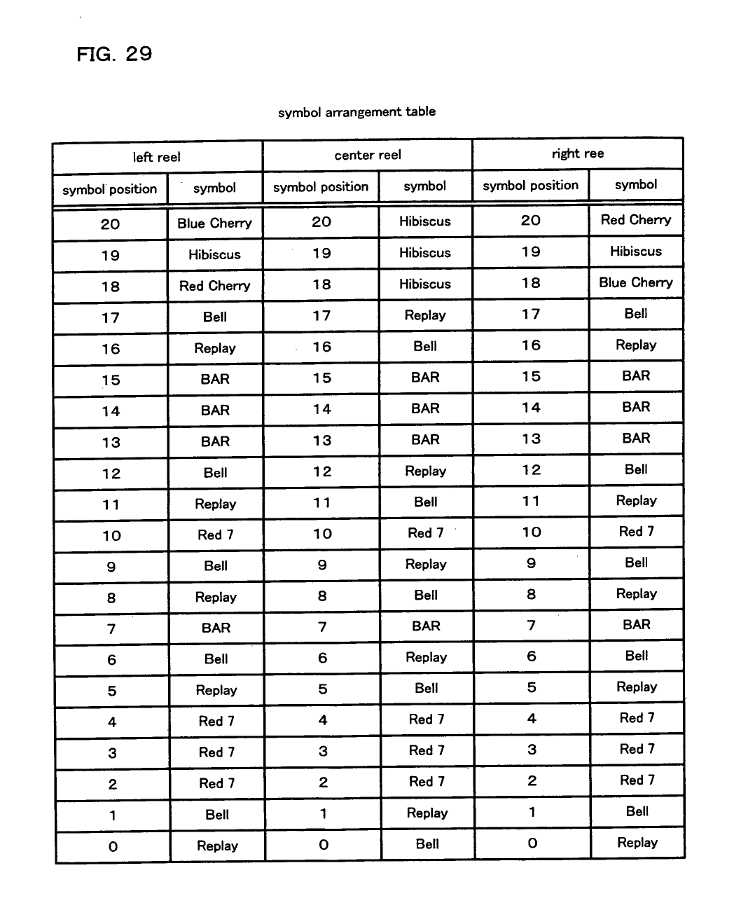

In the followings, a symbol arrangement table is described with reference to FIG. 29.

A symbol arrangement table includes the information about the symbols arranged on the peripheries of the reels corresponding to the symbol positions (code numbers) of the reels 3L, 3C, 3R. Based on the symbol arrangement table and a symbol combination table (which will be described later), it is possible to perceive a combination of symbols arranged along the activated line.

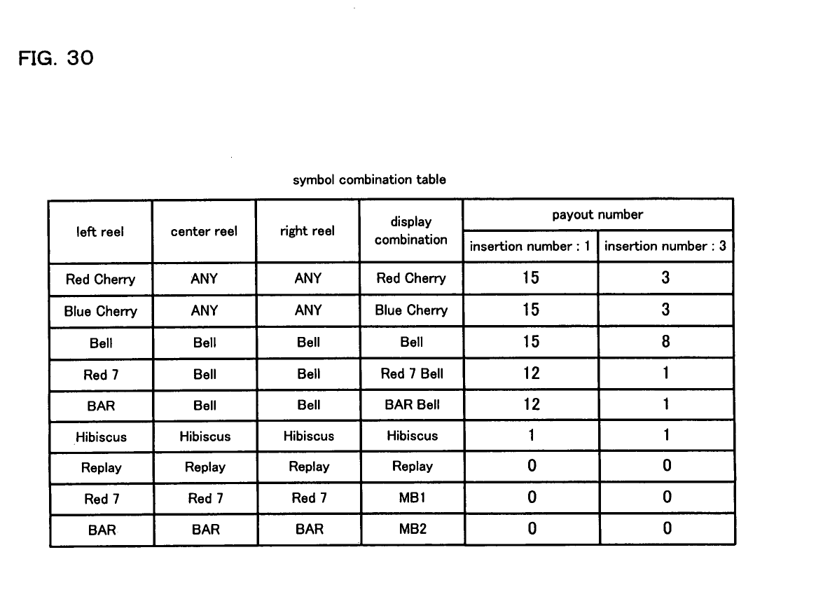

In the followings, a symbol combination table is described with reference to FIG. 30.

A symbol combination table includes the information about a display combination corresponding to a combination of symbols stopped at each of the three symbol stop positions connected by the one activated line, and the information about the payout number for each of the insertion numbers (bet numbers) corresponding to the display combination. The symbol combination table is referred to when the payout number is determined in accordance with the combination of symbols displayed along the activated line, after all the reels 3L, 3C, 3R are stopped. In addition, it is omitted the payout number when the insertion number is 2.

When a winning number is 1 (Red Cherry), Red Cherry may be a display combination. When ┌Red Cherry-Any-Any┘ is arranged along the activated line, Red Cherry becomes a display combination. At this time, when the insertion number is 1, 15 medals are paid out, and when the insertion number is 3, 3 medals are paid out. ┌Any┘ represents any symbol.

When ┌Blue Cherry-Any-Any┘ is arranged along the activated line, Blue Cherry becomes a display combination. At this time, when the insertion number is 1, 15 medals are paid out, and when the insertion number is 3, 3 medals are paid out. When ┌Bell-Bell-Bell┘ is arranged along the activated line, Bell becomes a display combination. At this time, when the insertion number is 1, 15 medals are paid out, and when the insertion number is 3, 8 medals are paid out.

When ┌Red 7-Bell-Bell┘ is arranged along the activated line, Red 7 Bell becomes a display combination. At this time, when the insertion number is 1, 12 medals are paid out, and when the insertion number is 3, one medal is paid out. When ┌BAR-Bell-Bell┘ is arranged along the activated line, BAR Bell becomes a display combination. At this time, when the insertion number is 1, 12 medals are paid out, and when the insertion number is 3, one medal is paid out. When ┌Hibiscus-Hibiscus-Hibiscus┘ is arranged along the activated line, Hibiscus becomes a display combination. At this time, when the insertion number is 1, one medal is paid out, and when the insertion number is 3, one medal is paid out. When ┌Replay-Replay-Replay┘ is arranged along the activated line, Replay becomes a display combination and a medal is automatically inserted.

When ┌Red 7-Red 7-Red 7┘ (which is a symbol combination operating the continuous operation device relating to the second type special single bonus) is arranged along the activated line, MB1 becomes a display combination and the gaming state is shifted to the CB gaming state. When ┌BAR-BAR-BAR┘ is arranged along the activated line, MB2 becomes a display combination and the gaming state is shifted to the CB gaming state.

Herein, since it is not defined regulations about the number of symbol combinations operating the continuous operation device relating to the second type special single bonus, it is possible to freely define the number of symbol combinations. For example, it is possible to arrange a symbol which is attracted-in without fail, such as Bell, Replay, etc.

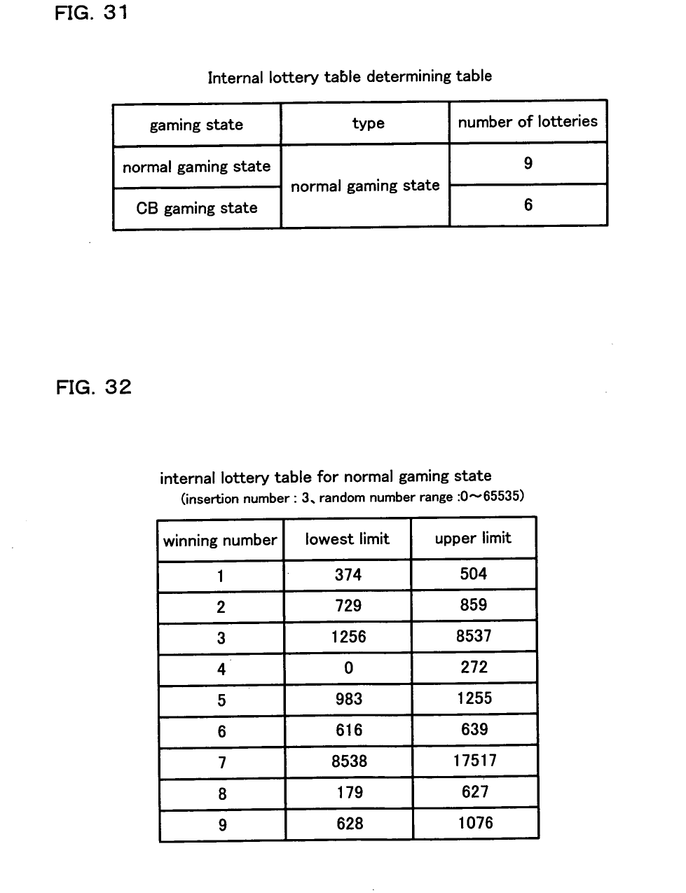

In the followings, it is described an internal lottery table determining table with reference to FIG. 31.

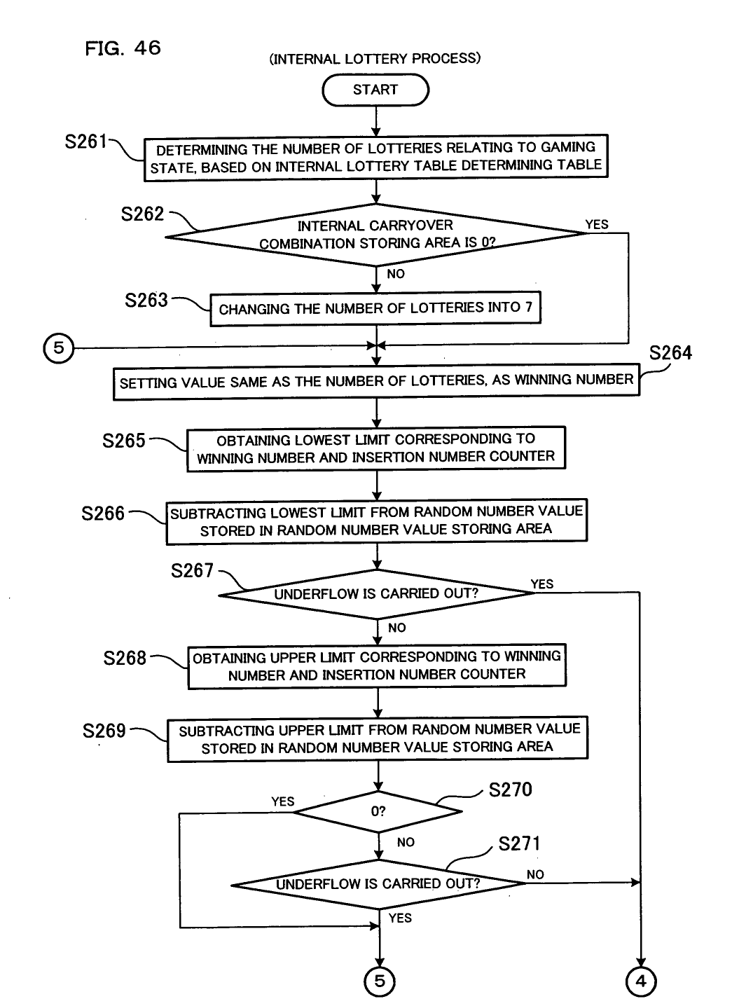

An internal lottery table determining table includes the information about an internal lottery table (see FIG. 32) and the number of lotteries, which correspond to the gaming state. In the normal gaming state, it is selected an internal lottery table for normal gaming state (see FIG. 32) and the number of lotteries is basically determined to be 9 (see a step S261 in FIG. 46). The number of lotteries is the number of cases where it is carried out a process required to determine an internal winning combination.

Specifically, the number of lotteries is the number of cases where it is determined whether a random number value is within a predetermined range (numerical range expressed by the lowest and upper limits corresponding to a winning number, which will be described with reference to FIG. 32). In the mean time, the number of lotteries is updated to 7 from 9 in the carryover section (see a step S263 in FIG. 46).

In the followings, an internal lottery table is described with reference to FIG. 32. An internal lottery table is provided every gaming state and includes the information about a numerical range expressed by the lowest and upper limits corresponding to a winning number for each of the insertion numbers. FIG. 32 shows an internal lottery table for normal gaming state. In addition, it is omitted an internal lottery table except the internal lottery table for normal gaming state, such as internal lottery table for CB gaming state.

In determining (lottery) a winning number based on the internal lottery table, it is determined whether the random number value is within a range expressed by the lowest limit and the upper limit corresponding to a winning number, from a winning number same as the number of lotteries determined for each gaming state, in descending order, until the winning number becomes 0. When the random number value is within a range expressed by the lowest limit and the upper limit, a corresponding winning number is determined. In addition, the number of cases where it is determined whether or not the random number value is within a range expressed by the lowest limit and the upper limit corresponding to a winning number is same as the number of lotteries determined in the internal lottery table determining table in FIG. 31.

In addition, when the random number value is never within a range expressed by the lowest limit and the upper limit until the winning number becomes 0, the wining number is 0 (i.e., losing). The losing of an internal winning combination means that it is not determined a combination matched to a payout to be awarded to the player in the internal lottery. In addition, in the embodiment, the losing is not a combination which is matched to a game value. In addition, a symbol combination corresponding to the losing as an internal winning combination may be considered as any symbol combination different from symbol combinations corresponding to plural combinations provided in advance. However, in the embodiment, a symbol combination corresponding to the losing is not provided.

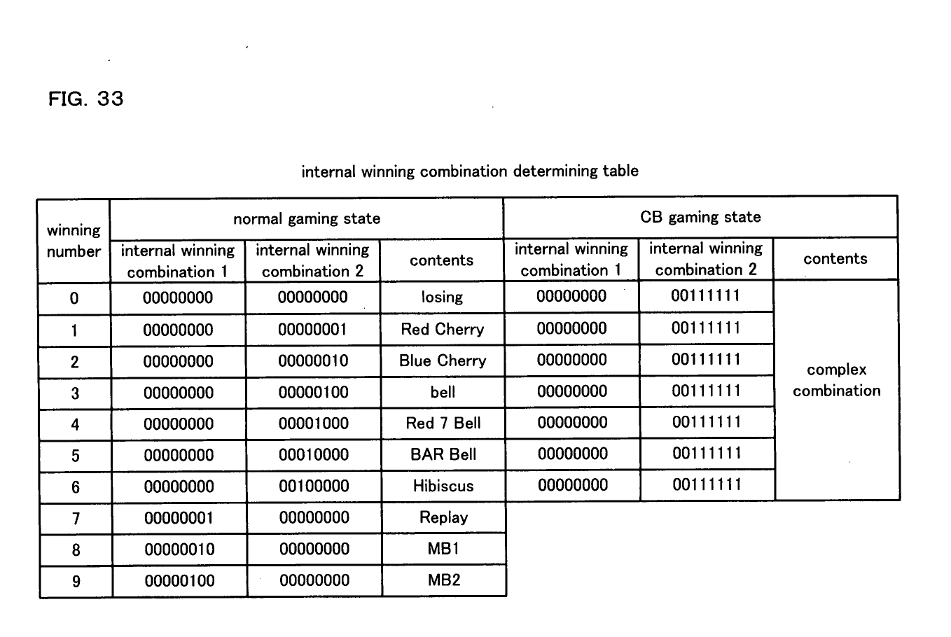

In addition, it is determined whether or not a winning is made, from the winning number, in descending order, until a winning number becomes 0, and the numerical ranges defined by the lowest and upper limits corresponding to each of the plural combinations are duplicately set. Accordingly, plural combinations may be determined as an internal winning combination. An internal winning combination is determined on the basis of the winning number determined, the gaming state, the insertion number and the internal winning combination determining table (see FIG. 33).

For example, in case of the normal gaming state (game section except the carryover section), when the insertion number is 3 and the random number value sampled from the range of 0˜65535 is 630, “the random number value (R) (630)—the lowest limit (L) (628)” is calculated for the winning number 9 first of all. The calculation result becomes 0 or more. Subsequently, “the random number value (R) (630)—the upper limit (U) (1076)” is calculated. This calculation result becomes 0 or less. Accordingly, since the random number value is within the numerical range expressed by the lowest and upper limits corresponding to the winning number (i.e., L≦R≦RU), when the random number value sampled is 630, the winning number 9 is determined. When the winning number 9 is determined, MB2 corresponding to the winning number 9 becomes an internal winning combination, based on an internal winning combination determining table (see FIG. 33).

Next, “the random number value (R) (630)—the lowest limit (L) (179)” is calculated for the winning number 8. Since the calculation result becomes 0 or more, “the random number value (R) (630)—the upper limit (U) (627)” is calculated. This calculation result is greater than 0. Accordingly, since the random number value is not within the numerical range expressed by the lowest and upper limits corresponding to the winning number, when the random number value sampled is 630, the winning number 8 is not determined.

Like this, the calculations of “random number value (R) (630)—lowest limit (L)” and “random number value (R) (630)—upper limit (U)” are repeated in descending order until the winning number becomes 0 so as to determine whether each of the winning numbers 7˜1 is determined or not. When the random number value sampled is 630, the winning numbers 7 and 5 to 1 are not determined. However, the winning number 6 is determined since the lowest limit (L) is 616 and the upper limit (U) is 639. Therefore, when the random number value sampled is 630, the winning numbers 6 and 9 are determined, so that both Hibiscus and MB2 are determined as an internal winning combination on the basis of the internal winning combination determining table (see FIG. 33).

In case of the carryover section, the number of lotteries is changed into 7 (see a step S263 in FIG. 46). Accordingly, in the carryover section, since there is no case where the winning number 8 or 9 is determined, MB1 or MB2 is not determined as an internal winning combination, based on the internal winning combination determining table (see FIG. 33).

In the followings, it is described an internal winning combination determining table with reference to FIG. 33.

An internal winning combination determining table includes the information (data) about an internal winning combination (flag) corresponding to a winning number. The flag is expressed by binary number. The internal winning combinations 1 and 2 expressed to correspond to the winning number are the information for identifying an internal winning combination and consist of 1 byte, respectively. Basically, the internal winning combination 1 is related to the internal carryover combination.

In the normal gaming state, when the winning number is 0 and the internal winning combination 2 is ┌00000000┘, the losing is determined as an internal winning combination. When the winning number is 1 and the internal winning combination 2 is ┌00000001┘ , an internal winning combination is Red Cherry. When the winning number is 2 and the internal winning combination 2 is ┌00000010┘, an internal winning combination is Blue Cherry.

When the winning number is 3 and the internal winning combination 2 is ┌00000100┘, an internal winning combination is Bell. When the winning number is 4 and the internal winning combination 2 is ┌00001000┘, an internal winning combination is Red 7 Bell. When the winning number is 5 and the internal winning combination 2 is ┌00010000┘, an internal winning combination is BAR Bell. When the winning number is 6 and the internal winning combination 2 is ┌00100000┘, an internal winning combination is Hibiscus.

When the winning number is 7 and the internal winning combination 1 is ┌00000001┘, an internal winning combination is Replay. When the winning number is 8 and the internal winning combination 1 is ┌00000010┘, an internal winning combination is MB1. When the winning number is 9 and the internal winning combination 1 is ┌00000100┘, an internal winning combination is MB2.

In the CB gaming state, the internal winning combination 2 is ┌00111111┘ for the respective winning numbers 0 to 6, and an internal winning combination is a complex combination.

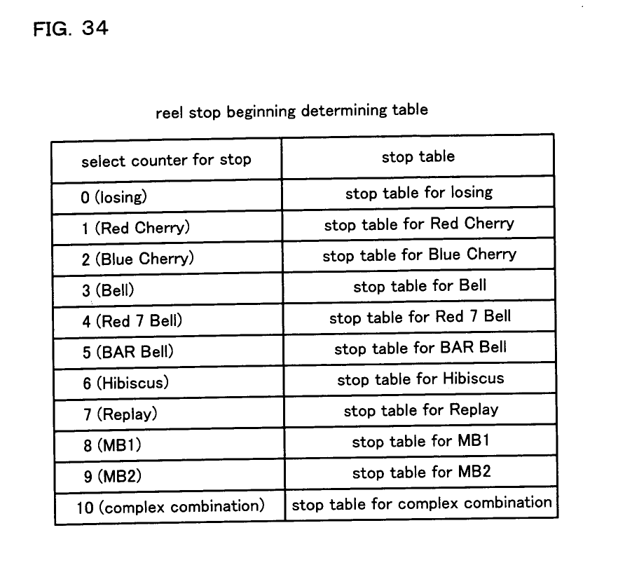

In the followings, it is described a reel stop beginning determination table with reference to FIG. 34.

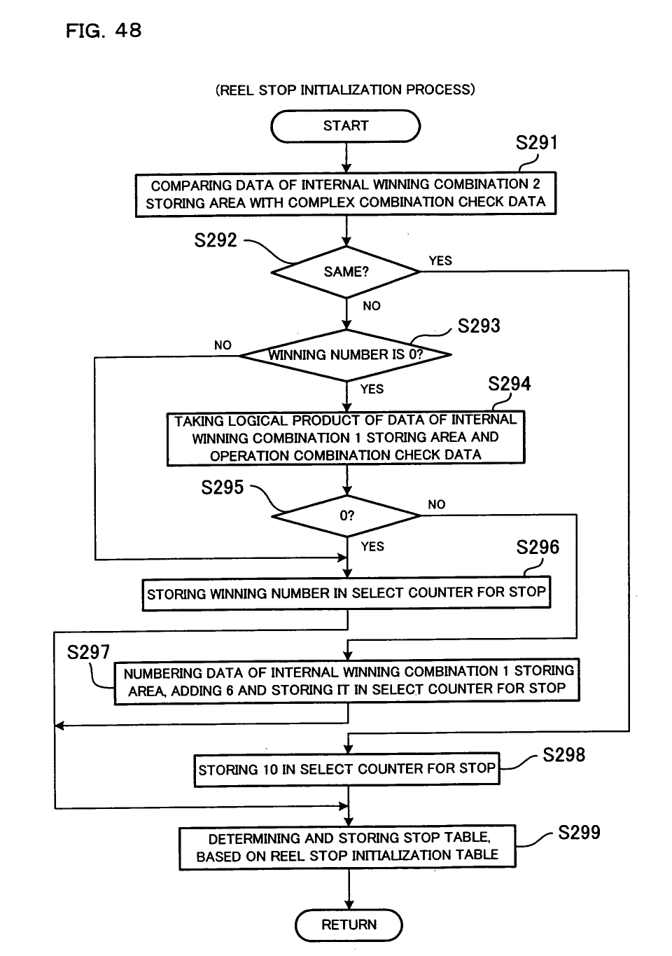

A reel stop beginning determination table includes the information of stop tables corresponding to the respective values 0 to 9 of a select counter for stop. The winning numbers are set in the select counter for stop (see a step S296 in FIG. 48). However, in case that an internal winning combination is a complex combination, 10 is set in the select counter for stop (see a step S298 in FIG. 48).

In the followings, it is described a stop table with reference to FIGS. 35 to 37.

Basically, a stop table is structured so that a predetermined symbol combination (symbol combination of a corresponding combination) is arranged along a predetermined display line (activated line). However, a stop table corresponding to Losing is structured so that a symbol combination corresponding to a combination is not arranged along the predetermined display line.

The stop table includes the information about a stop operation position and a stop control position of the respective reels 3L, 3C, 3R. The stop operation position represents a code number of a symbol located on the center line 8c (specifically, symbol whose center is above the center line 8c and nearest at the position of the center line 8c) when the stop buttons 7L, 7C, 7R mounted to correspond to the respective reels 3L, 3C, 3R are pushed. The stop control position represents a code number of a symbol stopped at the position of the center line 8c when the reel for which the stop operation is carried out is stopped.

In one embodiment, the number of sliding symbols is set to be maximum ┌4 symbols┘. For example, if the stop button 7R is operated at the time when ┌Replay┘ of the code number ┌00┘ reaches the position of the center line 8c while the right reel 3R is being rotated, it is possible to stop-control the right reel 3R so that ┌Red 7┘ of the code number ┌03┘ is stopped at the position of the center line 8c.

For example, when both MB and Small Win (MB+Small Win) are determined as an internal winning combination, it is determined, with the stop button being pushed, whether or not it can be embodied the Fattraction-ini of symbols constituting a symbol combination corresponding to MB for each of the number of sliding symbols 0˜4, in accordance with a retrieval order predetermined. In one embodiment, the retrieval order is 0 symbol, 1 symbol, 2 symbols, 3 symbols and 4 symbols.

Specifically, it is retrieved whether the rattraction-ini is possible or not, in order of 0 symbol, 1 symbol, 2 symbols, 3 symbols and 4 symbols. The stop control of the reel is carried out with the number of sliding symbols determined that ┌attraction-in┘ is possible first of all. For example, if the ┌attraction-in┘ can be realized with 0 symbol, it is not carried out the determination of whether or not the ┌attraction-in┘ can be realized with 1 symbol, 2 symbols, 3 symbols and 4 symbols, and 0 symbol is determined as the number of sliding symbols.

Basically, the ┌attraction-in┘ is meant by stopping the reel (reel corresponding to stop operation), which is a stop control target, so that a symbol (hereinafter, referred to as ┌attraction-in target symbol┘ ) constituting a symbol combination corresponding to an attraction-in target combination is displayed at the symbol stop position (hereinafter, referred to as ┌active symbol stop position┘) connected by the activated line, under condition that the maximum number of sliding symbols is 4. The attraction-in target combination is a combination corresponding to a symbol combination which is desirably arranged along the activated line. In one embodiment, the attraction-in target combination is basically MB.

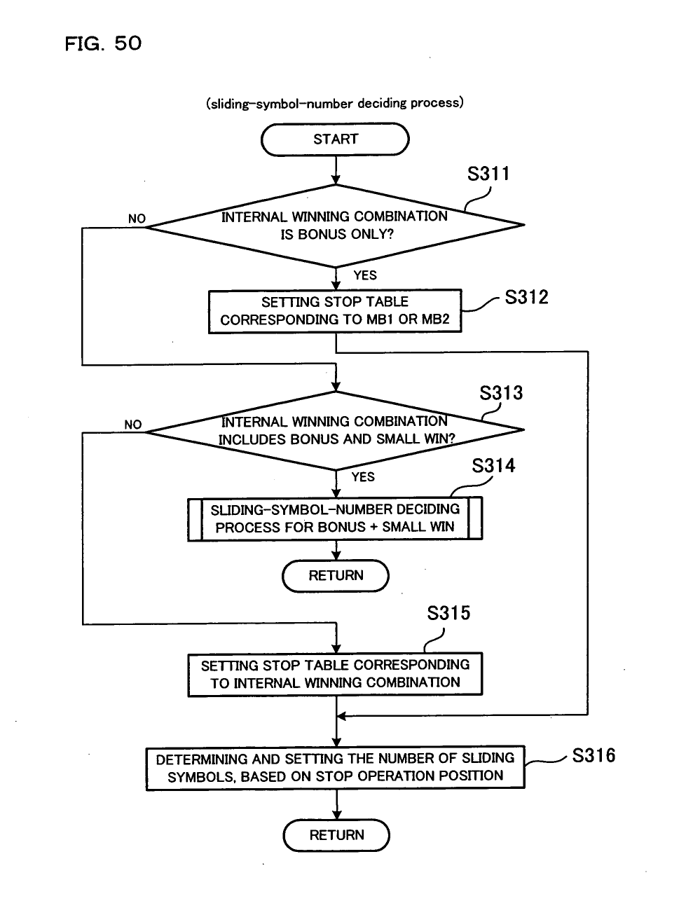

The ┌attraction-in┘ of MB (attraction-in target combination) is carried out in a game in which an internal winning combination is MB and Small Win. However, in a game in which an internal winning combination is MB and Replay (game in which a result of a determination in a step S313 of FIG. 50 is NO), since a priority ranking of Replay is higher than that of bonus, a stop table for Replay is set, so that the ┌attraction-in┘ of MB is not carried out.

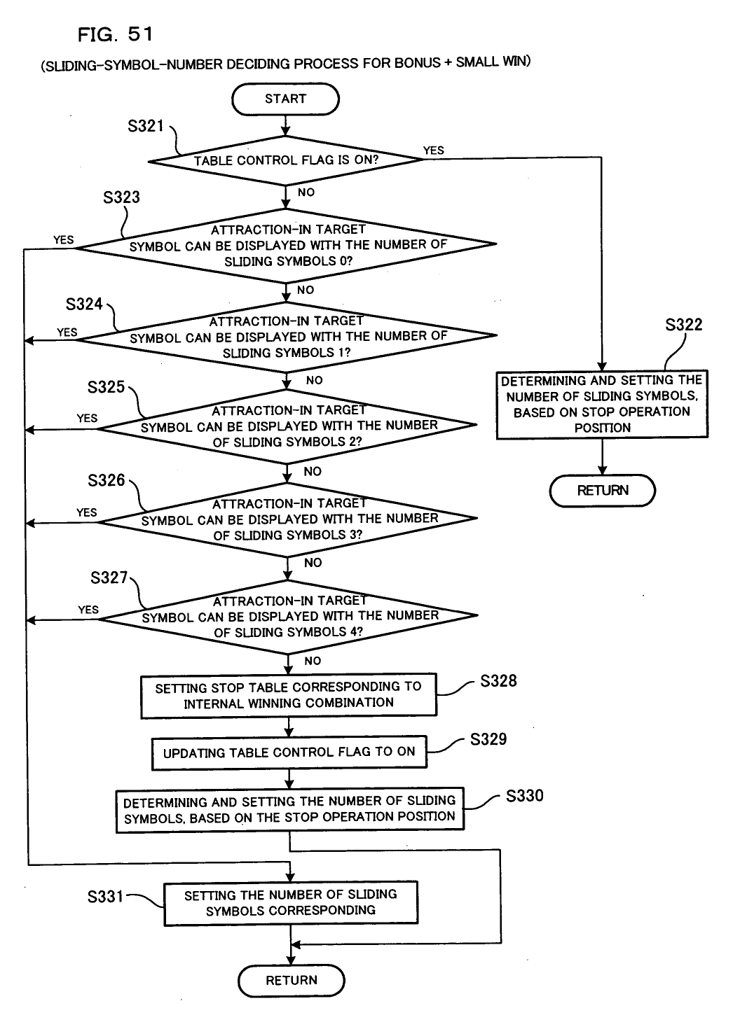

When the ┌attraction-in┘ is tried but is not realized within the range of the maximum number of sliding symbols (i.e., 4), it is set a table corresponding to the internal winning combination (see a step S328 in FIG. 51), and the stop control is carried out for the corresponding reel. However, in a game in which an internal winning combination is MB only, a stop table for MB is set (see a step S312 in FIG. 50).

In one embodiment, when the ┌attraction-in┘ corresponding to the first stop operation is not realized (a result of a determination in a step S327 of FIG. 51 is NO), it is carried out the stop control of the reels corresponding to the first to third stop operations, based on the stop table. In addition, when the ┌attraction-in┘ corresponding to the first stop operation is realized but the ┌attraction-in┘ corresponding to the second stop operation is not realized (a result of a determination in a step S327 of FIG. 51 is NO), it is carried out the stop control of the reels corresponding to the second and third stop operations, based on the stop table.

In addition, when the ┌attraction-in┘ corresponding to the first and second stop operations is realized but the ┌attraction-in┘ corresponding to the third stop operation is not realized (a result of a determination in a step S327 of FIG. 51 is NO), it is carried out the stop control of the reel corresponding to the third stop operation, based on the stop table.

In the followings, it is described an example of a stop table which is used when an internal winning combination is MB 1, with reference to FIG. 35.

In FIG. 35, the stop control position of the left reel 3L is any one of the code numbers ┌00┘, ┌03┘, ┌04┘, ┌05┘, ┌10┘, ┌11┘ and ┌16┘. In the symbol arrangement shown in FIG. 27, the symbols corresponding to the code numbers is ┌Red 7┘ or ┌Replay┘. Accordingly, ┌Red 7┘ or ┌Replay┘ is stopped at the central symbol stop position of the left symbol display area 2lL. In addition, when the code number of the stop control position of the left reel 3L is ┌03┘, the three same bonus symbols ┌Red 7┘ are successively stopped at all the symbol stop positions of the left symbol display area 21L.

In FIG. 35, the stop control position of the center reel 3C is any one of the code numbers ┌00┘, ┌03┘, ┌04┘, ┌05┘, ┌10┘, ┌14┘ and ┌16┘. In the symbol arrangement shown in FIG. 27, the symbols corresponding to the code numbers is ┌Red 7┘, ┌BAR┘ or ┌Bell┘. Accordingly, ┌Red 7┘, ┌BAR┘ or ┌Bell┘ is stopped at the central symbol stop position of the center symbol display area 21C.

In addition, when the code number of the stop control position of the center reel 3C is ┌03┘, the three same bonus symbols ┌Red 7┘ are successively stopped at all the symbol stop positions of the center symbol display area 21C. When the code number of the stop control position of the center reel 3C is ┌4┘, the three same bonus symbols ┌BAR┘ are successively stopped at all the symbol stop positions of the center symbol display area 21C.

In FIG. 35, the stop control position of the right reel 3R is any one of the code numbers ┌00┘, ┌03┘, ┌04┘, ┌05┘, ┌10┘, ┌14┘ and ┌16┘. In the symbol arrangement shown in FIG. 27, the symbols corresponding to the code numbers is ┌Red 7┘, ┌BAR┘ or ┌Replay┘. Accordingly, ┌Red 7┘, ┌BAR┘ or ┌Replay┘ is stopped at the upper symbol stop position of the right symbol display area 21R.

In addition, when the code number of the stop control position of the center reel 3R is ┌3┘, the three same bonus symbols ┌Red 7┘ are successively stopped at all the symbol stop positions of the right symbol display area 21R. When the code number of the stop control position of the right reel 3R is ┌14┘, the three same bonus symbols ┌BAR┘ are successively stopped at all the symbol stop positions of the right symbol display area 21R.

The stop table for MB1 shown in FIG. 35 is used, so that a symbol combination corresponding to a combination except MB1 is not stopped on the activated line, irrespective of the timing of the stop operation (stop operation position) by the player.

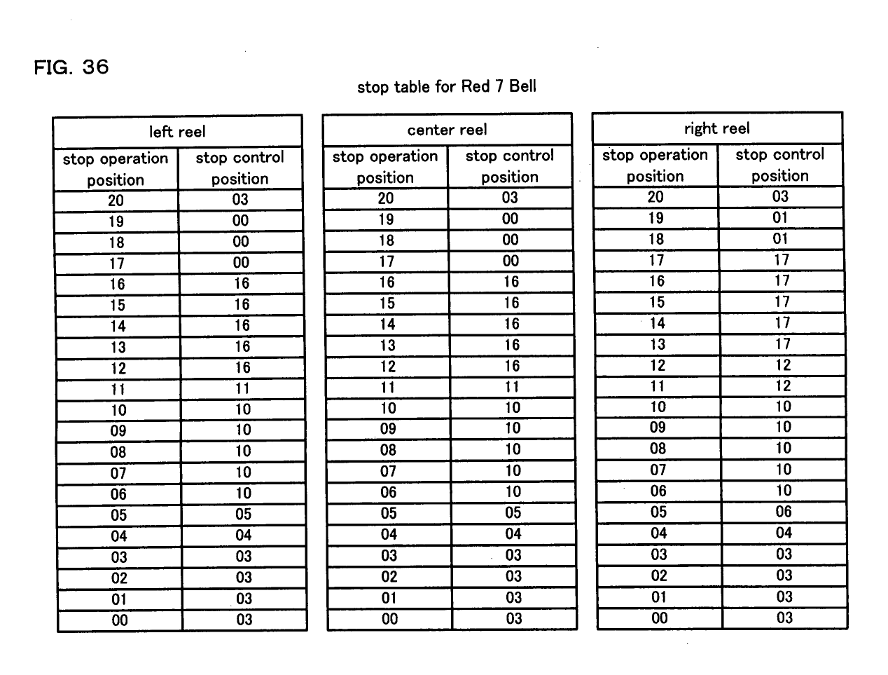

In the followings, it is described an example of a stop table which is used when an internal winning combination is Red 7 Bell, with reference to FIG. 36.

In FIG. 36, the stop control position of the left reel 3L is any one of the code numbers ┌00┘, ┌03┘, ┌04┘, ┌05┘, ┌10┘, ┌11┘ and ┌16┘. In the symbol arrangement shown in FIG. 27, the symbols corresponding to the code numbers is ┌Red 7┘ or ┌Replay┘. Accordingly, ┌Red 7┘ or ┌Replay┘ is stopped at the central symbol stop position of the left symbol display area 21L.

In FIG. 36, the stop control position of the center reel 3C is any one of the code numbers ┌00┘, ┌03┘, ┌04┘, ┌05┘, ┌10┘, ┌11┘ and ┌16┘. In the symbol arrangement shown in FIG. 27, the symbols corresponding to the code numbers is ┌Red 7┘ or ┌Bell┘. Accordingly, ┌Red 7┘ or ┌Bell┘ is stopped at the central symbol stop position of the center symbol display area 21C.

In FIG. 36, the stop control position of the right reel 3R is any one of the code numbers ┌01┘, ┌03┘, ┌04┘, ┌06┘, ┌10┘, ┌12┘ and ┌17┘. In the symbol arrangement shown in FIG. 27, the symbols corresponding to the code numbers is ┌Red 7┘ or ┌Bell┘. Accordingly, ┌Red 7┘ or ┌Bell┘ is stopped at the upper symbol stop position of the right symbol display area 21R.

The stop table for Red 7 Bell shown in FIG. 36 is used, so that a symbol combination corresponding to a combination except MB1 and Red 7 Bell is not stopped on the activated line, irrespective of the timing of the stop operation (stop operation position) by the player.

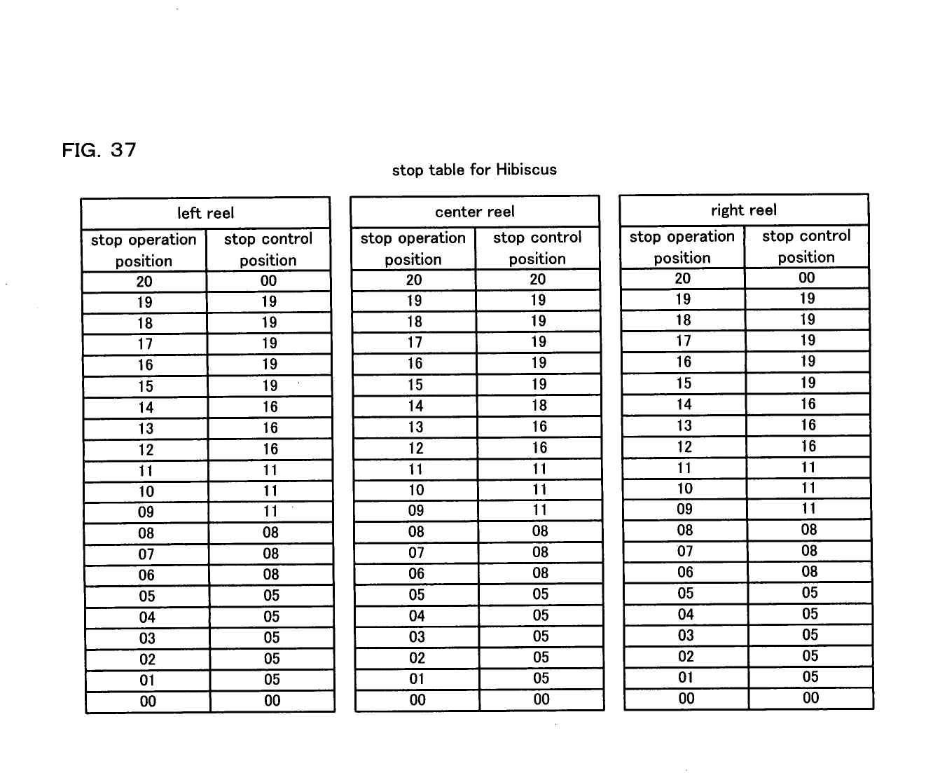

In the followings, it is described an example of a stop table which is used when an internal winning combination is Hibiscus, with reference to FIG. 37.

In FIG. 37, the stop control position of the left reel 3L is any one of the code numbers ┌00┘, ┌05┘, ┌08┘, ┌11┘, ┌16┘ and ┌9┘. In the symbol arrangement shown in FIG. 27, the symbols corresponding to the code numbers is ┌Hibiscus┘ or ┌Replay┘ Accordingly, ┌Hibiscus┘ or ┌Replay┘ is stopped at the central symbol stop position of the left symbol display area 21L.

In FIG. 37, the stop control position of the center reel 3C is any one of the code numbers ┌00┘, ┌05┘, ┌08┘, ┌11┘, ┌16┘, ┌18┘, ┌19┘ and ┌20┘. In the symbol arrangement shown in FIG. 27, the symbols corresponding to the code numbers is ┌Hibiscus┘ or ┌Bell┘. Accordingly, ┌Hibiscus┘ or ┌Bell┘ is stopped at the central symbol stop position of the center symbol display area 21C.

In FIG. 37, the stop control position of the right reel 3R is any one of the code numbers ┌00┘, ┌05┘, ┌08┘, ┌11┘, ┌16┘ and ┌19┘. In the symbol arrangement shown in FIG. 27, the symbols corresponding to the code numbers is ┌Hibiscus┘ or ┌Replay┘ Accordingly, ┌Hibiscus┘ or ┌Replay┘ is stopped at the upper symbol stop position of the right symbol display area 21R.

The stop table for Hibiscus shown in FIG. 37 is used, so that a symbol combination corresponding to a combination except Hibiscus is not stopped on the activated line, irrespective of the timing of the stop operation (stop operation position) by the player.

In the followings, a priority attraction-in ranking table is described with reference to FIG. 38.

A priority attraction-in ranking table includes the information about a relative priority attraction-in ranking of a symbol combination corresponding to a combination. The ┌attraction-in┘ is meant by stopping the reel (reel corresponding to stop operation), which is a stop control target, so that a symbol (hereinafter, referred to as ┌attraction-in target symbol┘) constituting a symbol combination corresponding to an attraction-in target combination is displayed, within a range of the maximum number of sliding symbols, at the symbol stop position (hereinafter, referred to as ┌active symbol stop position┘) connected by the activated line. The attraction-in target combination is a combination (internal winning combination) corresponding to a symbol combination which is desirably arranged along the activated line.

However, in case of the second and third stop operations, the rattraction-in┘ is meant as follows: when a symbol constituting a symbol combination corresponding to an attraction-in target combination is displayed at an active symbol stop position together with an attraction-in target symbol corresponding to this stop operation, the attraction-in target symbol is displayed at the active symbol stop position in the symbol display areas 21L, 21C, 21R connected by the activated line connecting the active symbol stop position.

Replay has the highest priority attraction-in ranking. A priority ranking of MB is higher than those of combinations except Replay. Accordingly, in case that MB is carried over, Replay is preferentially established when an internal winning of Replay is determined. In the mean time, in case that MB is carried over, MB is preferentially established when an internal winning of a combination except Replay is determined.

In addition, priority rankings of Red Cherry, Blue Cherry and Bell are higher than those of Red 7 Bell, BAR Bell and Hibiscus. Accordingly, in the CB gaming state, it is preferentially carried out the attraction-in of Red Cherry, Blue Cherry and Bell over Red 7 Bell, BAR Bell and Hibiscus when the stop control of the center and right reels 3C, 3R is carried out.

In addition, priority rankings of Red 7 Bell and BAR Bell are higher than that of Hibiscus. Accordingly, in the CB gaming state, it is preferentially carried out the attraction-in of Red 7 Bell and BAR Bell over Hibiscus when the stop control of the center and right reels 3C, 3R is carried out.

In the followings, it is described a table on bonus operation with reference to FIG. 39.

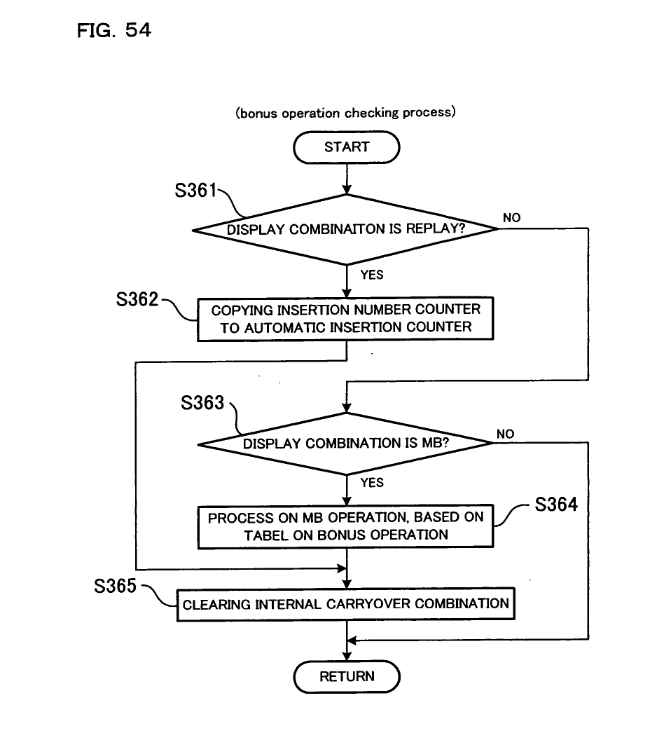

A table on bonus operation includes the information of a flag under. operation to be updated to ON, a value set in the bonus ending-number counter, the possible game-number and possible winning-number, for each of display combinations. The table on bonus operation is referred to in a step S364 of FIG. 54 which will be described later.

The flag under operation is the information for identifying a gaming state being operated (i.e., current gaming state). The flag under operation includes a flag under MB operation in correspondence with a display combination.

The bonus ending-number counter is a counter for counting the number of medals paid out in a game from after the flag under MB operation is updated to ON until it is updated to OFF.

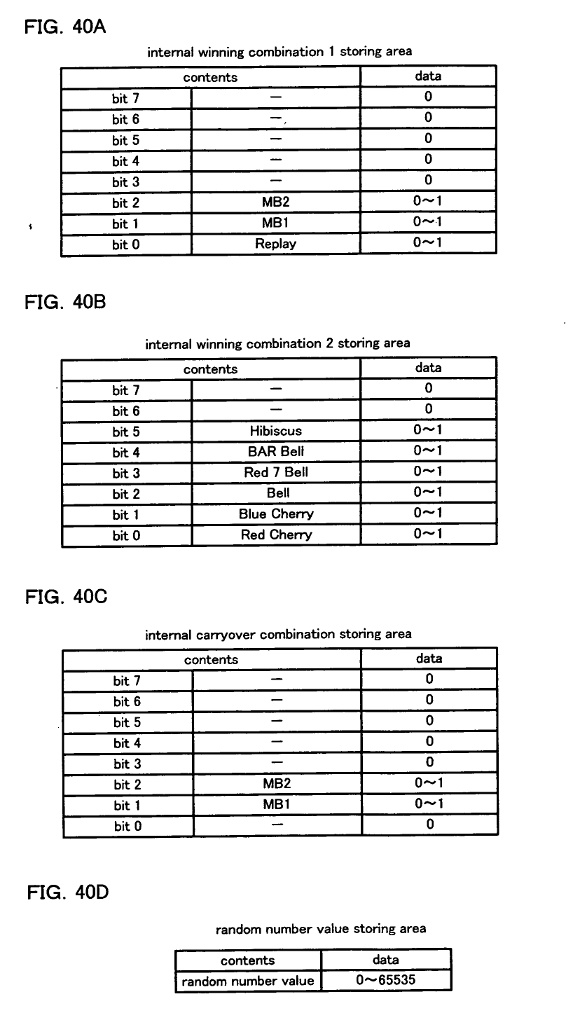

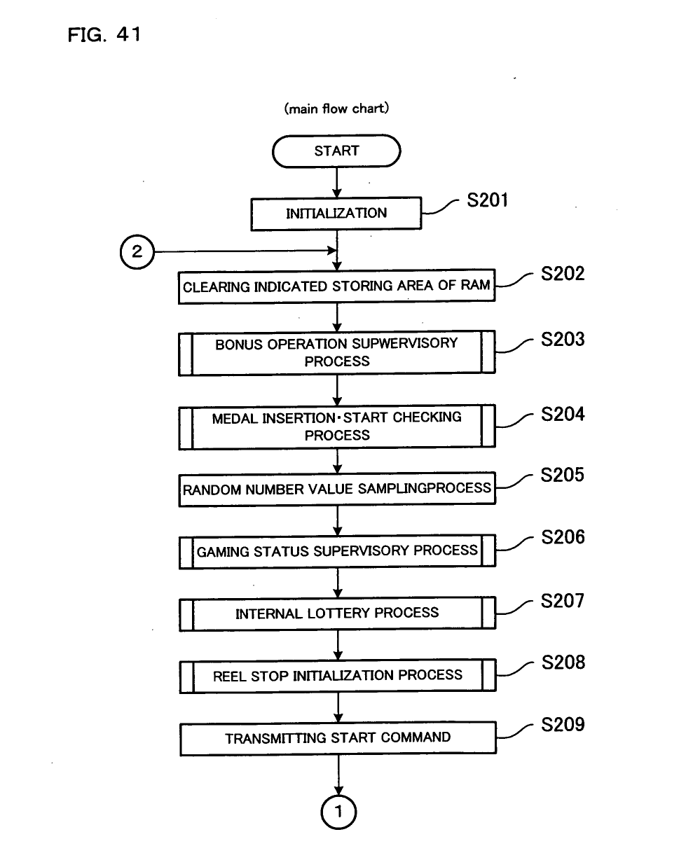

In the followings, it is described areas (memory areas) for storing an internal winning combination 1, an internal winning combination 2, an internal carryover combination and a random number value, with reference to FIG. 40A, 40B, 40C, 40D.

FIG. 40A shows an internal winning combination 1 storing area. The information (data) of an internal winning combination is stored (memorized) in the internal winning combination 1 storing area consisting of 1 byte. In the internal winning combination 1 storing area, a bit 0 (first bit) is a storing area corresponding to Replay. A bit 1 (second bit) is a storing area corresponding to MB1.

A bit 2 (third bit) is a storing area corresponding to MB2. A bit 3 (fourth bit) to a bit 7 (eighth bit) are unused storing areas. In the internal winning combination 1 storing area, a combination corresponding to a bit which is 1 is an internal winning combination. For example, when ┌00000010┘ is stored in the internal winning combination 1 storing area (i.e., when the bit 1 (second bit) is 1), an internal winning combination is MB1.

FIG. 40B shows an internal winning combination 2 storing area. The information (data) of an internal winning combination is stored (memorized) in the internal winning combination 2 storing area consisting of 1 byte. In the internal winning combination 2 storing area, a bit 0 (first bit) is a storing area corresponding to Red Cherry. A bit 1 (second bit) is a storing area corresponding to Blue Cherry.

A bit 2 (third bit) is a storing area corresponding to Bell. A bit 3 (fourth bit) is a storing area corresponding to Red 7 Bell. A bit 4 (fifth bit) is a storing area corresponding to BAR Bell. A bit 5 (sixth bit) is a storing area corresponding to Hibiscus. A bit 6 (seventh bit) and a bit 7 (eighth bit) are unused storing areas. In the internal winning combination 2 storing area, a combination corresponding to a bit which is 1 is an internal winning combination. For example, when ┌00000010┘ is stored in the internal winning combination 2 storing area (i.e., when the bit 1 (second bit) is 1), an internal winning combination is Blue Cherry.

FIG. 40C shows an internal carryover combination storing area. The information of an internal carryover combination is stored in the internal carryover combination storing area consisting of 1 byte. In the internal carryover combination storing area, a bit 1 (second bit) is a storing area (memory area) corresponding to MBl. In the internal carryover combination storing area, a bit 2 (third bit) is a storing area (memory area) corresponding to MB2. Bit 0 (first bit) and bit 3 (fourth bit) to bit 7 (eighth bit) are unused storing areas. When there is an internal carryover combination (carryover section), 1 is stored in the bit 1 (second bit) or bit 2 (third bit) corresponding to MB1 or MB2 of the internal carryover combination storing area (┌00000010┘ or ┌00000100┘ is stored in the internal carryover combination storing area).

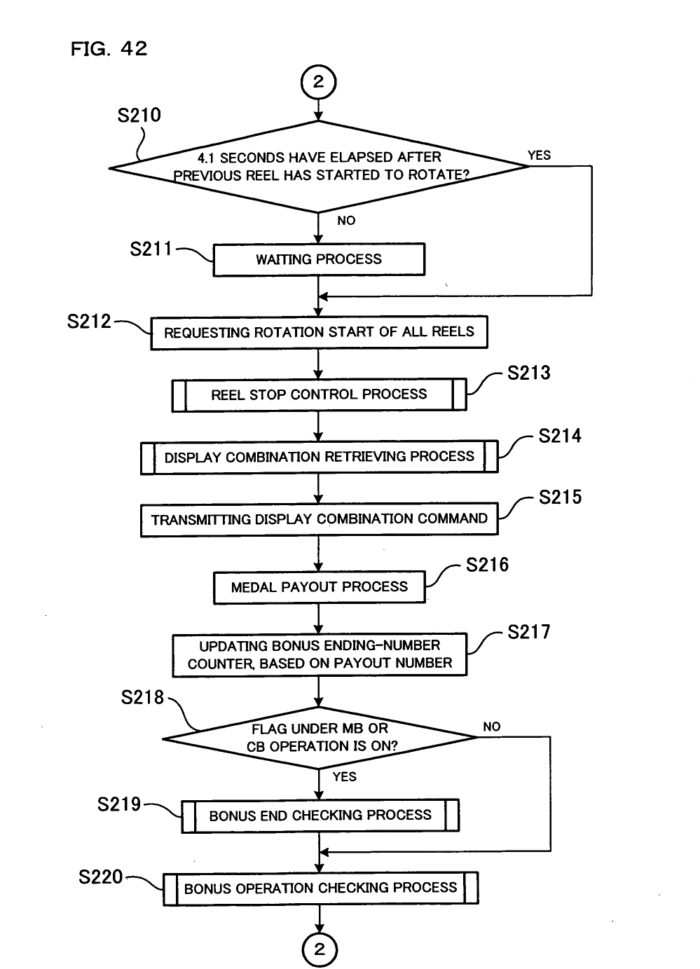

In the followings, it is described a control operation of the main control circuit 71, with reference to flow charts shown in FIGS. 41 and 42.

First, the CPU 31 carries out an initialization process (step S201). Specifically, the CPU 31 initializes the memory contents and communication data of RAM 33, and then proceeds to a step S202. In the step S202, the CPU 31 erases (clears) predetermined memory contents of the RAM 33. Specifically, the CPU 31 erases the data of the writable area of the RAM 33 used in a previous game, writes a parameter necessary for a next game into the writable area of the RAM 33 and indicates a start address of a sequence program for the next game, etc.

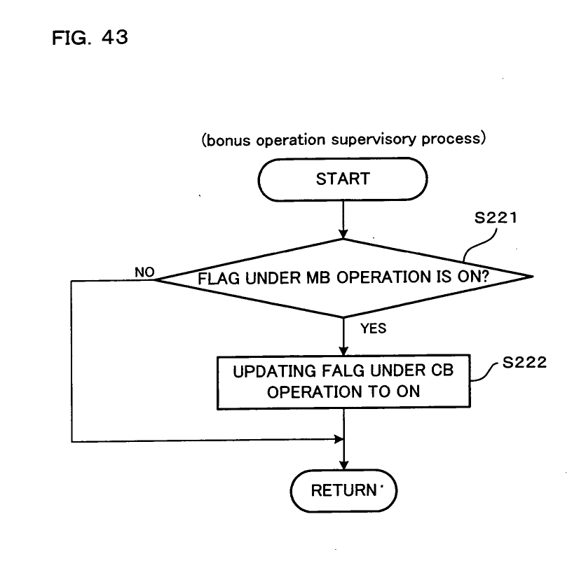

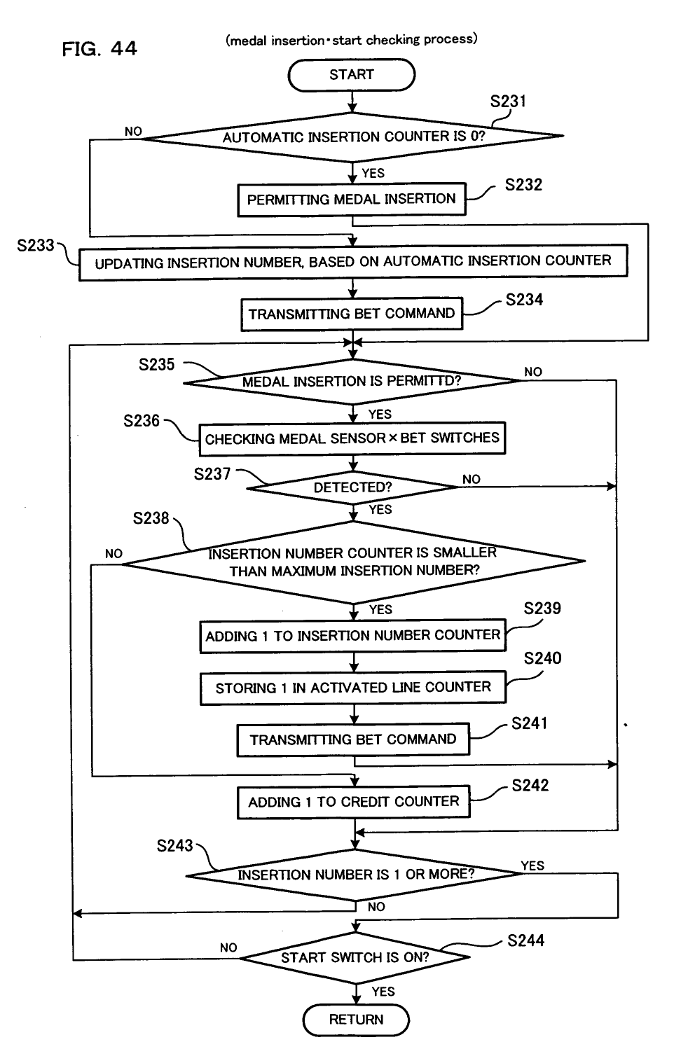

In a step S203, the CPU 31 carries out a bonus operation supervisory process which will be described with reference to FIG. 43, and then proceeds to a step S204. In the step S204, the CPU 31 carries out a medal insertion(start checking process which will be described with reference to FIG. 44, and then proceeds to a step S205. In this process, the CPU 31 updates the bet number, based on the inputs from the start switch 6S, the medal sensor 22S or the BET switches 11 to 13.

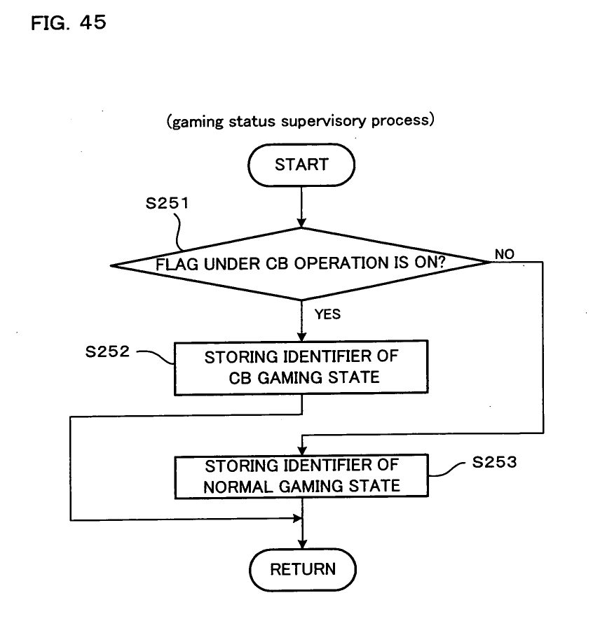

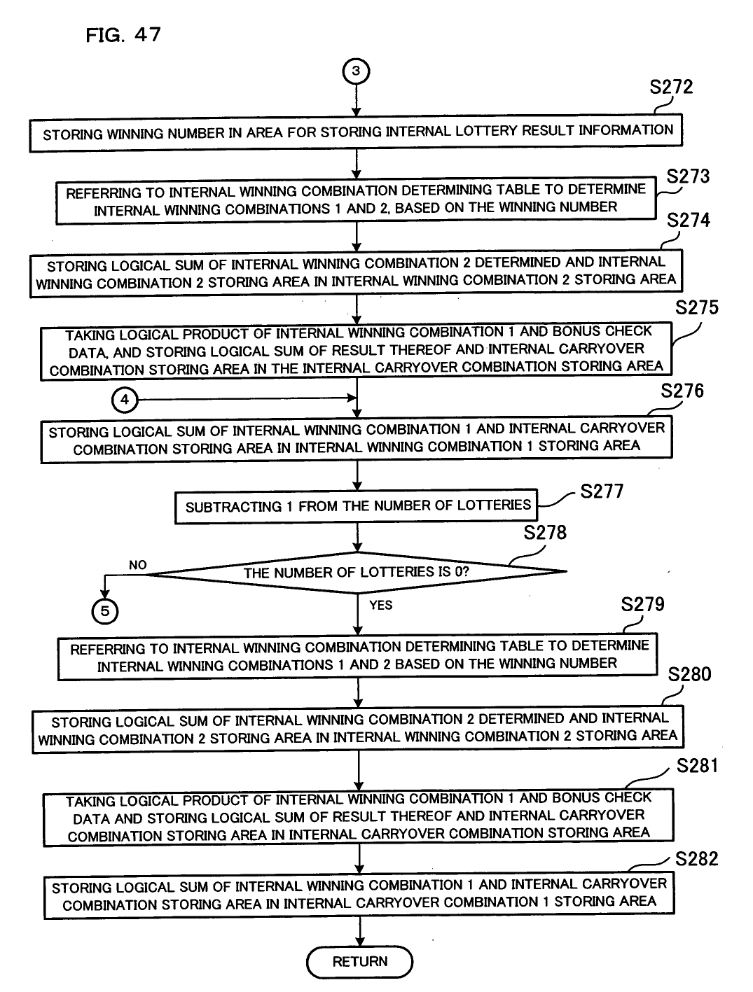

In the step S205, the CPU 31 samples a random number value for lottery, and proceeds to a step S206. The random number value sampled in this process is used for an internal lottery process which will be described later. In the step S206, the CPU 31 carries out a gaming status supervisory process which will be described with reference to FIG. 45, and proceeds to a step S207. In the step S207, the CPU 31 carries out an internal lottery process which will be described with reference to FIGS. 46 and 47, and proceeds to a step S208. In the step S208, the CPU 31 carries out a reel stop initialization process which will be described with reference to FIG. 48, and then proceeds to a step S209. In the step S209, the CPU 31 transmits a start command and then proceeds to a step S210. The start command contains the information ofa gaming state, an internal winning combination, etc., and is transmitted to the sub-control circuit 72.

In the step S210 of FIG. 42, the CPU 31 determines whether ┌4.1 seconds┘ have elapsed after a previous reel has started to rotate. When a result of the determination is YES, the CPU 31 proceeds to astep S212, otherwise proceedsto a step S211. In the step S211, the CPU 31 consumes a game start waiting time (waiting process) and then proceeds to a step S212. Specifically, the CPU 31 annuls an input related to a game start operation by a player during the period from after the previous game has started until a predetermined time (for example, 4.1 seconds) has elapsed.

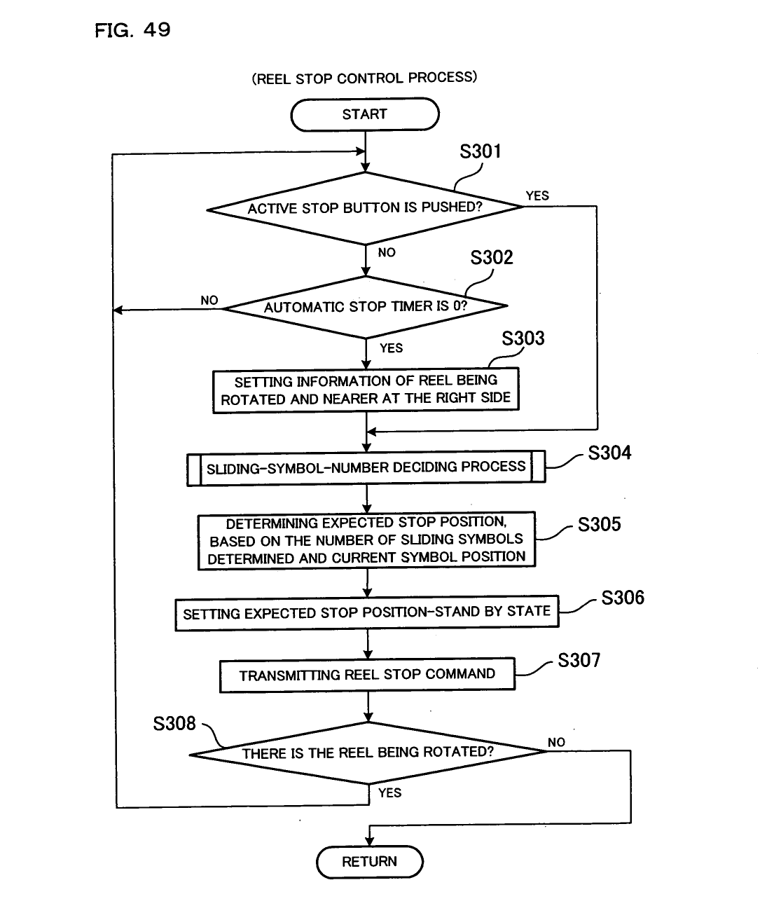

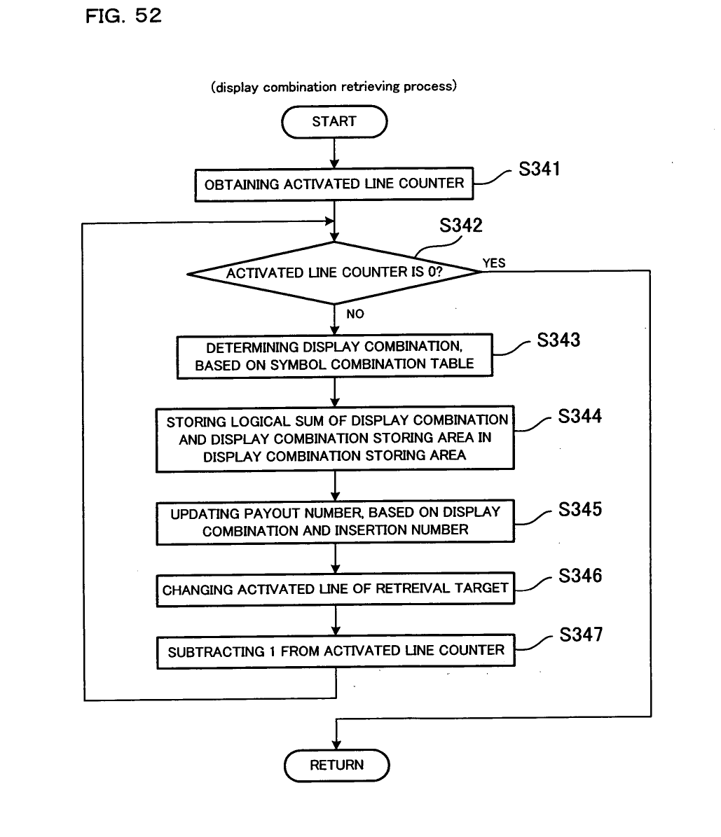

In the step S212, the CPU 31 requests the rotation start of all reels, and proceeds to a step S213. In the step S213, the CPU 31 carries out a reel stop control process which will be described with reference to FIG. 49, and then proceeds to a step S214. In the step S214, the CPU 31 carries out a display combination retrieving process which will be described with reference to FIG. 52, and then proceeds to a step S215. In the step S215, the CPU 31 transmits a display combination command, and then proceeds to a step S216.

In the step S216, the CPU 31 carries out a medal payout process, and then proceeds to a step S217. In the step S217, the CPU 31 updates the bonus ending-number counter based on the payout number, and proceeds to a step S218. In this process, when the bonus ending-number counter is 1 or more, the CPU 31 subtracts the counter depending on the payout number of medals. In the step S218, the CPU 31 determines whether the flag under MB operation or flag under CB operation is ON or not. When a result of the determination is YES, the CPU 31 proceeds to a step S219, otherwise proceeds to a step S220.

In the step S219, the CPU 31 carries out a bonus end checking process which will be described with reference to FIG. 53, and then proceeds to a step S220. In the step S220, the CPU 31 carries out a bonus operation checking process which will be described with reference to FIG. 54, and then proceeds to the step S202 of FIG. 41.

In the followings, it is described a bonus operation supervisory process with reference to FIG. 43.

First, the CPU 31 determines whether the flag under MB operation is ON or not (step S221). When a result of the determination is YES, the CPU 31 proceeds to a step S222, otherwise proceeds to the step S204 in FIG. 41. In the step S222, the CPU 31 updates the flag under CB operation to ON, and then proceeds to the step S204 in FIG. 41.

In the followings, a medal insertion(start checking process is described with reference to FIG. 44.

First, the CPU 31 determines whether the automatic insertion counter is 0 or not, i.e., whether Replay has been established in the previous game (step S231). When a result of the determination is YES, the CPU 31 proceeds to a step S232, otherwise proceeds to a step S233. The automatic insertion counter is a counter for counting the number of medals which are automatically inserted when a display combination is Replay. In the step S232, the CPU 31 permits the insertion of medal and then proceeds to a step S235. In the step S233, the CPU 31 updates the insertion number (insertion number counter), based on the automatic insertion counter, and then proceeds to a step S234. The insertion number counter is a counter for counting the number of medals inserted.

In the step S234, the CPU 31 transmits the BET command, and then proceeds to a step S235. In the step S235, the CPU 31 determines whether it is permitted the insertion of medal or not. When a result of the determination is YES, the CPU 31 proceeds to a step S236, otherwise proceeds to a step S243. In the step S236, the CPU 31 checks the medal sensor and the BET switches, and then proceeds to a step S237. Specifically, the CPU 31 checks the inputs from the medal sensor 10S or BET switches 11 to 13.

In the step S237, the CPU 31 determines whether it is detected signals from the medal sensor and the BET switches, i.e., whether a medal is inserted or not. Specifically, the CPU 31 determines whether or not it is detected signals from the medal sensor 10S or BET switches 11 to 13. When a result of the determination is YES, the CPU 31 proceeds to a step S238, otherwise proceeds to a step S243. In the step S238, the CPU 31 determines whether the value of the insertion number counter is smaller than the maximum insertion number. When a result of the determination is YES, the CPU 31 proceeds to a step S239, otherwise proceeds to a step S242.

In the step S239, the CPU 31 adds 1 to the insertion number counter and then proceeds to a step S240. In the step S240, the CPU 31 stores 1 in an activated line counter and then proceeds to a step S241. The activated line counter is a counter for counting the number of activated lines for which it is carried out a determination of the display combination. In the step S241, the CPU 31 transmits the BET command and then proceeds to a step S243. In the step S242, the CPU 31 adds 1 to the credit counter and then proceeds to a step S243.

In the step S243, the CPU 31 determines whether the insertion number is 1 or more. When a result of the determination is YES, the CPU 31 proceeds to a step S244, otherwise proceeds to the step S235. In the step S244, the CPU 31 determines whether the start switch is ON or not. When a result of the determination is YES, the CPU 31 proceeds to the step S205 in FIG. 41, otherwise proceeds to the step S235.

In the followings, it is described a gaming status supervisory process with reference to FIG. 45.

First, the CPU 31 determines whether the flag under CB operation is ON or not (step S251). When a result of the determination is YES, the CPU 31 proceeds to a step S252, otherwise proceeds to a step S253. In the step S252, the CPU 31 stores an identifier of the CB gaming state and then proceeds to the step S207 in FIG. 41. In the step S253, the CPU 31 stores an identifier of the normal gaming state and then proceeds to the step S207 in FIG. 41. Like this, in the gaming status supervisory process, the CPU 31 supervises the gaming state, based on the flag under operation (flag under CB operation), and stores the information for selecting a type of an internal lottery table relating to the gaming state in the RAM 33 (gaming state storing area) in a step S261 of FIG. 46.

In the followings, it is described an internal lottery process with reference to FIGS. 46 and 47.

First, the CPU 31 determines the number of lotteries relating to the gaming state, based on the internal lottery table determining table (see FIG. 31) (step S261), and then proceeds to a step S262. In the step S262, the CPU 31 determines whether the data (information) stored in the internal carryover combination storing area is 0 or not (i.e., whether or not there is an internal carryover combination). When a result of the determination is YES, the CPU 31 proceeds to a step S264, otherwise proceeds to a step S263. Herein, a result of the determination in the step S262 is NO in case of the carryover section. In the step S263, the CPU 31 changes the number of lotteries into 7, and then proceeds to a step S264.

In the step S264, the CPU 31 sets a value same as the number of lotteries in the register of the CPU 31, as a winning number, and then proceeds to a step S265. Thereby, the winning number ┌9┘ is set in the normal gaming state, the winning number ┌6┘ is set in the CB gaming state and the winning number ┌7┘ is set in the internal winning state (carryover state). In the step S265, the CPU 31 refers to the internal lottery table corresponding to the gaming state determined in the step S261 to obtain the lowest limit (L), based on the winning number and the insertion number, and then proceeds to a step S266. In the step S266, the CPU 31 subtracts the lowest limit (L) from the random number value (R) stored in the random number value storing area of the RAM 33 (R-L), and then proceeds to a step S267.

In the step S267, the CPU 31 determines whether or not it is carried out an underflow. Specifically, the CPU 31 determines whether the calculation result of R-L is negative or not. When a result of the determination is YES, the CPU 31 proceeds to a step S276 in FIG. 47, otherwise proceeds to a step S268. The result of determination becomes YES when the random number value is smaller than the lowest limit (L>R). In addition, the result of determination becomes NO when the random number value is equal to or greater than the lowest limit (L≦R).

In the step S268, the CPU 31 refers to the internal lottery table corresponding to the gaming state determined in the step S261 to obtain the upper limit (U), based on the winning number and the insertion number, and then proceeds to a step S269. In the step S269, the CPU 31 subtracts the upper limit (U) from the random number value (R) stored in the random number value storing area of the RAM 33 (R-U), and then proceeds to a step S270.

In the step S70, the CPU 31 determines whether a value resulting from the subtraction, i.e., the calculation result of R-U is ┌0┘ or not. When a result of the determination is YES, the CPU 31 proceeds to a step S272 in FIG. 47, otherwise proceeds to a step S271. The result of determination becomes YES when the random number value is equal to the upper limit (R=U). In addition, the result of determination becomes NO when the random number value is not equal to the upper limit (R≈U).

In the step S271, the CPU 31 determines whether or not it is carried out an underflow. Specifically, the CPU 31 determines whether the calculation result of R-U is negative or not. When a result of the determination is YES, the CPU 31 proceeds to a step S272 in FIG. 47, otherwise proceeds to a step S276 in FIG. 47. The result of determination becomes YES when the random number value is smaller than the upper limit (R<U). In addition, the result of determination becomes NO when the random number value is greater than the upper limit (R>U).

In the step S272 of FIG. 47, the CPU 31 stores the winning number in an area for storing internal lottery result information of the RAM 33, and then proceeds to a step S273. In the step S273, the CPU 31 refers to the internal winning combination determining table to determine internal winning combinations 1 and 2, based on the winning number, and then proceeds to a step S274. In the step S274, the CPU 31 stores a logical sum of the internal winning combination 2 determined in the step S273 and the internal winning combination 2 storing area (FIG. 40B) in the internal winning combination 2 storing area. Herein, it is established a bit corresponding to a type of Small Win which is won in the internal winning combination 2 storing area.

In the step S275, the CPU 31 takes a logical product of the internal winning combination 1 and the bonus check data, stores a logical sum of a result thereof and the internal carryover combination storing area in the internal carryover combination storing area, and then proceeds to a step S276. Thereby, MB determined is stored in the internal carryover combination storing area. In addition, the bonus check data is ┌00000110┘. In the step S276, the CPU 31 stores a logical sum of the internal winning combination 1 and the internal carryover combination storing area in the internal winning combination 1 storing area, and then proceeds to a step S277.

In the step S277, the CPU 31 subtracts 1 from the number of lotteries and then proceeds to a step S278. In the step S278, the CPU 31 determines whether or not the number of lotteries is 0. When a result of the determination is YES, the CPU 31 proceeds to a step S279, otherwise proceeds to the step S264 in FIG. 46. The result of determination becomes YES when the number of cases where it is determined whether or not the random number value (R) is within the numerical range defined by the upper limit (U) and the lowest limit (L) is 9 times in the normal gaming state, 6 times in the MB gaming state and 7 times in the internal wining state (carryover state). In the mean time, the result of determination becomes NO when the number of determination cases is less than 9 times in the normal gaming state, less than 6 times in the MB gaming state and less than 7 times in the internal winning state (carryover state).

In the step S279, the CPU 31 refers to the internal winning combination determining table (see FIG. 33) to determine the internal winning combinations 1 and 2 based on the winning number, and then proceeds to a step S280. In the step S280, the CPU 31 stores a logical sum of the internal winning combination 2 determined and the internal winning combination 2 storing area (see FIG. 40B) in the internal winning combination 2 storing area. In the step S281, the CPU 31 takes a logical product of the internal winning combination 1 and the bonus check data, stores a logical sum of a result thereof and the internal carryover combination storing area in the internal carryover combination storing area, and then proceeds to a step S282. Thereby, the internal carryover combination is stored in the internal carryover combination storing area. In the step S282, the CPU 31 stores a logical sum of the internal winning combination 1 and the internal carryover combination storing area in the internal carryover combination 1 storing area and then proceeds to the step S208 in FIG. 41. As a result, when the processes in the steps S272˜S275 are not carried out because the random number value (R) is not within any numerical ranges of the internal lottery table in FIG. 32, the losing or internal carryover combination is stored in the internal carryover combination 1 storing area.

In the followings, a reel stop initialization process is described with reference to FIG. 48.

First, the CPU 31 compares the data of the internal winning combination 2 storing area with the complex combination check data (┌00111111┘) (step S291), and then proceeds to a step S292. In the step S292, the CPU 31 determines whether or not the data of the internal winning combination 2 storing area is equal to the complex combination check data. When a result of the determination is YES (i.e., when the internal winning combination is the complex combination), the CPU 31 proceeds to a step S298, otherwise proceeds to a step S293.

In the step S293, the CPU 31 determines whether or not the winning number is 0. When a result of the determination is YES, the CPU 31 proceeds to a step S294, otherwise proceeds to a step S296. In the step S294, the CPU 31 takes a logical product of the data of the internal winning combination 1 storing area and the operation combination check data (┌00000110┘), and then proceeds to a step S295. In the step S295, the CPU 31 determines whether the logical product is 0 or not. When a result of the determination is YES, the CPU 31 proceeds to a step S296, otherwise (i.e., when there is an internal carryover combination) proceeds to a step S297.

In the step S296, the CPU 31 stores the winning number in the select counter for stop, and then proceeds to a step S299. For example, when an internal winning of both MB and Small Win is determined, the CPU 31 stores the smaller winning number in the select counter for stop. In the step S297, the CPU 31 numbers the data of the internal winning combination 1 storing area, adds 6, stores it in the select counter for stop and then proceeds to a step S299. The numbering is as follows: when the bit 0 is ON (1 is stored in the bit 0), 1 is set, when the bit 1 is ON (1 is stored in the bit 1), 2 is set, and when the bit 2 is ON (1 is stored in the bit 2), 3 is set. Specifically, when the data of the internal winning combination 1 storing area represents MB1 or MB2, 8 and 9 are stored in the select counter for stop, in the respective cases.

In the step S298, the CPU 31 stores 10 in the select counter for stop and then proceeds to a step S299. Specifically, when an internal winning combination is MB1, 8 is set in the select counter for stop, and when an internal winning combination is MB2, 9 is set in the select counter for stop. In the step S299, the CPU 31 determines and stores a stop table, based on the reel stop initialization table, and proceeds to the step S209 in FIG. 41.

In the followings, it is described a reel stop control process with reference to FIG. 49.

First, the CPU 31 determines whether an active stop button is pushed or not, i.e., whether there is an input from the stop switches 7LS, 7CS, 7RS (step S301). When a result of the determination is YES, the CPU 31 proceeds to a step S304, otherwise proceeds to a step S302. In the step S302, the CPU 31 determines whether the automatic stop timer is 0 or not. When a result of the determination is YES, the CPU 31 proceeds to a step S303, otherwise proceeds to the step S301.

In the step S303, the CPU 31 sets the information of the reel which is nearer at the right side and being rotated, and proceeds to a step S304. By the information, for example, when the plural reels are being rotated, the reels are stopped from the right side. In the step S304, the CPU 31 carries out a sliding-symbol-number deciding process which will be described with reference to FIG. 50, and then proceeds to a step S305. In the step S305, the CPU 31 determines an expected stop position (position for stopping the symbol), based on the determined number of sliding symbols and the current symbol position, and then proceeds to a step S306. In the step S306, the CPU 31 shifts to an expected stop position-stand by state, and then proceeds to a step S307.

In the step S307, the CPU 31 transmits a reel stop command and then proceeds to a step S308. In the step S308, the CPU 31 determines whether there is a reel being rotated. When a result of the determination is YES, the CPU 31 proceeds to the step S301, otherwise proceeds to the step S214 in FIG. 42.

In the followings, it is described a siding-symbol-number deciding process with reference to FIG. 50.

First, the CPU 31 determines whether an internal winning combination is the bonus (MB) only (step S311). When a result of the determination is YES, the CPU 31 proceeds to a step S312, otherwise proceeds to a step S313. In the step S312, the CPU 31 sets the stop table corresponding to MB1 or MB2, and then proceeds to a step S316. Herein, when an internal winning combination is MB1, the stop table for MB1 (see FIG. 35) is set, and when an internal winning combination is MB2, a stop table for MB2 (not shown) is set.

In the step S313, the CPU 31 determines whether or not the internal winning combination includes both the bonus (MB) and Small Win. When a result of the determination is YES, the CPU 31 proceeds to a step S314, otherwise proceeds to a step S315. In the step S314, the CPU 31 carries out a sliding-symbol-number deciding process for bonus+Small Win which will be described with reference to FIG. 51, and then proceeds to the step S305 in FIG. 49.

In the step S315, the CPU 31 sets the stop table corresponding to the internal winning combination, and then proceeds to a step S316. In the step S316, the CPU 31 determines and sets the number of sliding symbols, based on the stop operation position, the priority attraction-in ranking table and the internal winning combination.

In the followings, it is described a sliding-symbol-number deciding process for bonus+Small Win with reference to FIG. 51.

First, the CPU 31 determines whether a table control flag is ON or not (step S321). When a result of the determination is YES, the CPU 31 proceeds to a step S322, otherwise proceeds to a step S323. The table control flag is the information for identifying whether or not the stop table initialized in the reel stop control process of FIG. 49 is used. When the attraction-in target symbol can not be displayed in steps S323˜S327, the table control flag is updated to ON. When one game is over, the table control flag is updated to OFF.

In the step S323, the CPU 31 determines whether or not the attraction-in target symbol can be displayed with the number of sliding symbols 0. When a result of the determination is YES, the CPU 31 proceeds to a step S331, otherwise proceeds to a step S324. When MB1 is included in the internal winning combination, the attraction-in target symbol is ┌Red 7┘, and when MB2 is included in the internal winning combination, the attraction-in target symbol is ┌BAR┘.

In the step S324, the CPU 31 determines whether or not the attraction-in target symbol can be displayed with the number of sliding symbols 1. When a result of the determination is YES, the CPU 31 proceeds to a step S331, otherwise proceeds to a step S325. In the step S325, the CPU 31 determines whether or not the attraction-in target symbol can be displayed with the number of sliding symbols 2. When a result of the determination is YES, the CPU 31 proceeds to a step S331, otherwise proceeds to a step S326.

In the step S326, the CPU 31 determines whether or not the attraction-in target symbol can be displayed with the number of sliding symbols 3. When a result of the determination is YES, the CPU 31 proceeds to a step S331, otherwise proceeds to a step S327. In the step S327, the CPU 31 determines whether or not the attraction-in target symbol can be displayed with the number of sliding symbols 4. When a result of the determination is YES, the CPU 31 proceeds to a step S331, otherwise proceeds to a step S328.

In the step S328, the CPU 31 sets the stop table corresponding to the internal winning combination, and then proceeds to a step S329. Specifically, when the internal winning combination includes MB1 and Red 7 Bell, the stop table for Red 7 Bell (see FIG. 36) is set. When the internal winning combination includes MB1 and Hibiscus, the stop table for Hibiscus (see FIG. 37) is set. When the internal winning combination includes MB1 and Red Cherry, a dedicated stop table (not shown) is set. When the internal winning combination includes MB2 and BAR Bell, a dedicated stop table (not shown) is set. When the internal winning combination includes MB2 and Hibiscus, a dedicated stop table (not shown) is set. When the internal winning combination includes MB2 and Blue Cherry, a dedicated stop table (not shown) is set.

In the step S329, the CPU 31 updates the table control flag to ON, and then proceeds to a step S330. In the step S330, the CPU 31 determines and sets the number of sliding symbols based on the stop operation position, and then proceeds to the step S305 in FIG. 49. In the step S331, the CPU 31 sets the number of sliding symbols which provides an occasion in which the result of determination in one of the steps S323˜S327 is YES, and then proceeds to the step S305 in FIG. 49.

In case that an attraction-in target symbol (corresponding to the internal winning combination) can be stopped in the symbol display area of the reel corresponding to the stop operation, the stop table is not set in correspondence with the stop operation. This case comprises a case where a symbol constituting a symbol combination corresponding to the internal winning combination can be displayed together with the attraction-in target symbol and a case where it cannot be displayed. In addition, when a stop table is set, the stop control corresponding to the stop operation after that is carried out, based on the set stop table.

In the followings, it is described a display combination retrieving process with reference to FIG. 52.

First, the CPU 31 obtains the activated line counter (step S341) and then proceeds to a step S342. When a game is started, 1 is stored in the activate line counter (step S240 in FIG. 44). In the step S342, the CPU 31 determines whether the activated line counter is 0 or not. When a result of the determination is YES, the CPU 31 proceeds to the step S215 in FIG. 42, otherwise proceeds to a step S343. When it is ended the retrieval of the display combination for one activated line, the value of the activated line counter becomes 0.

In the step S343, the CPU 31 determines a display combination, based on the symbol combination table (see FIG. 30), and then proceeds to a step S344. In the step S344, the CPU 31 stores a logical sum of the display combination and the display combination storing area in the display combination storing area, and then proceeds to a step S345. In the step S345, the CPU 31 updates the payout number, based on the display combination and the insertion number, and then proceeds to a step S346. In the step S346, the CPU 31 changes the activated line of the retrieval target, and then proceeds to a step S347. In the step S347, the CPU 31 subtracts 1 from the activated line counter and then proceeds to the step S342.

In the followings, a bonus end checking process is described with reference to FIG. 53.

First, the CPU 31 updates the flag under CB operation to OFF (step S351), and then proceeds to a step S352. In the step S352, the CPU 31 determines whether the bonus ending-number counter is 0 or not. When a result of the determination is YES, the CPU 31 proceeds to the step S353, otherwise proceeds to the step S220 in FIG. 42. In the step S353, the CPU 31 carries out a process on bonus ending and then proceeds to the step S220 in FIG. 42.

In the followings, a bonus operation checking process is described with reference to FIG. 54.

First, the CPU 31 determines whether or not the display combination is Replay (step S361). When a result of the determination is YES, the CPU 31 proceeds to a step S362, otherwise proceeds to a step S363. In the step S362, the CPU 31 copies the insertion number counter to the automatic insertion counter and then proceeds to a step S365. Specifically, in the step S362, the CPU 31 sets (automatically inserts) the number same as the insertion number inserted to play this game to the automatic insertion counter.

In the step S363, the CPU 31 determines whether the display combination is MB. When a result of the determination is YES, the CPU 31 proceeds to a step S364, otherwise proceeds to the step S202 in FIG. 41. In the step S364, the CPU 31 carries out a process on MB operation, based on the table on bonus operation, and then proceeds to a step S365. In the process on MB operation, the CPU 31 updates the flag under MB operation to ON, and sets 250 in the bonus ending-number counter. In the step S365, the CPU 31 clears the internal carryover combination and then proceeds to the step S202 in FIG. 41.

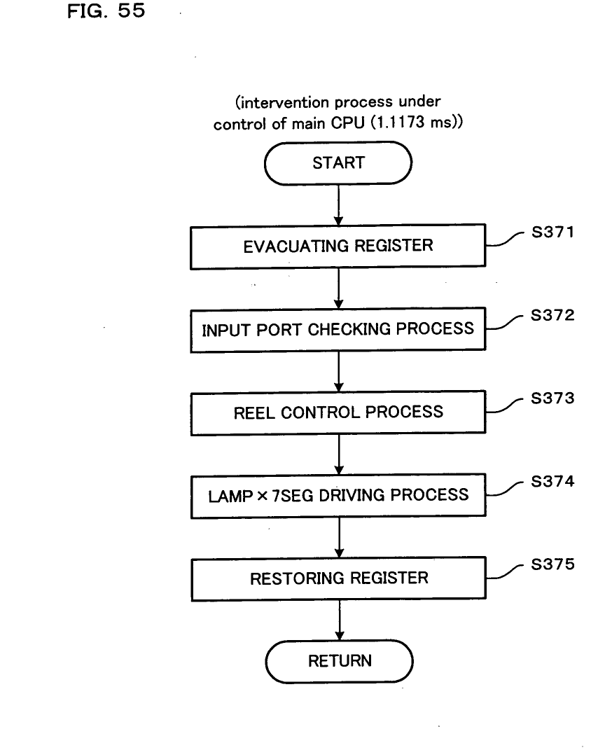

In the followings, it is described an intervention process under control of the main CPU (CPU 31), with reference to FIG. 55. The intervention process is carried out every 1.1173 ms.

First, the CPU 31 evacuates a register (step S371), and then proceeds to a step S372. In the step S372, the CPU 31 checks an input port and then proceeds to a step S373. Specifically, the CPU 31 checks whether there is a signal input from the start switch 6S resulting from the push operation of the start lever 6. In the step S373, the CPU 31 carries out a reel control process, and then proceeds to a step S374. Specifically, the CPU 31 sets the information representing the control target reel as an identifier of a reel, and controls the driving of the reel.

In the step S374, the CPU 31 performs a lamp(7SEG driving process. Specifically, the CPU 31 turns on the BET lamps 17a to 17c, based on the number of medals bet per a game. In addition, the CPU 31 displays the number of medals deposited (credited) and the payout number when a combination is established on the credit display unit 19. In the step S375, the CPU 31 restores the register and then ends the periodic intervention process.

The invention has been described with reference to the embodiments. However, the invention is not limited thereto.

In the embodiment 1, the information of the second numerical range (for example, ┌100┘˜┌199┘) corresponding to the second combination (for example, Small Win of White 7, etc.) has been included in the information of the first numerical range (for example, ┌0┘˜┌299┘) corresponding to the first combination (for example, RB, etc.). However, the invention is not limited thereto. For example, the information of the second numerical range (for example, ┌30┘˜┌99┘) corresponding to the second combination may include a part (for example, ┌50┘˜┌99┘ of ┌50┘˜┌299┘) of the numerical range constituting the first numerical range. By doing so, since it is possible to make the player's expectations different, which the first combination will be an internal winning combination, the interest in the game can be increased.

In the embodiment 1, the combination which is determined as an internal winning combination together with RB by the one lottery has been Small Win of White 7 or Small Win of Cherry. However, the invention is not limited thereto. For example, the combination may be Replay, rather than Small Win of White 7 or Small Win of Cherry. By doing so, the variety of game and the interest in the game can be increased.

In the embodiment 1, two of the first, second and third combinations have been determined as an internal winning combination by one lottery. However, it may be provided selecting operation means allowing the player to select the type of the first, second or third combination, and the internal winning combination determining means may determine an internal winning combination, based on the operation mode of the selecting operation means. By doing so, it is possible to increase the interest in the game.

In the embodiment 1, RB has been provided as a combination which is determined as an internal winning combination together with Small Win by one lottery and carried over. However, the invention is not limited thereto. For example, it may be provided any combination (for example, BB) which can be carried over, rather than RB.

In the embodiment 1, the random number range (numerical range) corresponding to the combination has been made to be continuous values. However, the invention is not limited thereto. For example, the numerical range may comprise plural values which are not continuous.

In the embodiment 4, the symbol display areas (symbol display means) 21L, 21C, 21R have been structured such that the bonus symbols (symbol constituting a specific symbol combination) equal to or more than the number of symbol stop positions provided to the symbol display areas 21L, 21C, 21R are successively displayed in the variation direction, with regard to each of the plural rows, and it has been carried out the stop control capable of stopping the bonus symbols at all the symbol stop positions provided to the symbol display areas 21L, 21C, 21R, regarding to each of the plural rows. However, the invention is not limited thereto.

For example, in at least one row of the plural rows, the symbol display areas (symbol display means) 21L, 21C, 21R may be structured such that the bonus symbols (symbol constituting a specific symbol combination) equal to or more than the number of symbol stop positions provided to the symbol display areas 21L, 21C, 21R are successively displayed in the variation direction, with regard to each row included in the at least one row (in case of one row, corresponding row), and it may be carried out the stop control capable of stopping the bonus symbols at all the symbol stop positions provided to the symbol display areas 21L, 21C, 21R, regarding to each row included in the at least one row of the plural rows.

In the embodiment 4, it has been provided the upper, central and lower symbol stop positions in the respective reels 3L, 3C, 3R, as the symbol stop position. However, the invention is not limited thereto. For example, two or four symbol stop positions may be provided in the respective reels 3L, 3C, 3R. By doing so, it is possible to embody diverse stop display pattern.

In the embodiment 4, the activated line has been structured to connect the central symbol stop positions of the respective symbol display areas 21L, 21C, 21R. However, the invention is not limited thereto. For example, the activated line may be structured to connect the upper or lower symbol stop positions of the respective symbol display areas 21L, 21C, 21R. In addition, at least two symbol stop positions (connecting the activated lines) of the symbol display areas 21L, 21C, 21R may be made to be different, respectively.

For example, the activated line may be connected at the upper symbol stop position of the left symbol display area 21L, the lower symbol stop position of the center symbol display area 21C and the upper symbol stop position of the right symbol display area 21R. Alternatively, the activated line may be connected at the lower symbol stop position of the left symbol display area 21L, the central symbol stop position of the center symbol display area 21C and the upper symbol stop position of the right symbol display area 21R. By doing so, it is possible to realize the various changes of the game and to increase the interest in the game.

In addition, it may be provided selecting operation means allowing the player to select the symbol stop positions (active symbol stop positions) connecting the activated line in the respective symbol display areas 21L, 21C, 21R. In this case, the stop control means carries out the stop control of the symbol, based on the active symbol stop positions of the respective symbol display areas 21L, 21C, 21R selected by the selecting means. By doing so, it is possible to increase the interest in the game.

In the embodiment 4, the three reels have been provided, and when any one reel is being varied, the two same bonus symbols have been displayed along one activated line in the other stopped reels, on condition that MB has been determined. However, the invention is not limited thereto. For example, four reels may be provided, and when any one reel is being varied, the three same bonus symbols have been displayed along one activated line in the other stopped reels, on condition that MB is determined.

In addition, the invention can be applied to another gaming machine such as pachinko gaming machine, pachinko-slot and the like, in addition to the gaming machine 1 of the above embodiments. In addition, the invention can be applied to a game program which pseudo-executes the operations in the gaming machine 1 described above as a home gaming machine. In this case, a medium for recording the game program may include a CD-ROM, FD (flexible disk) and the other recording media.

In the mean time, the detailed structures may be properly modified. In addition, the effects described in the embodiment are only enumerations of the most preferred effects obtainable from the invention and the effects of the invention are not limited to the embodiments.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A gaming machine comprising:
symbol display means for displaying plural symbols;
start signal output means for outputting a command signal to start a unit game in accordance with an operation of a player;
internal winning combination determination information storing means for storing internal winning combination determination information having information of numerical ranges corresponding to each of predetermined plural combinations;
internal winning combination determining means for determining a combination corresponding to a numerical range including a random number value sampled by a random number lottery as an internal winning combination, based on the internal winning combination determination information;
symbol varying means for varying symbols to be displayed by the symbol display means, on condition that a signal is outputted by the start signal output means;
stop signal output means for outputting a command signal to stop the symbol variation carried out by the symbol varying means, in accordance with an operation of the player;
stop control means for carrying out a stop control of the symbol variation carried out by the symbol varying means, based on a signal outputted by the stop signal output means and an internal winning combination determined by the internal winning combination determining means; and
means for awarding a payout to the player when a predetermined symbol combination is displayed by the symbol display means,
wherein the internal winning combination determination information includes information of a first numerical range corresponding to a first combination, information of a second numerical range included in the first numerical range and corresponding to a second combination and information of a third numerical range including a part of the numerical range constituting the first numerical range and corresponding to a third combination.

2. The gaming machine according to claim 1, further comprising carryover means for carrying over the first combination as an internal winning combination until a symbol combination corresponding to the first combination is displayed by the symbol display means, on condition that the internal winning combination determining means determines the first combination as an internal winning combination,
wherein the awarding means comprises means for operating an advantage state which is relatively advantageous to the player, on condition that the symbol combination corresponding to the first combination is displayed by the symbol display means; and game value awarding means for awarding a game value to the player, on condition that the symbol combination corresponding to the second combination is displayed by the symbol display means, and awarding the game value or a game value different from it to the player, on condition that the symbol combination corresponding to the third combination is displayed by the symbol display means.

3. A gaming machine comprising:
game value information storing means for storing information of a game value;
game start command means for outputting a game start command signal to start a unit game in accordance with an operation of a player;
symbol display means having plural display units capable of variably displaying plural types of symbols, on condition that the information of game value is stored in the game value information storing means when the game start command signal is detected;
stop command means provided to correspond to each of the plural display units and outputting a stop command signal to stop the variable display of symbols in the corresponding display units in accordance with an operation by a player;
internal winning combination determining means for determining an internal winning combination, on condition that the game start command signal is detected;
stop control means for stopping the variable display of symbol of the display unit corresponding to the detected stop command signal, on condition that the stop command signal is detected;
combination determining means for determining whether a symbol combination, which is arranged along a line connecting symbol stop positions predetermined for each of the display units, corresponds to an internal winning combination determined by the internal winning combination determining means, on condition that the plural display units stop the symbols;
means for awarding a payout to the player, on condition that the combination determining means determines that the symbol combination arranged along the line corresponds to the internal winning combination determined by the internal winning combination determining means, the payout corresponding to the determined internal winning combination;
display means capable of displaying identification information discernible by the player along the line; and
display control means for controlling the display means.

4. A gaming machine comprising:
symbol display means for displaying plural symbols;
start signal output means for outputting a command signal to start a unit game in accordance with an operation by a player;
internal winning combination determination information storing means for storing internal winning combination determination information having information about the lowest limit and the upper limit of numerical ranges corresponding to each of predetermined plural combinations;
internal winning combination determining means for determining a combination corresponding to a numerical range including a random number value sampled by a random number lottery, as an internal winning combination, based on the internal winning combination determination information;
symbol varying means for varying symbols to be displayed by the symbol display means, on condition that a signal is outputted by the start signal output means;
stop signal output means for outputting a command signal to stop the symbol variation carried out by the symbol varying means, in accordance with an operation by a player;
stop control means for carrying out a stop control of the symbol variation carried out by the symbol varying means, based on a signal outputted by the stop signal output means and an internal winning combination determined by the internal winning combination determining means; and
means for awarding a payout to a player, when a predetermined symbol combination is displayed by the symbol display means,
wherein the internal winning combination determination information includes information of the first lowest limit and the first upper limit corresponding to a first combination, information of the second lowest limit and the second upper limit corresponding to a second combination and information of the third lowest limit and the third upper limit corresponding to a third combination,
wherein the information of the second lowest limit is the information of a value of the first lowest limit or more, the information of the second upper limit is the information of a value of the first upper limit or less, and the information of the third lowest limit is one of the information of a value of the first lowest limit or more and the information of a value smaller than the first lowest limit, and
wherein when the information of the third lowest limit is the information of a value of the first lowest limit or more, the information of the third upper limit is the information of a value greater than the first upper limit, and when the information of the third lowest limit is the information of a value smaller than the first lowest limit, the information of the third upper limit is the information of a value of the first upper limit or less.
